(19) United States
(12) Patent Application Publication
(10) Pub. No.: US 2025/0158289 A1
(43) Pub. Date: May 15, 2025

(54) ANTENNA SYSTEMS

(71) Applicant: Parsec Technologies, Inc., Plano, TX (US)

(72) Inventors: Michael A. Neenan, Plano, TX (US); Richard Loy Smith, Jr., Dallas, TX (US); Rauhon Ahmed Shaik, Wylie, TX (US); George Alexander Bednekoff, Plano, TX (US)

(21) Appl. No.: 18/896,751

(22) Filed: Sep. 25, 2024

Related U.S. Application Data
(63) Continuation of application No. PCT/US2024/048461, filed on Sep. 25, 2024.
(63) Continuation-in-part of application No. 18/894,607, filed on Sep. 24, 2024.
(63) Continuation-in-part of application No. PCT/US2024/048229, filed on Sep. 24, 2024.
(60) Provisional application No. 63/585,186, filed on Sep. 25, 2023.
(60) Provisional application No. 63/647,436, filed on May 14, 2024.
(60) Provisional application No. 63/653,697, filed on May 30, 2024.
(60) Provisional application No. 63/679,582, filed on Aug. 5, 2024.
(60) Provisional application No. 63/680,013, filed on Aug. 6, 2024.
(60) Provisional application No. 63/637,247, filed on Apr. 22, 2024.
(60) Provisional application No. 63/638,330, filed on Apr. 24, 2024.
(60) Provisional application No. 63/676,268, filed on Jul. 26, 2024.
(60) Provisional application No. 63/585,541, filed on Sep. 26, 2023.
(60) Provisional application No. 63/540,335, filed on Sep. 25, 2023.
(60) Provisional application No. 63/652,599, filed on May 28, 2024.
(60) Provisional application No. 63/680,045, filed on Aug. 6, 2024.

(51) Int. Cl. H01Q 21/06; H01Q 1/02; H01Q 1/32; H01Q 1/42

(52) U.S. Cl. CPC H01Q 21/062; H01Q 1/02; H01Q 1/32; H01Q 1/42

(57) ABSTRACT

An antenna assembly can include a base portion and a cover, the cover configured to be removably coupled to the base portion. The antenna assembly can include a modem positioned on or above the base portion, a ground plane, and a multi-band antenna.

### INCORPORATION BY REFERENCE TO ANY PRIORITY APPLICATIONS

The present application claims priority benefit to U.S. Provisional Application No. 63/585,186, filed Sep. 25, 2023, entitled “ANTENNA SYSTEMS,” U.S. Provisional Application No. 63/647,436, filed May 14, 2024, entitled “ANTENNA SYSTEMS,” U.S. Provisional Application No. 63/653,697, filed May 30, 2024, entitled “ANTENNA SYSTEMS,” U.S. Provisional Application No. 63/679,582, filed Aug. 5, 2024, entitled “ANTENNA SYSTEMS,” and U.S. Provisional Application No. 63/680,013, filed Aug. 6, 2024, entitled “ANTENNA SYSTEMS, and is a continuation of PCT Application No. PCT/US2024/048461, filed Sep. 25, 2024, entitled “ANTENNA SYSTEMS.” The present application also claims priority benefit to U.S. Provisional Application No. 63/637,247, filed Apr. 22, 2024, entitled “ANTENNA SYSTEMS.” The present application also claims priority benefit to U.S. Provisional Application No. 63/638,330, filed Apr. 24, 2024, entitled “ANTENNA SYSTEMS,” and U.S. Provisional Application No. 63/676,268, filed Jul. 26, 2024, entitled “ANTENNA SYSTEMS.” The present application also claims priority benefit to U.S. Provisional Application No. 63/585,541, filed Sep. 26, 2023, entitled “ANTENNA SYSTEMS,” and is a continuation-in-part of U.S. application Ser. No. 18/894,607, filed Sep. 24, 2024, entitled “ANTENNA SYSTEMS.” The present application also claims priority benefit to U.S. Provisional Application No. 63/540,335, filed Sep. 25, 2023, entitled “ANTENNA SYSTEMS,” U.S. Provisional Application No. 63/652,599, filed May 28, 2024, entitled “ANTENNA SYSTEMS,” and U.S. Provisional Application No. 63/680,045, filed Aug. 6, 2024, entitled “ANTENNA SYSTEMS, and is a continuation-in-part of PCT Application No. PCT/US2024/048229, filed Sep. 24, 2024, entitled “ANTENNA SYSTEMS.” All of the above-mentioned applications are hereby incorporated by reference herein in their entireties. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure relates to the field of wireless broadband communication, and more particularly to antenna systems and antennas that cover multiple frequency bands used in the telecommunication wireless spectrum.

### Description of the Related Art

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

### SUMMARY

This disclosure relates to antennas that cover multiple frequency bands that are prolific in today's telecommunication wireless spectrum. The advances of telecommunications wireless devices have expanded the number of frequency bands that a radio can support for prolific coverage. For example, there are over 30 5G Bands that a radio may be asked to support if the radio is to provide ubiquitous coverage for a mobile device. While some of the LTE Bands overlap one another, there are numerous gaps between the bands as well. A multi-band approach to the antenna's frequency response provides a unique and novel radiating structure to support the numerous 5G bands.

According to some advantageous implementations, an antenna assembly is disclosed. The antenna assembly can include a base portion; a cover, the cover configured to be removably coupled to the base portion; a modem positioned on or above the base portion; a ground plane; and a multi-band antenna.

According to some implementations, an antenna system is disclosed. The antenna system can include a conductive sheet having a body portion with a front face, a head portion, a first left arm, and a first right arm; wherein the head portion angularly extends from the body portion; wherein the first left arm angularly extends from the body portion and the first right arm angularly extends from the body portion; wherein the front face is configured as a first resonating component, the head portion is configured as a second resonating component, the first left arm is configured as a third resonating component, and the first right arm is configured a fourth resonating component; and wherein at least one of the respective first, second, third, and fourth resonating components is configured to resonate within a low frequency band of between 450 MHz and 900 MHz during use and at least one of the respective first, second, third, and fourth resonating components is configured to resonate within a high frequency band of between 1 GHz and 8.0 GHz during use.

According to some implementations, an antenna assembly is disclosed. The antenna assembly can include a base portion, a cover, a modem, and a multi-band antenna. The cover can be configured to be removably coupled to the base portion to define an internal volume. The cover can include a support portion extending from a top side of the cover towards the base portion. The modem can be configured to be supported by the support portion. The multi-band antenna can be housed within the internal volume.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one implementation of the present disclosure in detail, it is to be understood that the implementations are not limited in its application to the details of construction and the arrangements of the components set forth in the following description or illustrated in the drawings. The implementations are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A illustrates a perspective view of an antenna assembly, in accordance with some aspects of this disclosure.

FIG. 1B illustrates a bottom side view of the antenna assembly of FIG. 1A, in accordance with some aspects of this disclosure.

FIGS. 2A and 2B illustrate a perspective view and a top side view respectively of the antenna assembly of FIG. 1A with a cover removed showing a first antenna configuration, in accordance with some aspects of this disclosure.

FIGS. 3A and 3B illustrate a perspective view and a top side view respectively of the antenna assembly of FIG. 1A with the cover removed showing a second antenna configuration, in accordance with some aspects of this disclosure.

FIGS. 3C and 3D illustrate a perspective view and a top side view respectively of another implementation of an antenna assembly with the cover removed showing a third antenna configuration, in accordance with some aspects of this disclosure.

FIG. 4A illustrates an isolation view of a ground plane of the antenna assembly of FIG. 1A, in accordance with some aspects of this disclosure.

FIG. 4B illustrates a bottom perspective view of the cover of the antenna assembly of FIG. 1A, in accordance with some aspects of this disclosure.

FIG. 4C illustrates a perspective view of a modem support of the antenna assembly of FIG. 1A, in accordance with some aspects of this disclosure.

FIGS. 5A-5K illustrate various views of components of a multi-band radiator portion that can be included in any antenna assembly described herein, in accordance with some aspects of this disclosure.

FIGS. 5L-5N illustrate various views of components of another implementation multi-band radiator portion that can be included in any antenna assembly described herein, in accordance with some aspects of this disclosure.

FIG. 6A illustrates a perspective view of an antenna assembly, in accordance with some aspects of this disclosure.

FIG. 6B illustrates a bottom side view of the antenna assembly of FIG. 6A, in accordance with some aspects of this disclosure.

FIGS. 7A-7C illustrate a perspective view, a top side view, and a side view respectively of the antenna assembly of FIG. 6A with a cover removed, in accordance with some aspects of this disclosure.

FIGS. 8A-8H illustrate various views of components of a multi-band radiator portion of the antenna assembly of FIG. 6A, in accordance with some aspects of this disclosure.

FIG. 9A illustrates a perspective view of an antenna assembly, in accordance with some aspects of this disclosure.

FIG. 9B illustrates a perspective view of the antenna assembly of FIG. 9A with a cover removed showing an antenna configuration, in accordance with some aspects of this disclosure.

FIGS. 9C and 9D illustrate a top perspective view and a bottom perspective view respectively of the cover of the antenna assembly of FIG. 9A in isolation, in accordance with some aspects of this disclosure.

FIGS. 9E-9L illustrate various views of another implementation of the assembly of FIG. 9A, in accordance with some aspects of this disclosure.

FIG. 9M illustrates a perspective view of a modem shell that can be used with the antenna assembly of FIG. 9A, in accordance with some aspects of this disclosure.

FIG. 9N illustrates a perspective view of a modem and the modem shell of FIG. 9M, in accordance with some aspects of this disclosure.

FIGS. 9O-9T illustrate a top-side view, bottom-side view, left-side view, right-side view, front-side view, back-side view respectively of the modem shell of FIG. 9M, in accordance with some aspects of this disclosure.

FIGS. 10A-10J illustrate various views of components of another implementation of a multi-band radiator portion that can be included in any antenna assembly described herein, in accordance with some aspects of this disclosure.

FIGS. 11A-11C illustrate various views of any implementation of a multi-band antenna that can be included in an antenna assembly described herein, in accordance with some aspects of this disclosure.

FIGS. 12A-12B illustrate various views of another implementation of a multi-band antenna that can be included in any antenna assembly described herein, in accordance with some aspects of this disclosure.

FIGS. 13A-13C illustrate various views of another implementation of a multi-band antenna that can be included in any antenna assembly described herein, in accordance with some aspects of this disclosure.

FIGS. 14A-14D illustrate various views of another implementation of a multi-band antenna that can be included in any antenna assembly described herein, in accordance with some aspects of this disclosure.

FIGS. 15A-15B illustrate various views of another implementation of a multi-band antenna that can be included in any antenna assembly described herein, in accordance with some aspects of this disclosure.

FIG. 16 illustrates a perspective view of a stacked patch antenna on a ground plane that can be included in any antenna assembly described herein, in accordance with some aspects of this disclosure.

FIGS. 17A-17G illustrate various views of components of another implementation multi-band radiator portion that can be included in any antenna assembly described herein, in accordance with some aspects of this disclosure.

FIGS. 18A-18D illustrate various implementations of millimeter wave radios with their antennas that can be included in the any antenna assembly described herein, in accordance with some aspects of this disclosure.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

### DETAILED DESCRIPTION

Illustrative implementations of the present disclosure are described below. In the interest of clarity, not all features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the implementations described herein may be oriented in any desired direction.

The system and method will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

Antenna Assembly with First Multi-Band Radiator Portions

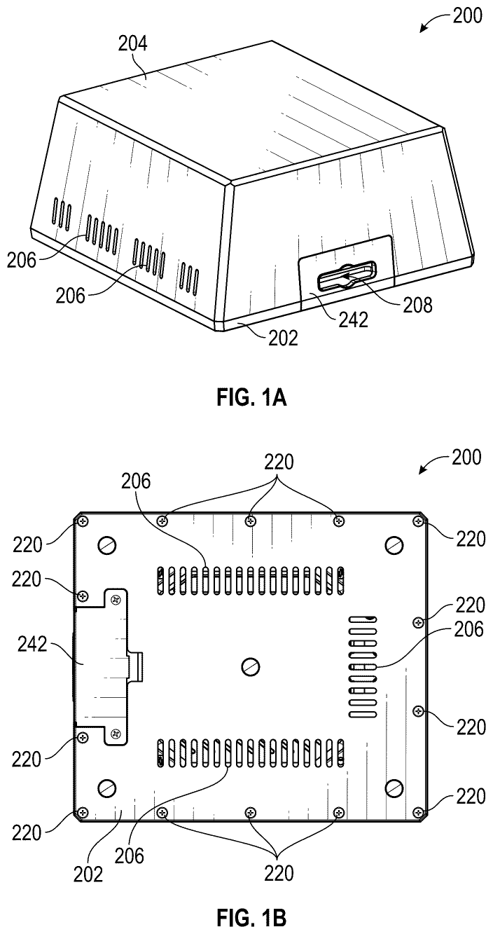

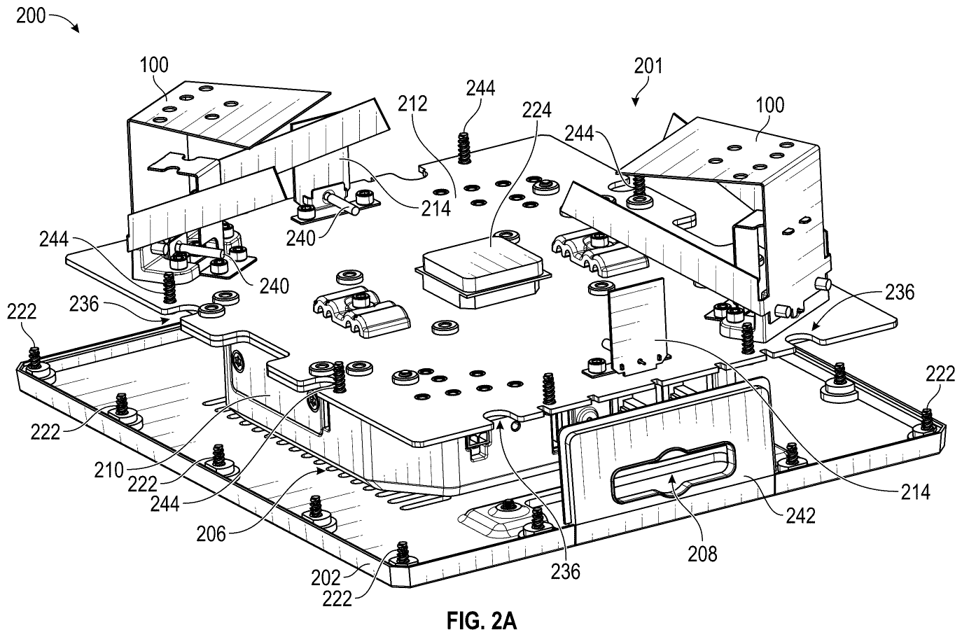

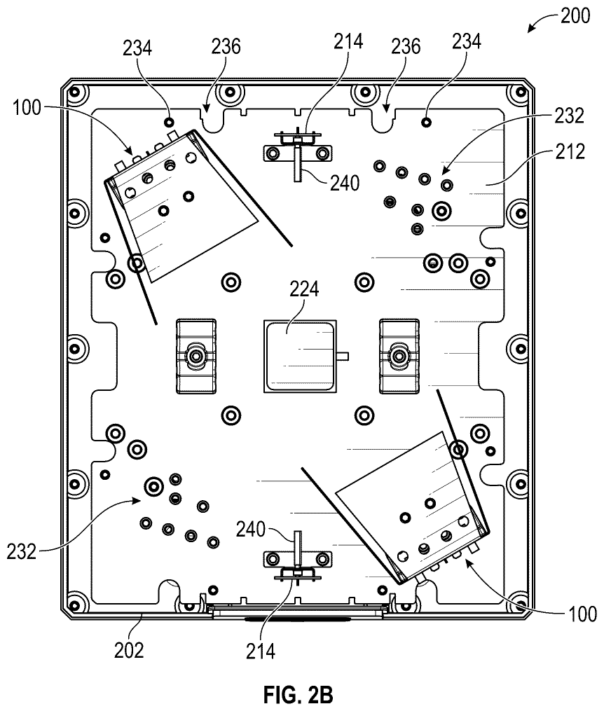

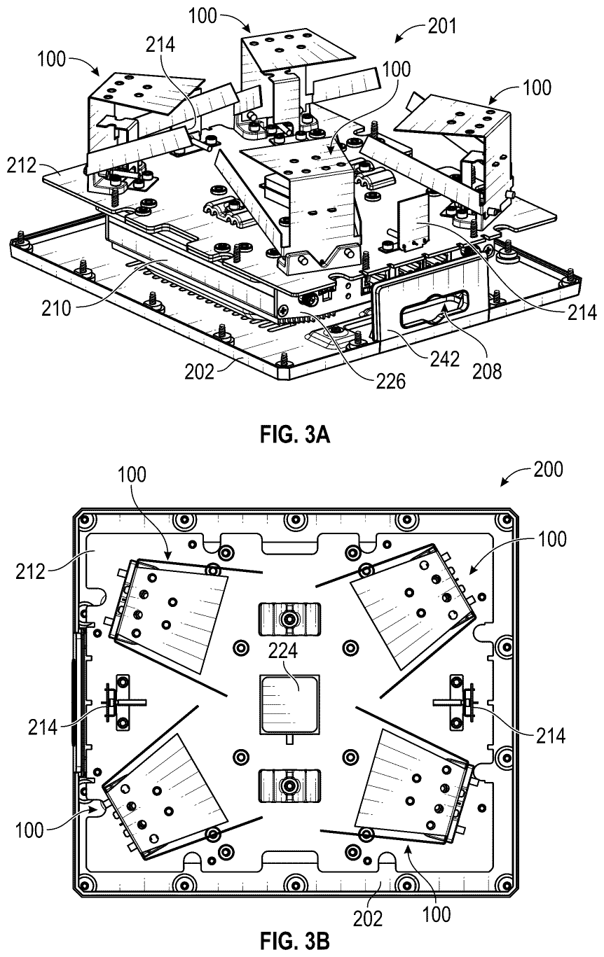

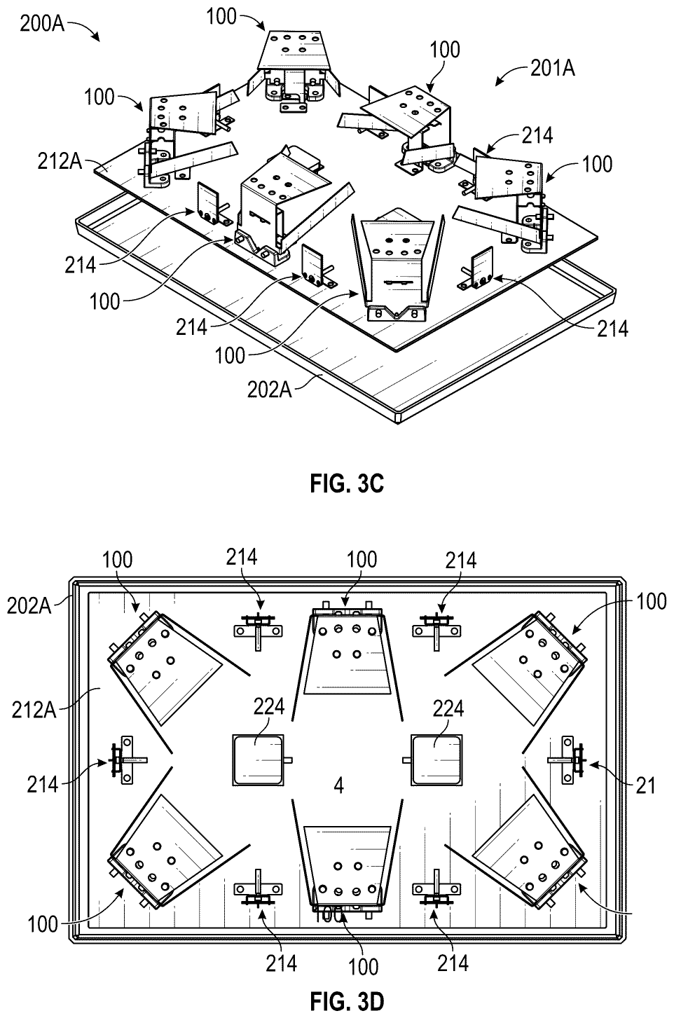

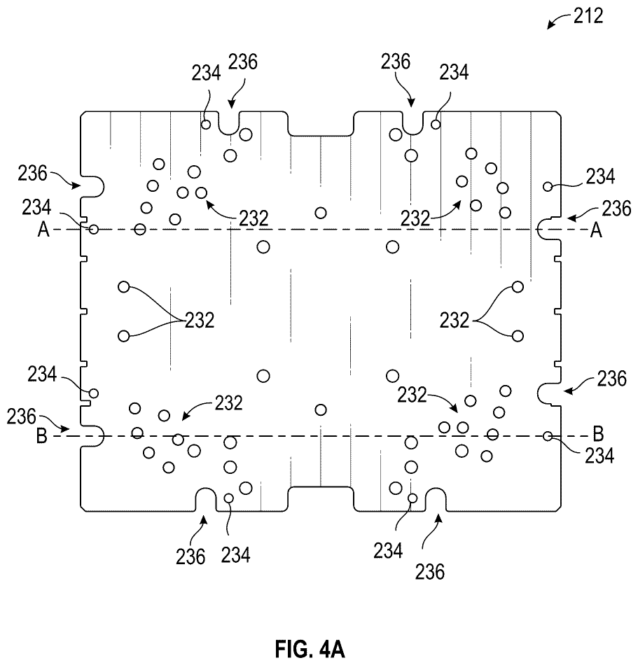

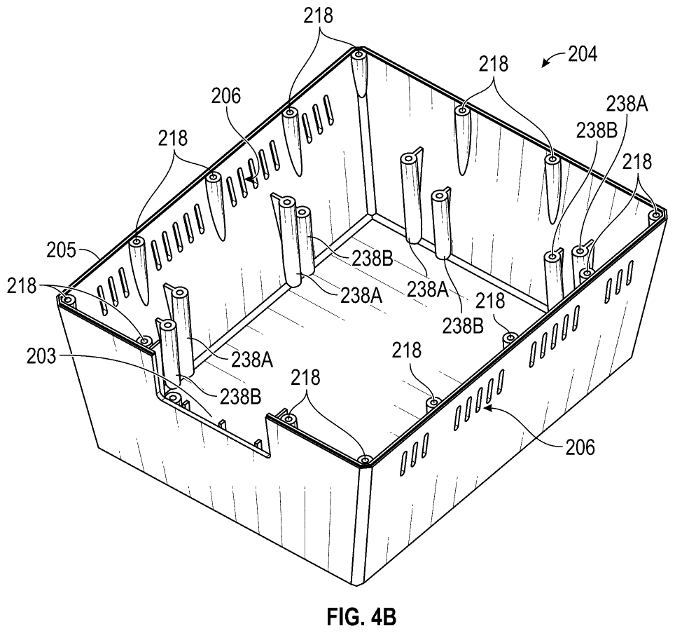

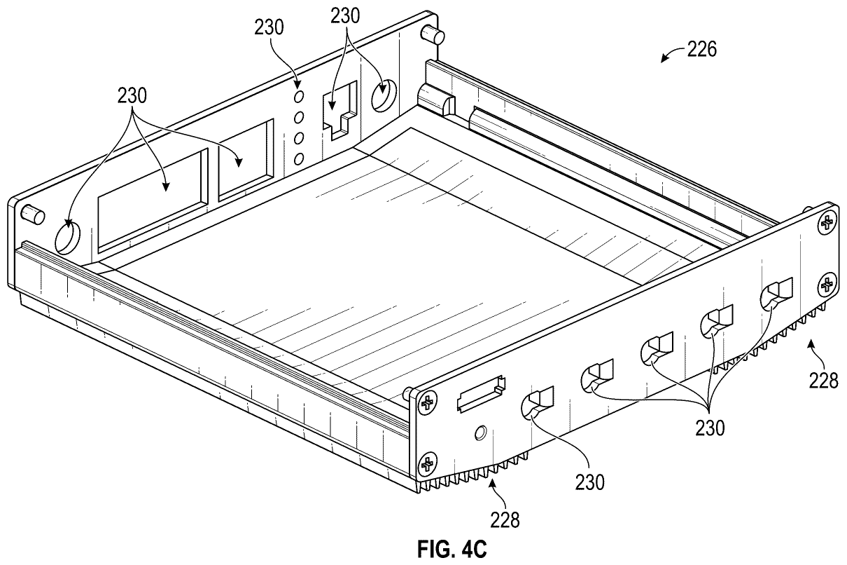

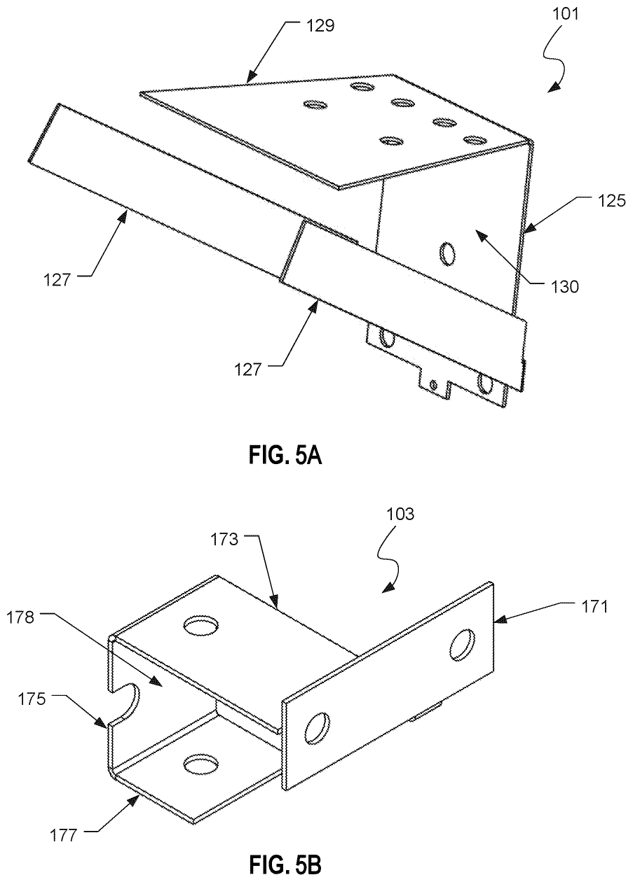

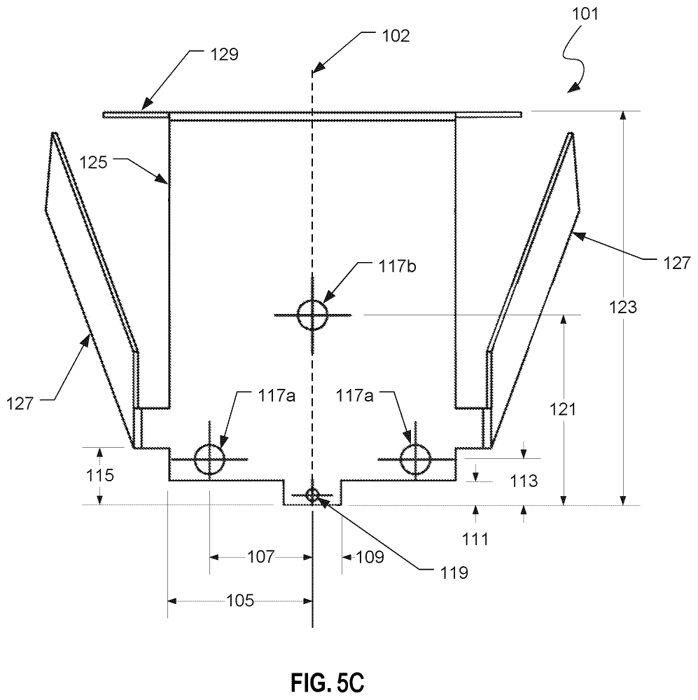

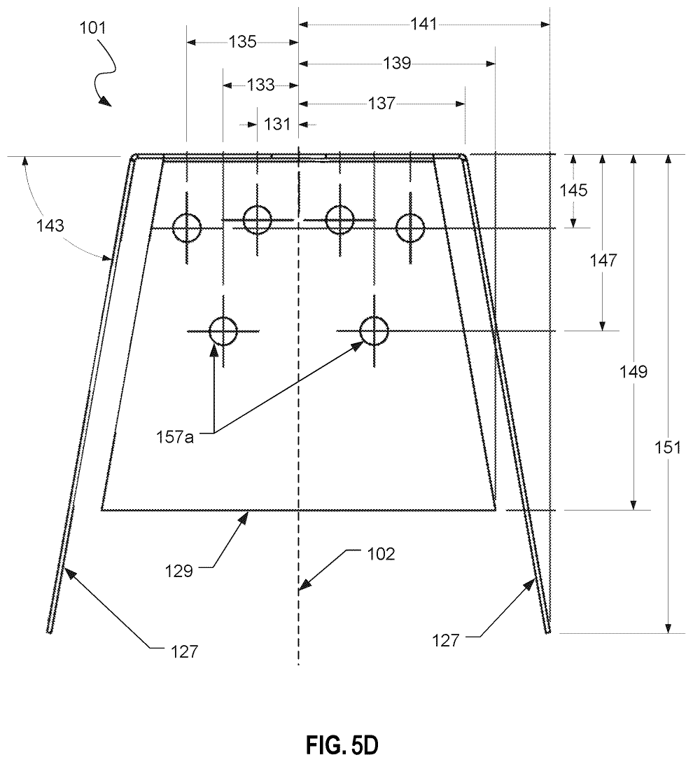

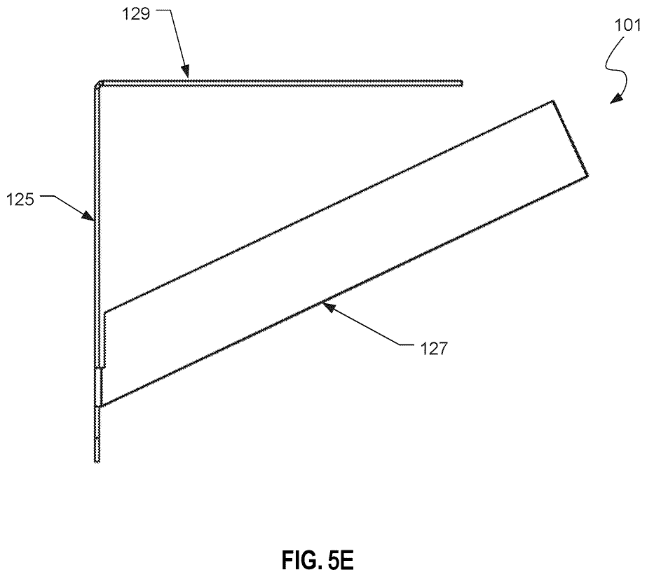

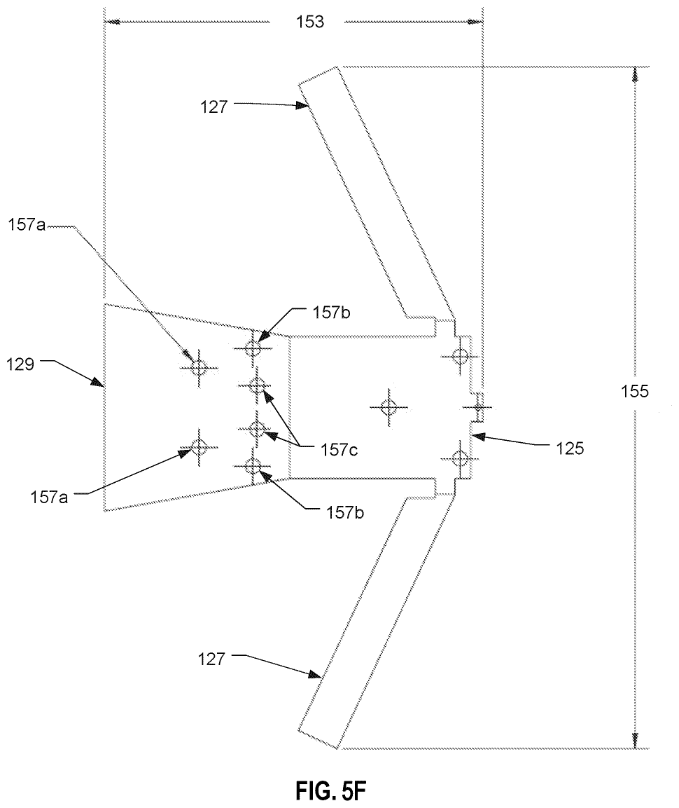

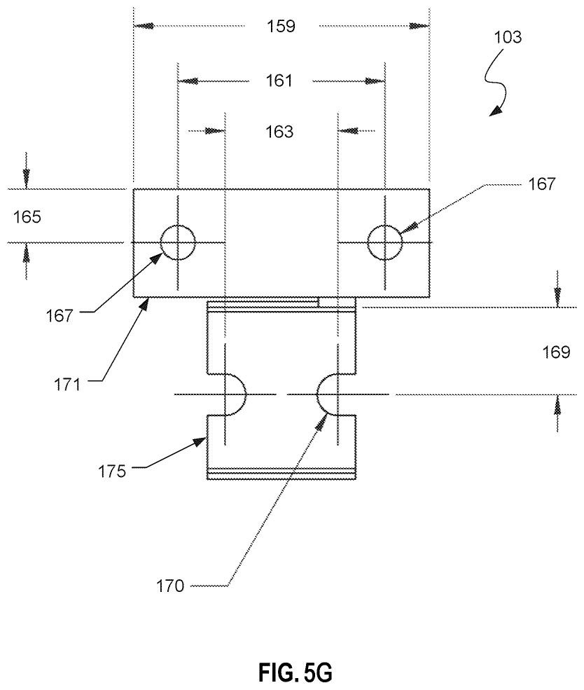

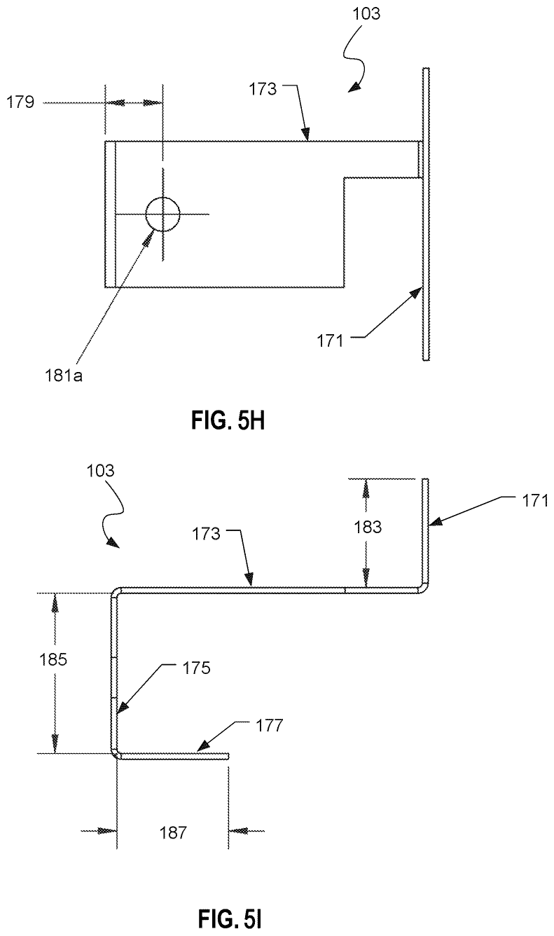

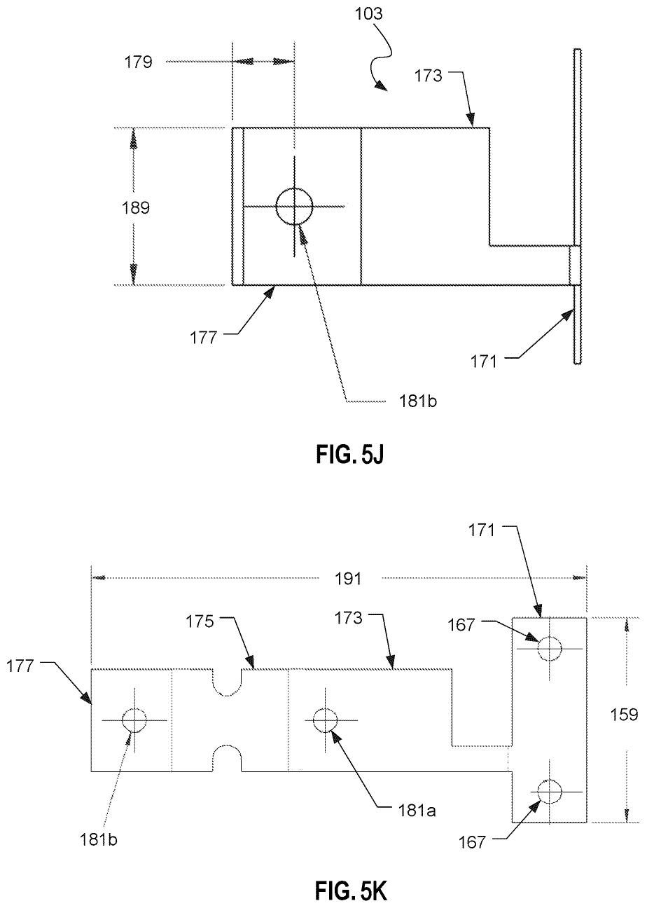

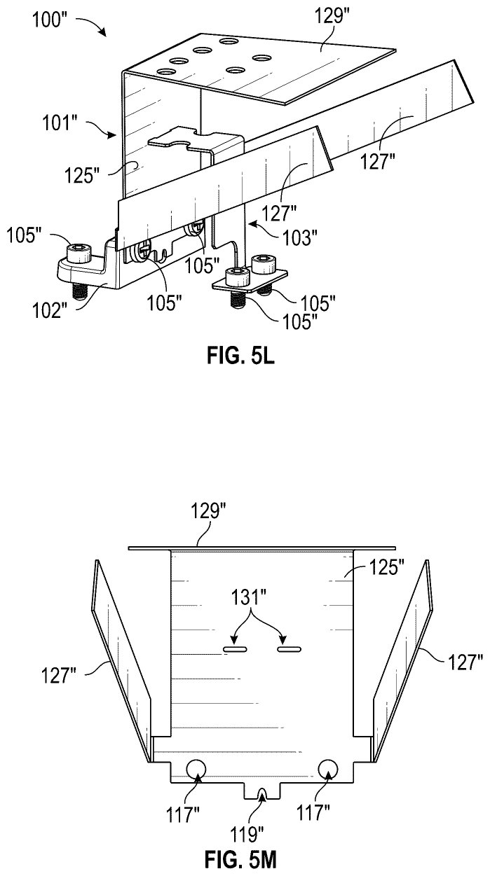

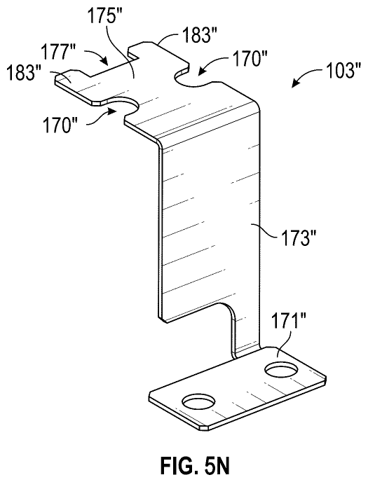

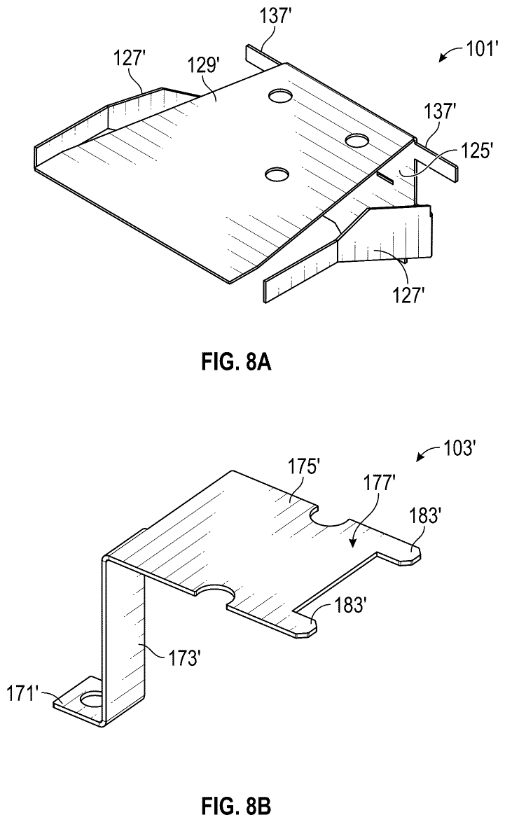

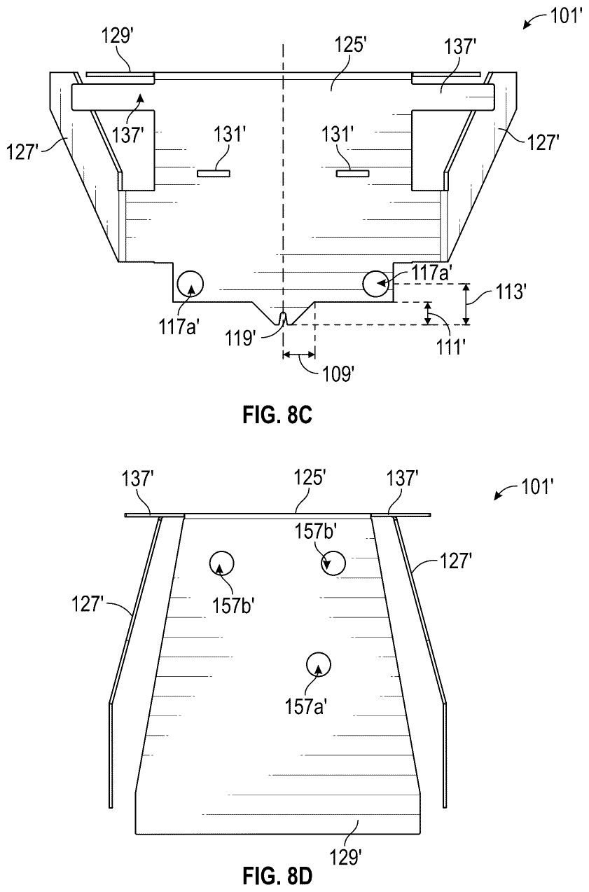

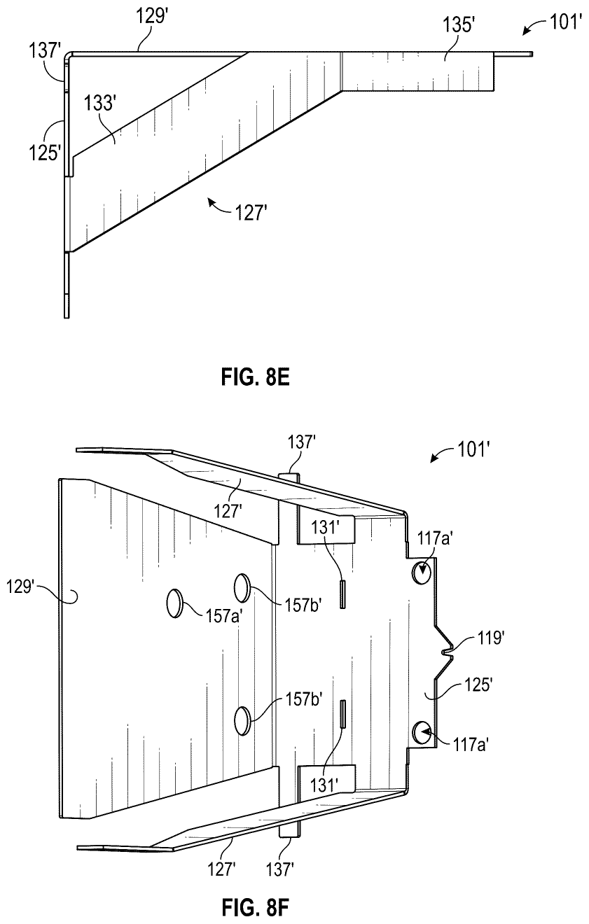

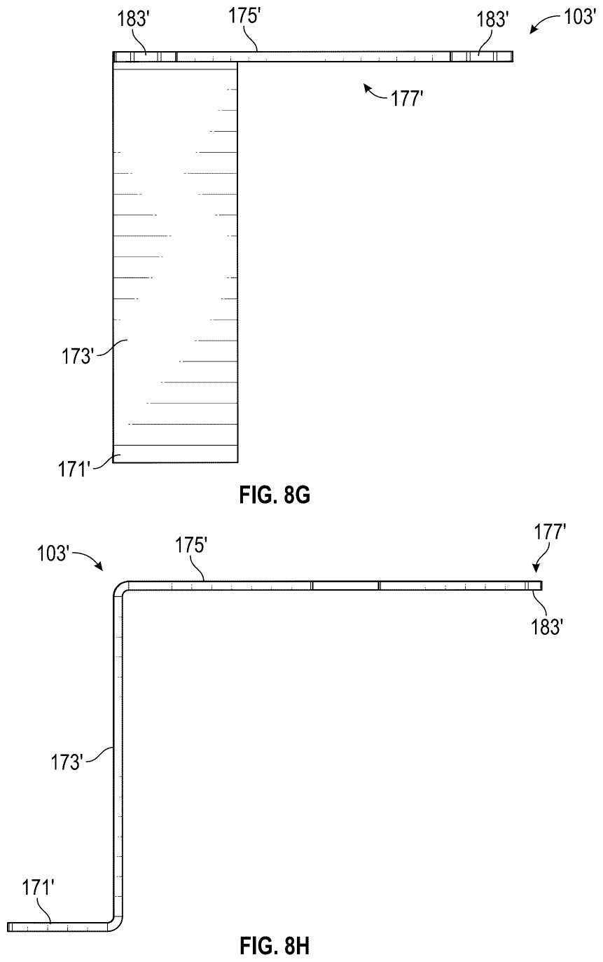

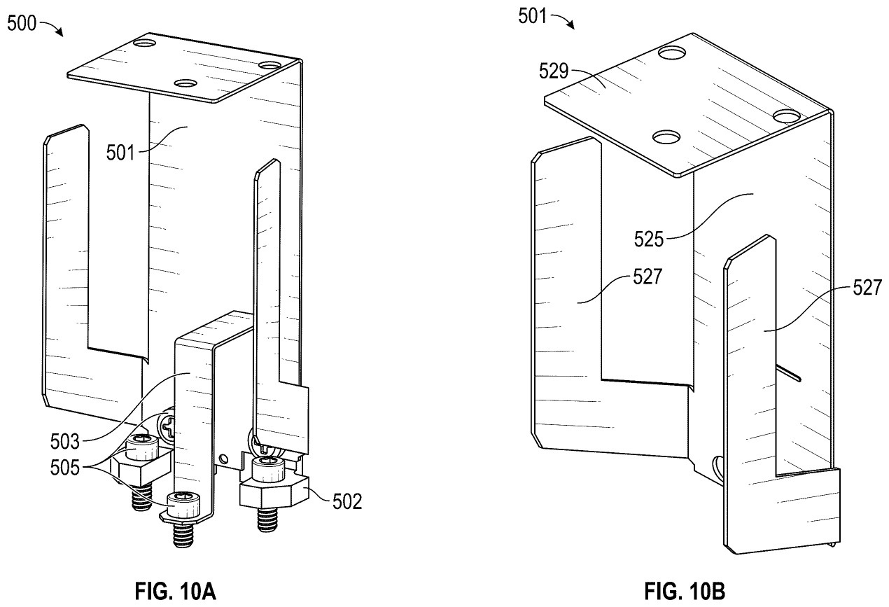

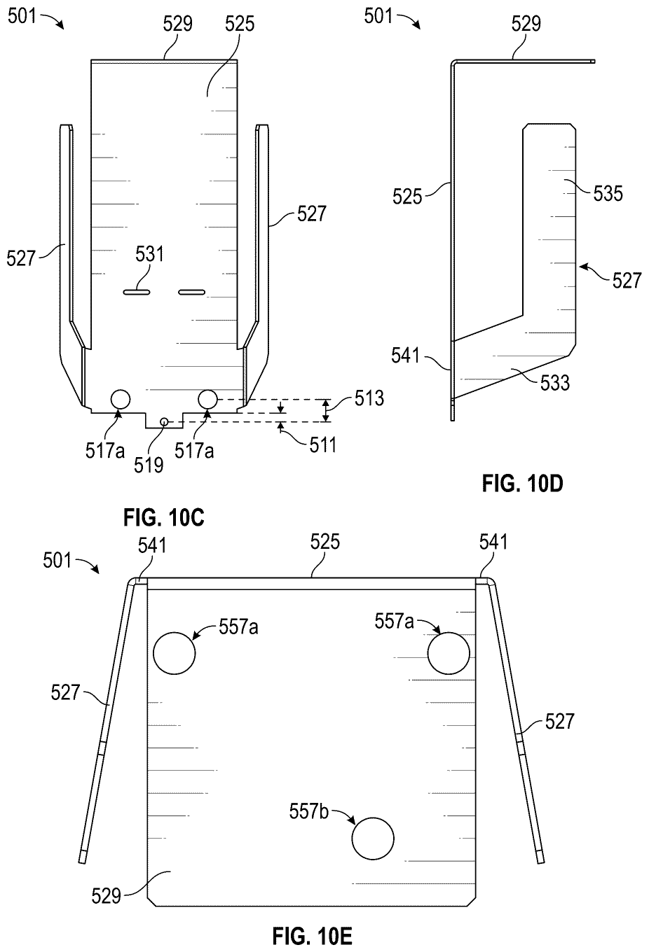

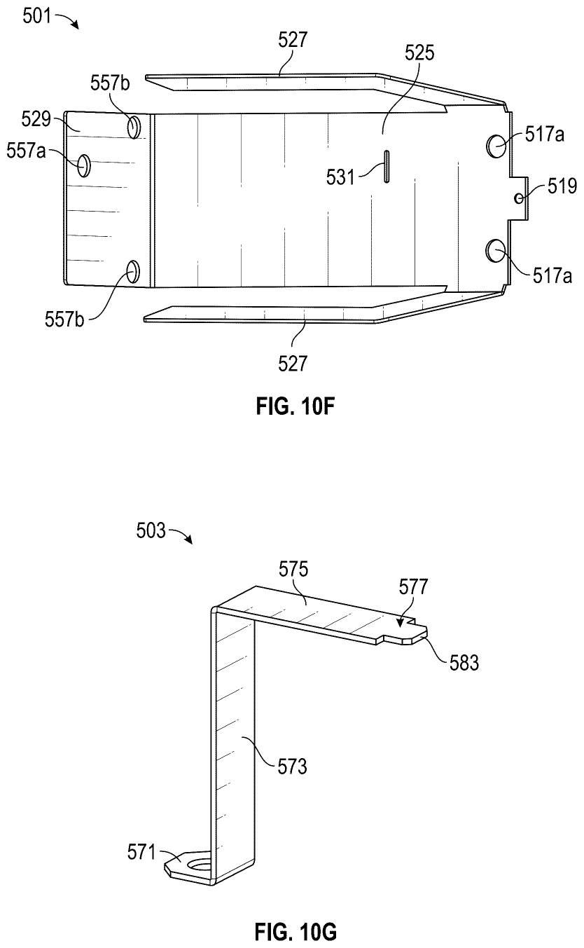

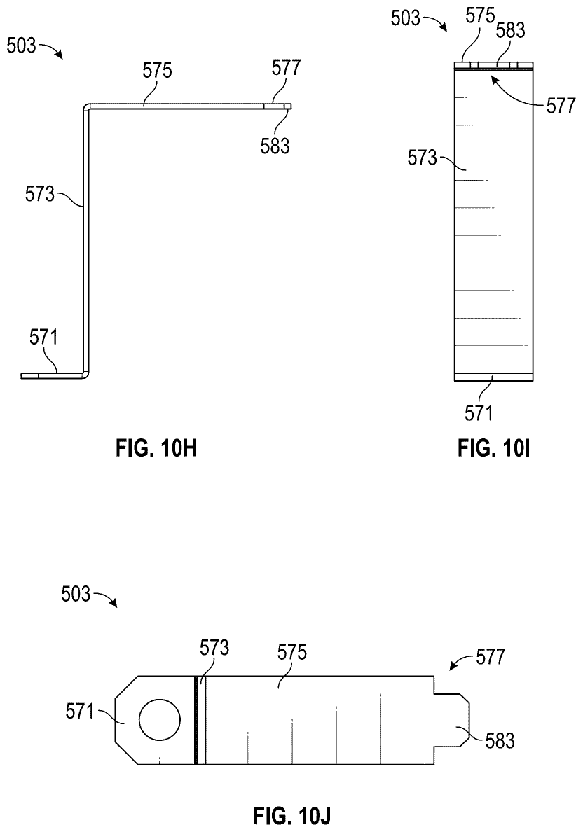

Referring now to the drawings wherein like reference characters identify corresponding or similar elements in form and function throughout the several views. FIGS. 1A and 1B illustrate various views of an antenna assembly. FIGS. 2A and 2B illustrate various views of the antenna assembly of FIG. 1A with the cover removed with two multi-band radiator portions. FIGS. 3A and 3B illustrate various views of the antenna assembly of FIG. 1A with the cover removed with four multi-band radiator portions. FIGS. 3C and 3D illustrate various views of another implementation of an antenna assembly with the cover removed with six multi-band radiator portions. FIGS. 4A-4C illustrate various isolation views of components of the antenna assembly of FIG. 1A. FIGS. 5A-5K and 5L-5N illustrate various views of components of a multi-band radiator portion of the antenna assembly of FIG. 1A, in accordance with some aspects of this disclosure. FIGS. 8A-8H illustrate various views of components of another implementation of a multi-band radiator portion that can be included in an antenna assembly described herein, such as the antenna assembly of FIG. 1A. FIGS. 10A-18D illustrate various views of additional components that can be included in any of the antenna assemblies described herein, such as the antenna assembly of FIG. 1A.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

With reference to FIG. 1A, a perspective view of an antenna assembly 200 is illustrated in accordance with an implementation of the present disclosure. The antenna assembly 200 may include a base 202, a cover 204, and a multi-band antenna 201. As shown in FIGS. 2A-3B, the multi-band antenna can include one or more antennas (e.g., one or more multi-band radiator portions 100, one or more dual-band WiFi radiator portions 214, etc.), as described further herein. The antennas 100, 214 may also be referred to herein as “radiating antenna elements”, “antenna elements” and “radiating portions.” The antenna assembly 200 can be configured to provide wireless internet connectivity for a plurality of uses (e.g., data, voice communication, video, and/or the like). The antenna assembly 200 may be used in a wide range of applications. For example, the antenna assembly 200 may be used in indoor environments, at home applications, work environments, and/or the like. In some implementations, the antenna assembly 200 can be a 2×2 MIMO LTE/5G antenna, a 4×4 MIMO LTE/5G antenna, and/or the like. In some implementations, the antenna assembly 200 can be a 2×2 MIMO WIFI antenna, a 4×4 MIMO WIFI antenna, and/or the like. In some implementations, the antenna assembly 200 can include a GPS. In some implementations, the antenna assembly 200 can include a router, a modem, a modem-router, and/or the like.

In some implementations, any of the multi-band multi-element antennas described herein (e.g., the multi-band multi-element antenna 201) can include radiating elements (e.g., the multi-band radiator portions 100, multi-band radiator portion 100′, dual-band WiFi radiator portions 214, and/or any other antenna or radiating portions described herein) configured to radiate at specific frequency bands. For example, the radiating elements 100, 100′, and/or 214 can be configured for one or more of: low-band operation (approximately 600 MHz to 900 MHZ), mid-band operation (approximately 1.7 GHZ to 2.7 GHZ), CBRS-band (“C-band”) operation (approximately 3.4 GHz to 4.2 GHZ), and/or 5 GHz Wi-Fi-band (“Wi-Fi-band”) operation (approximately 4.8 GHz to 7.25 GHZ), depending on the desired performance of the antenna assembly. Throughout the disclosure, reference may be made to a “high-band”, or certain radiating elements may be described as configured for “high-band operation”. High-band operation may cover approximately 1.6 GHz to 6 GHz, in some implementations.

FIG. 1B illustrates a bottom side view of the antenna assembly 200. With reference to FIGS. 1A and 1B, the antenna assembly 200 can include the base 202 and the cover 204 (also referred to herein as “radome 204”). A bottom perspective view of the cover 204 is shown in FIG. 4B. The cover 204 can be removably coupled to the base 202 to define an internal volume of the antenna assembly 200. For example, the cover 204 can include a plurality of base fastener bosses 218 (see e.g., FIG. 4B) and the base 202 can include a plurality of fastener holes 220. Fasteners 222 (see e.g., FIG. 2A) can be inserted through the fastener holes 220 and into the fastener bosses 218 to couple the base 202 to the cover 204. Other conventional methods can be used to couple the cover 204 to the base 202. As shown in FIG. 1A, the cover 204 can be coupled to a top side of the base 202. The base 202 and cover 204 can protect and/or provide mechanical support for the internal components of the antenna assembly 200 (e.g., the antennas 100, any other antennas utilized in the antenna assembly 200, etc.). For example, as discussed herein, the antennas 100 (as well as other radiator portions) can be secured within the internal volume. In some implementations, the cover 204 may be transparent to radiation from the antenna portions and may serve as an environmental shield for the internal components of antenna assembly 200. One or both of the base 202 and cover 204 can be made of non-conductive materials. For example, the base 202 and/or cover 204 may not be made of metal. In some examples, the base 202 and/or cover 204 can be made of plastic, fiberglass, and/or the like materials that allow RF signals to pass through. In other implementations, the base 202 can be made of an electrically conductive material, such as a metal. “Conductive” as the term is used herein generally references to electrical conduction. The cover 204 can be configured to be removably coupled to the base 202. For example, a bottom edge of the cover 204 can be configured to interface with a top edge of the base 202.

One or more of the base 202 and the cover 204 can include one or more vents 206. Vents 206 can be configured for heat flow (e.g., to allow heat produced by the components of the antenna assembly 200 to be exchanged with the environment). For example, the cover 204 can include one or more vents 206 in the side walls and/or the top wall (not shown). Similarly, the base 202 can include one or more vents 206 that pass through the base 202 to promote heat flow. The cover 204 can include an opening 208 in one or more side walls to facilitate access to an internal modem 210 that may include coaxial and discrete wire cables (see e.g., FIG. 2A). The internal modem 210 can be a router, a modem, a modem-router, and/or the like. The opening 208 can provide access to data and power connections of the internal modem 210. The internal modem 210 can be a telecommunications modem, in some implementations. In some implementations, the opening 208 can be formed in a door 242, as shown in at least FIG. 2A. The door 242 can form a portion of the base 202 and/or cover 204. The door 242 can be removably coupled to the base 202 and/or the cover 204. Removing the door 242 can provide greater access into the internal volume of the antenna assembly 200, without requiring the cover 204 to be removed from the base 202.

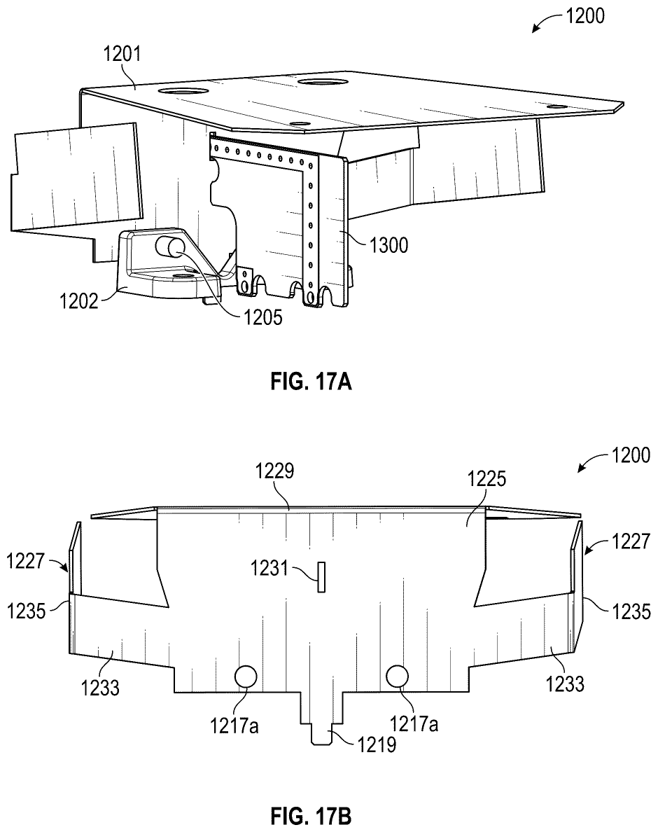

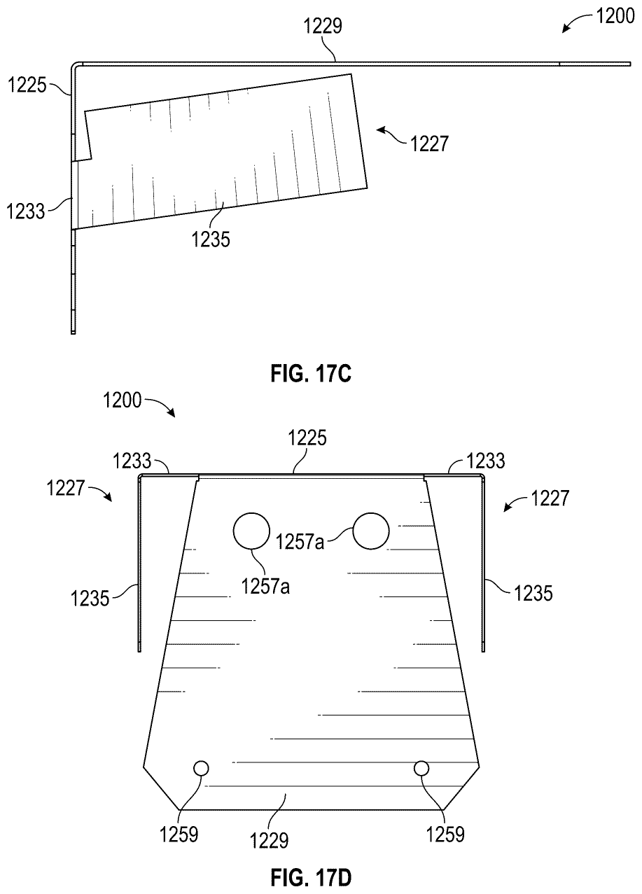

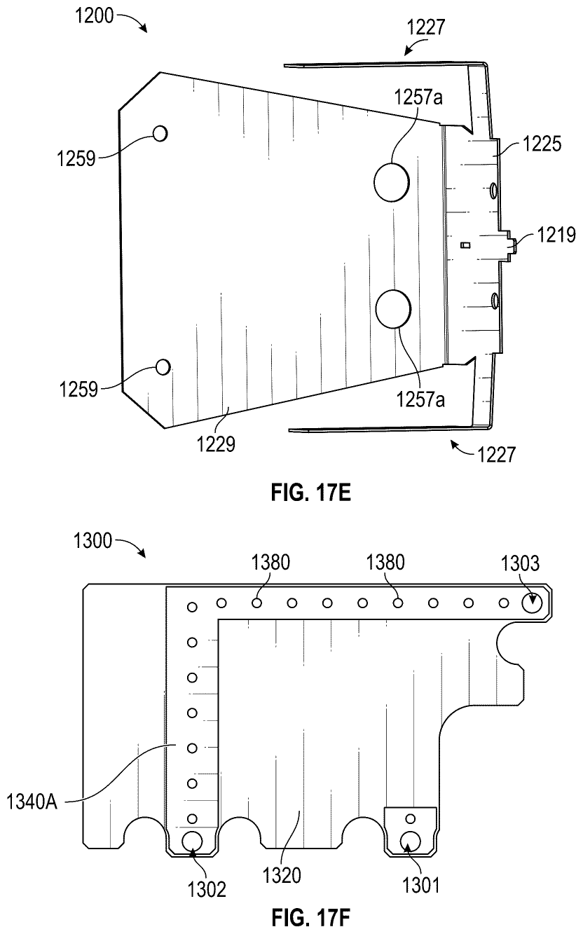

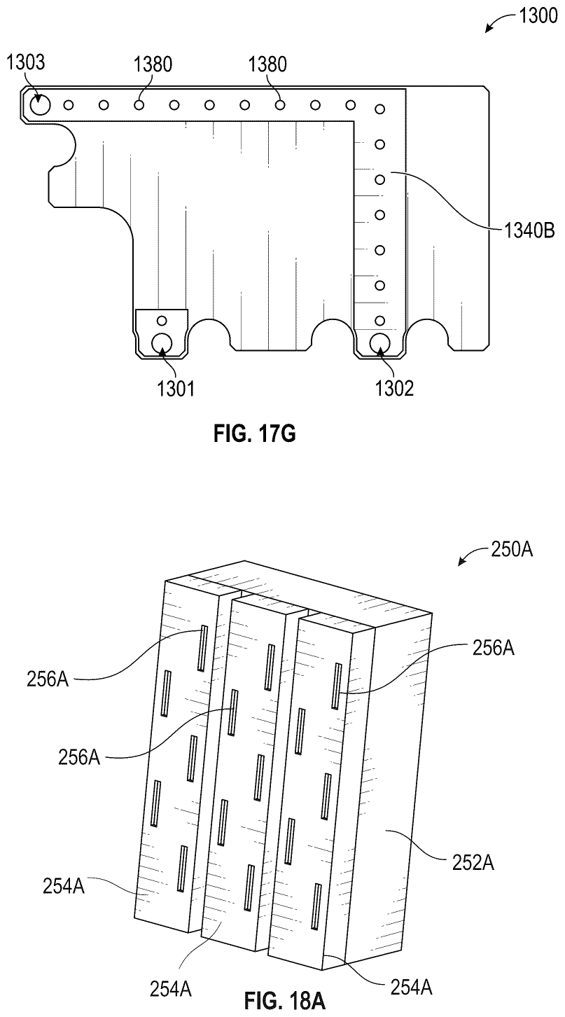

In some implementations, the antenna assembly 200 can be configured to be supported by the base 202 in an arrangement with the base 202 positioned below the cover 204 (e.g., on a horizontal surface). In some implementations, the base 202 can be configured to be mounted to a vertical surface (e.g., a wall). Mounting the antenna assembly 200 to a wall (e.g., via the base 202 or an additional component) can provide certain advantages, particularly when the antenna is configured as a directional antenna, as described herein. In some cases, the antenna assembly 200 can be configured as a directional antenna, such as when one or more multi-band radiator portions 1200 of FIGS. 17A-17G and/or one or more stacked patch antennas 1100 of FIG. 16 are included in the antenna assembly 200. When the antenna assembly 200 is configured as a directional antenna, mounting the antenna assembly 200 on the wall can provide certain advantages. For example, a wall-mounted antenna assembly 200 can allow for an elevated position, which can provide a clearer line of sight to the device or networks the antenna assembly 200 is intending to communicate with (e.g., by reducing obstructions such as furniture, people, other objects) compared to if the antenna assembly 200 was positioned on a table. The wall-mounting of the antenna assembly 200 can also reduce potential interferences from other electronic devices positioned near the antenna assembly 200, with can improve signal quality and consistency in some cases. A wall-mounted antenna assembly 200 configured as a directional antenna can be aimed in a specific direction. For example, by wall-mounting, the antenna assembly 200 can be strategically pointed towards an area or device.

In some implementations, when the antenna assembly 200 is configured as a directional antenna (e.g., including one or more stacked patch antennas 1100 and/or multi-band radiator portions 1200) it can be advantageous to position the base 202 on a horizontal surface in some cases (e.g., to point vertically). For example, such an arrangement can be desirable when the antenna assembly 200 is configured to communicate with a satellite. In this example, the vertical direction of the antenna assembly 200 can provide improved line of sight to the satellite(s). For example, pointing the antenna assembly 200 vertically toward the satellite ensures the strongest possible signal is directed at the target. Misalignment could result in signal loss or weak reception. In some cases, satellite communication systems often require precise alignment in both azimuth (horizontal) and elevation (vertical) to maintain an optimal connection. A vertically oriented antenna assembly 200 configured as a directional antenna will can be aimed at a specific elevation angle that matches the satellite's position relative to the ground station. An additional advantage of pointing the antenna assembly 200 vertically can include minimizing interference from terrestrial signals and reflections from the ground or nearby objects, which can be especially important when communicating with high-altitude satellites.

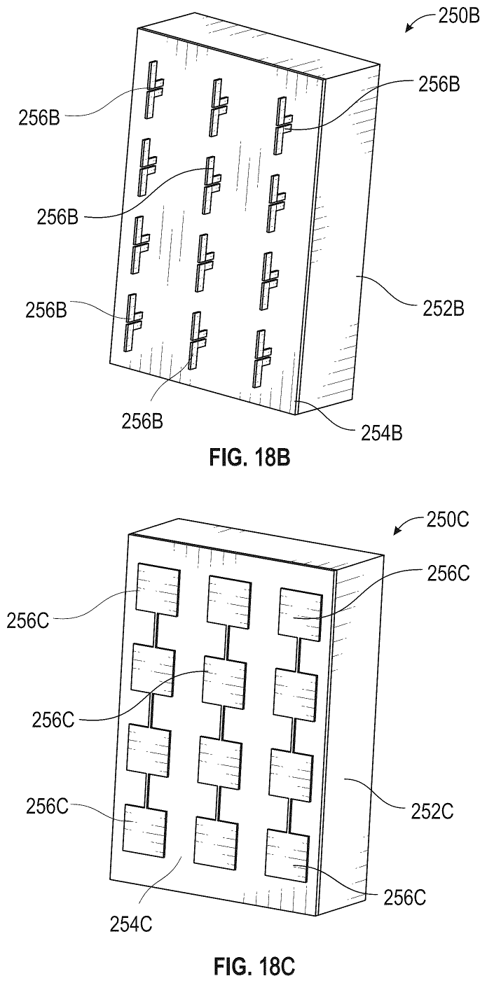

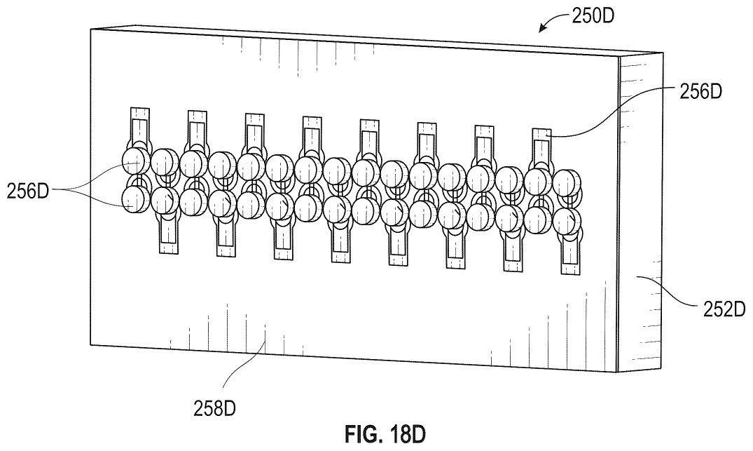

FIGS. 2A-3B illustrate various views of the antenna assembly 200 with the cover 204 removed. The antenna assembly 200 can include the modem 210, a ground plane 212, the multi-band antenna 201, and/or one or more GPS antennas 224. The multi-band antenna 201 can include one or more dual-band WiFi radiator antennas 214, and/or one or more multi-band radiator portions/antennas 100. FIGS. 2A and 2B show the antenna assembly 200 in a first configuration that includes two dual-band WiFi radiator portions 214 and two multi-band radiator portions 100. FIGS. 3A and 3B show the antenna assembly 200 in a second configuration that includes two dual-band WiFi radiator portions 214 and four multi-band radiator portions 100. Other configurations of the antenna assembly 200 are possible with different numbers of multi-band radiator portions 100 and dual-band WiFi radiator portions 214, depending on the desired application. As described further herein, various alternative antenna elements can also be incorporated into the multi-band multi-element antenna 201, in some implementations. For example, any of the multi-band radiator multi-band radiator portions 100, multi-band radiator portions 100′, multi-band radiator portion 100″, dual-band WiFi radiator portions 214, GPS antenna elements 224, multi-band radiator portion 500, multi-band antenna 600, multi-band antenna 700, multi-band antenna 800, multi-band antenna 900, multi-band antenna 1000, stacked patch antenna 1100, and/or multi-band radiator portion 1200 can form part of the multi-band multi-element antenna 201. Additionally, in some implementations, any of the millimeter wave radios 250 described with reference to at least FIGS. 18A-18D can be incorporated into the antenna assembly 200.

With reference to FIG. 2A, the internal modem 210 can be supported by the base 202 or the ground plane 212. As noted herein, the internal modem 210 can include data and power connections for the antenna assembly 200. In some implementations, the one or more vents 206 in the side walls of the cover 204 can be arranged alongside the internal modem 210 to promote heat flow. Similarly, the one or more vents 206 in the base 202 can be positioned around the internal modem 210.

FIG. 4C shows an implementation of a modem support 226. The modem support 226 can be configured to house the internal modem 210. For example, the internal modem 210 can be positioned in and/or coupled to the modem support 226. The modem support 226 can be coupled to and/or supported by the base 202 or the ground plane 212. The modem support 226 can isolate the internal modem 210 from the base 202. The modem support 226 can include a plurality of fins 228 on a bottom side of the modem support 226. The plurality of fins 228 can be used to promote additional heat flow from the internal modem 210 to the surrounding space, which can promote better convective heat flow for the internal modem 210. In some implementations, the plurality of fins 228 can act as heat exchangers for the internal modem 210. The modem support 226 can include a plurality of openings 230 in various shapes and sizes. The plurality of openings 230 can be used to route cables through the modem support 226 to the internal modem 210.

FIG. 4A shows an isolation top view of the ground plane 212 and FIGS. 2A-3B show the ground plane 212 positioned within the antenna assembly 200. The ground plane 212 may serve as the ground reference for at least the dual-band WiFi radiator antennas 214, the multi-band radiator portions 100, and the GPS antenna 224. The ground plane 212 can also serve as the ground reference for any additional antennas or antenna components included in the antenna assembly 200. The ground plane 212 may be positioned above the internal modem 210 relative to the base 202. For example, the ground plane 212 may be coupled to the walls of the cover 204 such that the ground plane 212 is suspended above the base 202. In some implementations, the ground plane 212 may divide the internal volume of the antenna assembly 200 into a top internal volume or enclosure, for the dual-band WiFi radiator antennas 214, the multi-band radiator portions 100, the GPS antenna 224, and/or any additional antennas, and a bottom internal volume or enclosure, for the internal modem 210. The antenna portions 214, 100 and the GPS antenna 224 may be coupled to a top side of the ground plane 212. In the assembled antenna assembly 200, the ground plane 212 can be covered by the cover 204, enclosing the internal volume of the antenna assembly 200. In some implementations, the ground plane 212 can serve as a heat sink or heat spreader. For example, the ground plane 212 can be a heat sink for the internal modem 210. In implementations of the antenna assembly 200 that include one or more vents 206 in the top half of the walls of the cover 204 and/or in the top wall of the cover 204, the ground plane 212 can promote heat exchange from the internal modem 210 to the external environment through the slots 206 in the cover 204.

With continued reference to FIG. 4A, the ground plane 212 can be configured to accommodate modems 210 with different thicknesses. For example, the ground plane 212 can be rotated 180 degrees about its long axis to change which mounting bosses of the cover 204 engage the ground plane 212. The ground plane 212 can include a plurality of antenna holes 232. The antenna holes 232 can be used to mount the various antennas to the ground plane 212 and/or to route cables through the ground plane 212 to, for example, connect to the internal modem 210. In some implementations, the ground plane 212 can also include a plurality of cover holes 234 and/or a plurality of cover slots 236. The cover holes 234 can be used to couple the ground plane 212 to the cover 204. For example, as shown in FIG. 4B, the cover 204 can include a plurality of ground plane bosses 238 that extend along the side walls of the cover 204. The ground plane bosses 238 can extend from near a top side 203 of the cover 204 partially along the side walls towards a bottom edge 205 of the cover.

As shown in FIG. 4B, in some implementations, the cover 204 can include ground plane bosses 238 with different heights relative to the top side 203. For example, the cover 204 can include a plurality of first bosses 238A with a first height and a plurality of second bosses 238B with a second height. The first height of the plurality of first bosses 238A can be larger than the second height of the plurality of second bosses 238B. Each first boss 238A can be positioned adjacent to a second boss 238B. The ground plane bosses 238 can be configured to receive fasteners 244 (see e.g., FIG. 2A) to removably couple the ground plane 212 to the cover 204 via the cover holes 234. The different height bosses 238 can be used to change the position of the ground plane 212 relative to the top side 203 and change the ratio of the top internal volume to the bottom internal volume. For example, when the cover holes 234 of the ground plane 212 are aligned with the second bosses 238B, the ground plane 212 is positioned closer to the top side 203 of the cover 204. In this arrangement, the antenna assembly 200 can accommodate an internal modem 210 with a larger height and/or shorter height multi-band radiator portions 100 (e.g., such an arrangement may be desirable when one or more multi-band radiator portions 1200 of FIGS. 17A-17F are included in the antenna assembly 200). Conversely, when the cover holes 234 of the ground plane 212 are aligned with the first bosses 238A, the ground plane 212 is positioned further from the top side 203 of the cover 204. In this arrangement, the antenna assembly 200 can accommodate an internal modem 210 with a smaller height and/or multi-band radiator portions 100 with a larger height (e.g., such an arrangement may be desirable when one or more multi-band radiator portions 500 of FIGS. 10A-10J are included in the antenna assembly 200).

Referring back to FIG. 4A, each cover hole 234 is located adjacent to a cover slot 236. Cover slots 236 on one side of the ground plane 212 are aligned with cover holes 234 on the opposite side of the ground plane 212 and vice versa (see e.g., lines A-A and B-B). As such, when the ground plane 212 is positioned in the cover 204 in a first orientation, all of the cover holes 234 can be aligned with all of the second bosses 238B of the cover 204 and all of the cover slots 236 can be aligned with all of the first bosses 238A. The cover slots 236 can be sized to receive the first bosses 238A while enabling the cover holes 234 to be aligned with the second bosses 238B. In this arrangement, the top internal volume is at a minimum and the bottom internal volume is at a maximum. To change the ratio of the top internal volume to the bottom internal volume, the ground plane 212 can be positioned in the cover 204 in a second orientation. For example, the ground plane 212 can be rotated 180 degrees from the first orientation to the second orientation. In the second orientation, the cover holes 234 can be aligned with the first bosses 238A. In this arrangement, the top internal volume is at a maximum and the bottom internal volume is at a minimum. In some implementations, fasteners can be used to couple the ground plane 212 to the cover 204. As such, the fasteners can be easily removed to move the ground plane 212 from the first orientation to the second orientation to change volumes of the top and bottom internal volumes. Including a ground plane 212 that can be used to change the ratio of internal volumes of the antenna assembly 200 can provide a benefit of allowing different sized modems and antennas to be used in the same protective case (e.g., the base 202 and the cover 204). As such, the antenna assembly 200 can be modified for individual applications with minimal modifications. For example, when it is desirable to include one or more multi-band radiator portions 500 of FIGS. 10A-10J in the antenna assembly 200, a larger top internal volume may be required. Similarly, when it is desirable to include one or more multi-band radiator portions 1200 of FIGS. 17A-17F in the antenna assembly 200, a smaller top internal volume may be utilized.

Referring back to FIGS. 2A-3B, the dual-band WiFi radiator antennas 214 can be used for un-licensed band wireless telecommunication purposes. In some implementations, the antennas 214 can be configured operation at frequencies above approximately 1 GHz. For example, the antennas 214 can be configured as multi-band Wi-Fi radios, 3GPP radios, cellular radios, and/or the like. In some advantageous implementations, the antennas 214 can be multi-band WiFi antenna devices. As such, the antennas 214 can be configured for mid-band operation, CBRS-band operation, and Wi-Fi-band operation, depending on the specific radio or transceiver attached. In some cases, the antennas 214 can have an operating range of approximately 1.6 GHz to 8 GHz or higher. In some implementations, the antennas 214 can include one or more PCB portions. The PCB portions may be made of flexible substrate materials (e.g., polyimide). As such, the PCB portions may be a flex circuit. In some cases, the PCB portions may be fiberglass reinforced with epoxy (e.g., FR4). The PCB portions may provide structure for the radiating portions of the antennas 214. The various conductive portions of the antennas 214 may be etched into the structure of the PCB portions. While the antennas 214 are referred to herein as “dual-band WiFi radiator antennas,” the antennas 214 may be configured for operation on less than two or more than two bands, in some implementations.

Depending on the particular use, the number of dual-band WiFi radiator portions 214 can vary. In the illustrated examples, the antenna assembly 200 includes two dual-band WiFi radiator portions 214. However, more or fewer dual-band WiFi radiator portions 214 are possible. In some cases, one or more of the dual-band WiFi radiator portions 214 can be configured for Bluetooth communication. For example, one or more of the dual-band WiFi radiator portions 214 can be a Bluetooth radiator portion 214. In some implementations, each dual-band WiFi radiator portions 214 can be coupled to an individual RF cable. For example, terminated coaxial cables 240 are shown coupled to the dual-band WiFi radiator portions 214 in FIGS. 2A-3B.

In some implementations, the antenna assembly 200 can include one or more GPS antenna elements 224. The GPS antenna element(s) 224 can be used to collect one or more signal(s) from geosynchronous satellites so that the GPS function of a radio including the antenna assembly 200 can determine where the antenna assembly 200 is positioned relative to a global coordinate system. Depending on the particular use, the number of GPS antenna element(s) 224 can vary. When included, the GPS antenna element(s) 224 may be positioned on the ground plane 212 and within the cover 204. In this arrangement, the GPS antenna element(s) 224 are supported by the ground plane 212 in the assembled antenna assembly 200.

The multi-band radiator portions 100 can be used for wireless telecommunication purposes (e.g., cellular telecommunication). Accordingly, the second antenna elements 100 may be referred to herein as “multi-band radiator portions” or “cellular radiator portions”. Depending on the particular use, the number of multi-band radiator portions 100 can vary. In the example of FIGS. 2A and 2B, the antenna assembly 200 includes two multi-band radiator portions 100, in the example of FIGS. 3A and 3B, the antenna assembly 200 includes four multi-band radiator portions 100, and in the example of FIGS. 3C and 3D, the antenna assembly 200A includes six multi-band radiator portions 100; however, more or fewer multi-band radiator portions 100 are possible. The multi-band radiator portions 100 are described further herein with reference to at least FIGS. 5A-5K. Another example of a multi-band radiator portion 100′ that can be used in addition to or alternatively to the multi-band radiator portions 100 in the multi-band multi-element antenna 201 is described further herein with reference to at least FIGS. 8A-8H. It is recognized that any discussion of the features or arrangements of the multi-band radiator portions 100 in the multi-band multi-element antenna 201 can apply to the multi-band radiator portions 100′. Similarly, such discussion can also apply to any alternative antennas or radiator portion included in an implementation of the multi-band multi-element antenna 201.

The RF cabling to connect the internal modem 210 to the multi-band radiator portions 100 and the dual-band WiFi radiator portions 214 can extend through the ground plane 212 and into the lower enclosure of the antenna assembly 200. For example, each the multi-band radiator portion 100 is shown coupled to a terminated coaxial cable 240. The combination of the multi-band radiator portions 100 and the dual-band WiFi radiator portions 214 with the data ports of the internal modem 210 can allow for a wireless modem to provide “last mile” service for a data connection to a home, office, etc. to support improved data speeds and latency. The antenna assembly 200 can be used in place of a cable modem, a fiber modem, a twisted pair modem, etc. that require physical connection to the home/office. As such, the antenna assembly 200 can eliminate the costs associated with truck roll and scheduling, while still providing data/internet connection for an end user. In another example, use of the antenna assembly 200 may preclude the infrastructure costs of having the data service on the poles or in the ground near the end user's facility.

The orientation and the arrangement of the multi-band radiator portions 100 and the dual-band WiFi radiator portions 214 on the ground plane 212 relative to each other can be selected to optimize the performance of the antenna assembly 200 for the particular use case. In the example of FIGS. 2A and 2B, the dual-band WiFi radiator portions 214 are positioned on opposite sides of the ground plane 212 and the multi-band radiator portions 100 are positioned on opposite corners of the ground plane 212. In other examples, the dual-band WiFi radiator portions 214 may be positioned in opposite corners of the ground plane 212. The relationship between the multi-band radiator portions 100 can be important for the performance of the antenna assembly 200. In the example of FIGS. 2A and 2B, the first multi-band radiator portion 100 faces generally towards the second multi-band radiator portion 100. In some implementations, the arrangement of the multi-band radiator portions 100 can be selected to have complementary overlapping azimuth patterns. Additionally, the arrangement can be selected to improve the multi-band radiator portion 100 to multi-band radiator portion 100 isolation, without the use of divider walls or RF absorbing material. When other antennas (e.g., the antennas of any of FIGS. 10A-18D) are included in the antenna assembly 200, such antennas can be arranged on the ground plane 212 in a similar or different manner, depending on the particular application.

FIGS. 3C and 3D illustrate various views of an antenna assembly 200A and select components thereof. Some features of the antenna assembly 200A are similar or identical to features of the antenna assembly 200 in at least FIGS. 1A-3B and 4A-5K. Thus, reference numerals used to designate the various features or components of the antenna assembly 200 are identical to those used for identifying the corresponding features of the components of the antenna assembly 200A in FIGS. 3C and 3D, except that the numerical identifiers for the antenna assembly 200A include an “A”. Therefore, the structure and description for the various features of the antenna assembly 200 and the operation thereof as described in at least FIGS. 1A-3B and 4A-5K are understood to also apply to the corresponding features of the antenna assembly 200A in FIGS. 3C and 3D, except as described differently below.

The antenna assembly 200A differs from the antenna assembly 200 in shape and size. For example, the antenna assembly 200A has a generally rectangular shape (e.g., a rectangular base 202A and ground plane 212A) compared to the generally square shaped antenna assembly 200. Accordingly, the antenna assembly 200A can be longer in at least one dimension compared to the antenna assembly 200. The increased size of the antenna assembly 200A compared to the antenna assembly 200 allows the antenna assembly 200A to accommodate additional antenna elements. As shown in the illustrated example of FIGS. 3C and 3D, the multi-band multi-element antenna 201A of the antenna assembly 200A may include six the multi-band radiator portions 100, two antenna elements 224, and/or six dual-band WiFi radiator portions 214. In other implementations, more or fewer antennas and/or different antennas (e.g., one or more of any of the antennas of FIGS. 10A-18D) may be included in the antenna assembly 200A.

FIGS. 5A-5K illustrate various views of components of the multi-band radiator portions 100, in accordance with some aspects of this disclosure. Each multi-band radiator portion 100 can include a multi-band radiating element 101 and a ground connection 103. The ground connection 103 is configured to couple to multi-band radiating element 101 to the ground plane 212. FIGS. 5A and 5C-5F illustrate assorted view of the multi-band radiating element 101. FIGS. 5B and 5G-5K illustrate the ground connection 103. It is recognized that the multi-band radiator portions 100 described herein are just one example of multi-band radiator portions that can be included in the antenna assembly 200. In other implementations, different multi-band radiator portions can be included. The antenna assembly 200 can include multi-band radiator portions that are similar or identical to any of the antennas described and/or illustrated in U.S. patent application Ser. No. 11,283,149, filed Sep. 30, 2019, titled “ANTENNA SYSTEM” and in U.S. patent application Ser. No. 17/712,000, filed Apr. 1, 2022, titled “ANTENNA SYSTEM,” the entire contents of both of which are hereby incorporated by reference in their entirety.

As shown in FIG. 5A, a radiating element 101 can be one element or component of the multi-band radiator portion 100. An upright low band radiation portion 125 (also referred to herein as the “body portion 125”) can be a body portion of the radiating element 101. The upright low band radiation portion 125 can be coupled to a feeding portion at a feed point 119 (see e.g., FIG. 5C) to electrically excite the radiating element 101. As shown in FIG. 5A, a second low band radiation portion 129 (also referred to herein as the “head portion 129”) can be positioned at an angle relative to the body portion (e.g., the upright low band radiation portion 125) and extend such that the second low band radiation portion 129 is not coplanar with the upright low band radiation portion 125. In some other implementations, the second low band radiation portion 129 can be configured without a bend such that it is coplanar with the upright low band radiation portion 125. In some implementations, advantages of a bend can include having two distinct low band radiating portions, reducing the total height of the system to be more compact and conserve space, and configuring the system to be able to easily cover and provide protection for the system in a compact configuration with multi-band coverage (e.g., in the antenna assembly 200). In some other implementations the second low band radiation portion 129 can be coupled to a third low band radiation portion, a fourth low band radiation portion, and/or other radiation portions. In some implementations, material forming the second low band radiation portion 129 can extend in a direction further away from the upright low band radiation portion 125 and comprise a slit between the material such that portion of material on each side of the slit may form a third low band radiation portion and a fourth low band radiation portion respectively, that may be coplanar with and extend beyond the second low band radiation portion 129. In some implementations the third and fourth low band radiation portions can be the same length and width. In some implementations, the length and/or width of the third low band radiation portion may be different from the length and/or width of the fourth low band radiation portion. In some implementations, one or more of the third low band radiation portion and the fourth low band radiation portion may be angled or bent or attached such that it is not coplanar with the second low band radiation portion 129. Adding variations in radiation portions can provide advantageous coverage in different areas of bandwidth in some implementations.

In some cases, the radiating element 101 is a modified printed inverted-F antenna (PIFA) modified to have three bent arm members that make the radiating element 101 a three-dimensional antenna as opposed to a two-dimensional antenna generally practiced in the art for printed inverted F antenna. Furthermore, the radiating element 101 can be a dual band monopole antenna, a multi-band 3D inverted F antenna, or a version of a 2D inverted F antenna similar to a PIFA, that has a configuration that, when used in conjunction with high order electromagnetic modes generated or received by a transceiver and/or receiver (as is typically performed for PIFA antenna), permit the radiating element 101 to have an operating frequency range of 600 MHz to 7.25 GHZ.

The low band portions (e.g., upright low band radiation portion 125, the second low band radiation portion 129, and/or any additional low band radiation portions) can be configured for radiation in the low band, including low band odd multiples. The high band radiation portion can comprise one or more arms 127 configured for high band radiation. In the illustrated example, the radiating element 101 includes two arms 127. The two arms 127 can be coupled to a lower portion of the upright low band radiation portion 125. In some implementations, the arms 127 can be coupled to an upper portion of the upright low band radiation portion 125. In some other implementations, one or more additional arms can be coupled to an upper portion of a low band radiation portion (e.g., upright low band radiation portion 125, the second low band radiation portion 129, etc.). In some implementations the arms 127 can have the same length. In some implementations arms 127 can have different lengths. In some implementations, one or more of the arms 127 can be positioned at an angle relative to the upright low band radiation portion 125 and/or relative to the ground plane 212. The arms 127 can be positioned at the same angle or at different angles. The arms 127 can be configured for radiation in the high band, including high even order resonances. In some implementations, additional arm portions can be added or formed at selected locations to add coverage for additional high frequency bandwidth areas. For example, in some implementations portions of the arms may be slit, extended, angled, bent, modified, and/or otherwise connected to provide improved coverage areas.

As shown in FIG. 5B, a ground connection 103 (also referred to herein as the “tuner 103” or the “grounding portion 103”) can be adapted and configured to couple the radiating element 101 with the ground plane 212. The tuner 103 can include a face plate 171 that is configured to be coupled to the ground plane 212. The tuner 103 can include an arm portion 173, which can be an arm portion coupled to the face plate 171. The width of arm portion 173 can be adjusted to accommodate clearance for transmission lines (not shown) of the antenna assembly 200, which can be used to excite the radiating element 101. Low band operation of the multi-band radiator portions 100 is enhanced and can be adjusted by the length and width of body portion 125 and head portion 129 as well as the location, placement, and configuration of an opening 117b (see e.g., FIG. 5C) in body portion 125. The tuner 103 can include a base portion 177. The base portion 177 can be adapted and configured to be positioned against the body portion 125 of the radiating element 101 such that the opening in the base 177 and the opening 117b can be a point of coupling creating a ground connection for the multi-band radiator portion 100. The raised ground connection being elevated relative to the feed location provides advantages to achieve the multiband coverage. Dimensions can be selected to provide harmonic resonance at higher odd orders in some implementations. The grounding portion provides advantages for achieving multiple advantageous resonances. For example, in some implementations, the height, width, and clearance provided for by the size of arm portion 173 can be advantageously selected. Additionally, the length and width of body portion 175 can also be advantageously selected. The location of opening 117b and the corresponding connecting location of the coupling point 181b, shown in FIG. 5J, when coupled together for the grounding connection create a symbiotic connection to provide a resonance of desired impedance to match a desired frequency and bandwidth for a low band frequency configuration in some implementations. FIG. 5C shows twin coupling points 117a of the radiating element 101. The twin coupling points 117a can be used to attach the multi-band radiator portion 100 to a nonconductive structural stand coupled to the ground plane 212. More isolation can be created from the ground plane 212 by expanding the space 111 as well as decreasing the width 109. The feed point location 119 is configured to receive an electrical connection to excite the radiating element 101.

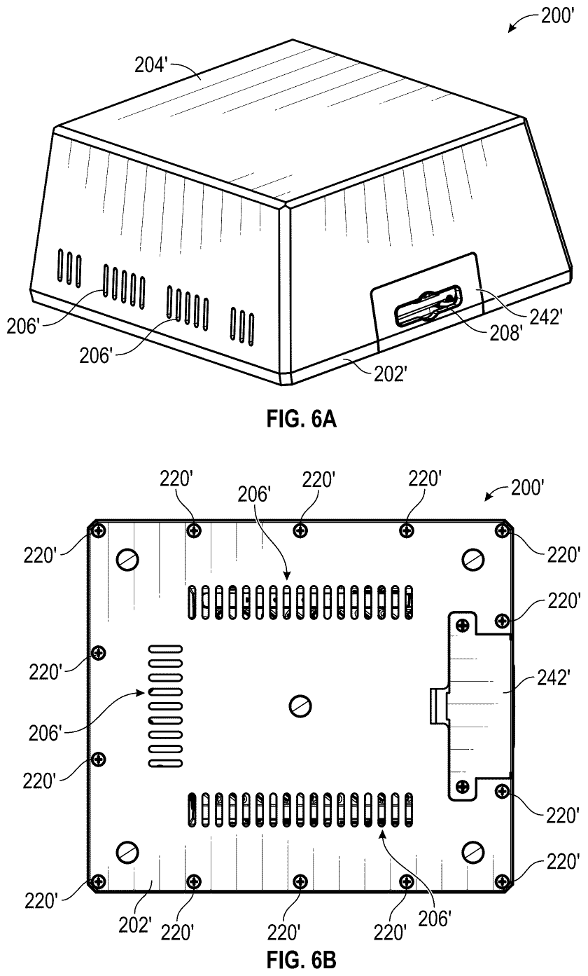

In some other implementations, features and aspects of the multi-band radiator portions 100 can be further described as follows. FIG. 5C illustrates the radiating element 101 that can be coupled to the ground plane 212 of the antenna assembly 200 shown in FIG. 6A, and electrically excited at the feed point 119. The feed point 119 can be coupled to the upright low band radiation portion 125 with what can be a narrow width tab 109. Additional isolation between the upright low band radiation portion 125 and the ground plane 212 can be obtained by adjusting 111 and consequently the coupling location reference 113. For additional mechanical support, the upright low band radiation portion 125, can have a non-conductive coupling mechanism (not shown) to the ground plane 212. The upright low band radiation portion 125 can have a coupling point 117b for attaching the grounding portion 103 with the coupling point 181b (see e.g., FIG. 5J). As noted above, also coupled to the upright low band radiation portion 125 can be two arms 127. The arms 127 can assist with the dominate radiation in the high band for the multi-band radiator portion 100. One or more portions similar to the arms 127 may be used for assisting in the high band portion of the radiation are realizable in the implementation of this approach. Higher even order resonances may radiate from portions similar to the arms 127 of the radiating element 101 to assist in the multi-band properties of the device. Furthermore, there can be the additional head portion 129 coupled to the upright low band radiation portion 125 that may be perpendicular in nature for its orientation. Though it is not necessary for it to be bent near 90-degrees as depicted in this illustration and can be shown to be perceptibly straight in other implementations, by bending the low band radiation portion of the radiating element 101 to realize two distinct portions (e.g., the upright low band radiation portion 125 and the second low band radiation portion 129), the total height of the radiating element 101 is reduced and as such the total volume of the antenna assembly 200 to most likely provide environmental protection is consequently reduced. The low band operation of the radiating element 101 is determined by several factors. Some of the factors are the length and width of upright low band radiation portion 125 and of second low band radiation portion 129, the location of opening 117b, and/or the grounding portion 103.

FIG. 5B illustrates the grounding portion of the device 103. The face plate 171 can be coupled to the arm 173. The width of the arm 173 can be adjusted to accommodate clearance for assembly purposes for a transmission line of the antenna assembly 200 that may be used for excitation of the multi-band radiator portion 100. The body 175 can be coupled to arm 173. The base 177 can be coupled to the body 175. The base 177 can also have a coupling point 178 that is configured to couple to the opening 117b of the radiating element 101 in the assembled multi-band radiator portion 100. The height of the arm 173, the width of the arm 173, the clearance provided for in the arm 173, the length of body 175, and the symbiotic location of opening 117b and coupling point 181b all provide for a reactance that counterbalances the reactance of the low band impedance to provide a resonance of desired impedance match for the desired frequency and bandwidth for the low band radiation. The location of the coupling point 181b and the length and width of the grounding portion 103 are also chosen to provide higher odd order resonant harmonics at the desired locations to cover a portion of the frequency band of the multi-band performance of the antenna assembly 200.

FIG. 5C illustrates a back side view of the radiating element 101. Twin coupling points 117a in the radiating element 101 may be coupled to a non-conductive object (not shown), which can be coupled to the ground plane 212 of the antenna assembly 200 shown in FIG. 6A. This coupling may provide mechanical stability for the multi-band radiator portions 100 while not disturbing or inhibiting the ground connection provided by tuner 103.

FIGS. 5D-5F provide additional views of the radiating element 101. As shown in FIGS. 5D and 5F, the second low band radiation portion 129 can include one or more clearances. For example, the second low band radiation portion 129 can include one or more first clearances 157a, one or more second clearances 157b, and/or one or more third clearances 157c. The clearances 157a, 157b, 157c may allow for ease of assembly of the completed multi-band radiator portions 100. FIG. 5G-5K provide additional views of the ground connection 103 of the multi-band radiator portions 100.

In some implementations, a different ground connection, such as the ground connection 103′ of at least FIG. 8B or a similar ground connection, can be used with the multi-band radiator portions 100, as shown in at least FIG. 2A. For example, FIGS. 5L-5N show an implementation of the multi-band radiator portion 100 in the form of multi-band radiator portion 100″ that includes a ground connection 103″. The radiating element 101″ of the multi-band radiator portion 100″ differs from the radiating element 101 of the multi-band radiator portion 100 in that the radiating element 101″ includes slots 131″ instead of opening 117b for coupling to the ground connection 103″. The ground connection 103″ is similar to the ground connection 103′ described with reference to FIGS. 8A-8H below and includes like reference numbers ending in a “double prime” instead of a single “prime” accordingly.

Antenna Assembly with Second Multi-Band Radiator Portions

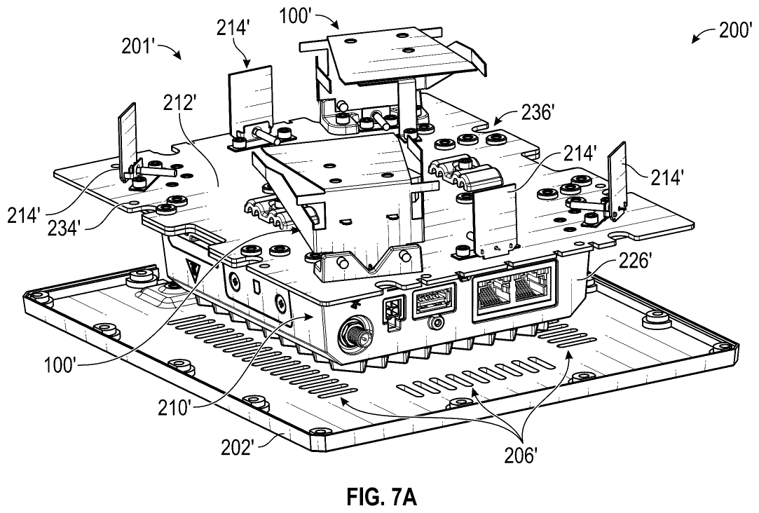

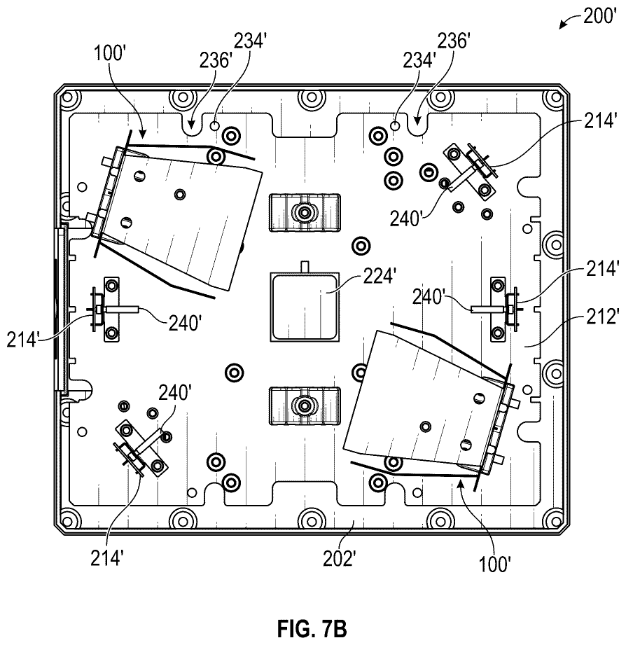

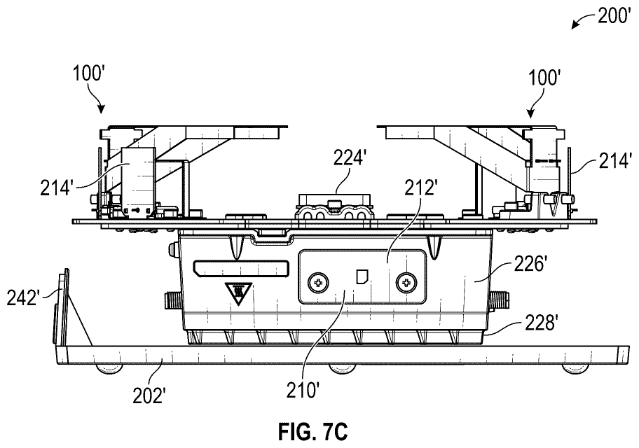

Referring now to the drawings wherein like reference characters identify corresponding or similar elements in form and function throughout the several views. FIGS. 6A and 6B illustrate various views of an antenna assembly. FIGS. 7A-7C illustrate various views of the antenna assembly of FIG. 6A with the cover removed. FIGS. 8A-8K illustrate various views of components of a multi-band radiator portion of the antenna assembly of FIG. 6A, in accordance with some aspects of this disclosure. FIGS. 10A-18D illustrate various views of additional components that can be included in any of the antenna assemblies described herein, such as the antenna assembly of FIG. 6A.

FIGS. 6A-8H illustrate various views of an antenna assembly 200′ and components thereof. Some features of the antenna assembly 200′ are similar or identical to features of the antenna assembly 200 in at least FIG. 1A-5K. Thus, reference numerals used to designate the various features or components of the antenna assembly 200 are identical to those used for identifying the corresponding features of the components of the antenna assembly 200′ in FIGS. 6A-8H, except that the numerical identifiers for the antenna assembly 200′ include a “prime”. Therefore, the structure and description for the various features of the antenna assembly 200 and the operation thereof as described in at least FIGS. 1A-5K are understood to also apply to the corresponding features of the antenna assembly 200′ in FIG. 6A-8H, except as described differently below.

The antenna assembly 200′ differs from the antenna assembly 200 primarily in shape and/or features of the multi-band radiator portions 100′. The multi-band radiator portions 100′ are described further herein with reference to FIGS. 8A-8H. The antenna assembly 200′ may also differ from the antenna assembly 200 in that the antenna assembly 200 includes four dual-band WiFi radiator portions 214′ and two the multi-band radiator portions 100′. In other implementations, the antenna assembly 200′ could include more or fewer dual-band WiFi radiator portions 214′ and/or more or fewer multi-band radiator portions 100′. As described further herein, various alternative antenna elements can also be incorporated into the multi-band multi-element antenna 201′, in some implementations. For example, any of the multi-band radiator multi-band radiator portions 100, multi-band radiator portions 100′, multi-band radiator portion 100″, dual-band WiFi radiator portions 214, GPS antenna elements 224, multi-band radiator portion 500, multi-band antenna 600, multi-band antenna 700, multi-band antenna 800, multi-band antenna 900, multi-band antenna 1000, stacked patch antenna 1100, and/or multi-band radiator portion 1200 can form part of the multi-band multi-element antenna 201′ of the antenna assembly 200′. Additionally, in some implementations, any of the millimeter wave radios 250 described with reference to at least FIGS. 18A-18D can be incorporated into the antenna assembly 200′.

FIGS. 8A-8H illustrate various views of components of the multi-band radiator portions 100′, in accordance with some aspects of this disclosure. Each multi-band radiator portion 100′ can include a multi-band radiating element 101′ and a ground connection 103′ (also referred to herein as a “grounding portion” or a “tuner”). The ground connection 103′ is configured to couple multi-band radiating element 101′ to the ground plane 212′. FIGS. 8A and 8C-8F illustrate assorted views of the multi-band radiating element 101′. FIGS. 8B and 8G-8H illustrate the ground connection 103′. In some implementations, a different ground connection, such as the ground connection 103 illustrated in at least FIG. 5B can be used with the radiating element 101′ to form the multi-band radiator portions 100′. It is recognized that the multi-band radiator portions 100′ described herein are just one example of multi-band radiator portions that can be included in the antenna assembly 200. In other implementations, different multi-band radiator portions can be included. For example, the antenna assembly 200 can include multi-band radiator portions that are similar or identical to the multi-band radiator portions 100 described herein. In the illustrated implementation, the radiating element 101′ and the ground connection 103′ are constructed of metal (e.g., a conductive sheet). In some cases, the conductive sheet can have a thickness between 0.01 inches and 0.03 inches. In other implementations, the radiating element 101′ and/or ground connection 103′ could be constructed out of several rigid PCB portions or a single flex circuit PCB (e.g., supported by the radome 204′ or another RF-transparent supporting structure). Additional disclosure regarding antenna systems and assemblies including the multi-band radiator portions 100′ of FIGS. 8A-8H is further described in U.S. application Ser. No. 18/894,607, filed Sep. 24, 2024, entitled “Antenna Systems,” the entire contents of which is hereby incorporated by reference herein in its entirety. The disclosure and Figures in U.S. application Ser. No. 18/894,607 can be used in connection with the disclosure and Figures described and shown herein.

As shown in FIG. 8A, a radiating element 101′ can be one element or component of the multi-band radiator portion 100′. An upright low-band radiation portion 125′ (also referred to herein as the “body portion 125′”) can be a body portion of the radiating element 101′. The upright low-band radiation portion 125′ can be coupled to a feeding portion at a feed point 119′ (see e.g., FIG. 8C) to electrically excite the radiating element 101′. As shown in FIG. 8A, a second low-band radiation portion 129′ (also referred to herein as the “head portion 129”) can be positioned at an angle relative to the body portion 125′ (e.g., the upright low-band radiation portion 125′) and extend such that the second low-band radiation portion 129′ is not coplanar with the upright low-band radiation portion 125′. In some other implementations, the second low-band radiation portion 129′ can be configured without a bend such that it is coplanar with the upright low-band radiation portion 125′. In some implementations, advantages of a bend can include having two distinct low-band radiating portions, reducing the total height of the system to be more compact and conserve space, and configuring the system to be able to easily cover and provide protection for the system in a compact configuration with multi-band coverage (e.g., in the antenna assembly 200′). Having a compact radiating element 101′ (e.g., in part due to the bend between the upright low-band radiation portion 125′ and the second low-band radiation portion 129′) can allow the multi-band radiator portions 100′ to be utilized in antenna assemblies where a low profile is required or desired. For example, in some implementations, it can be desirable for the antenna assembly 200′ to have as low a profile as possible, to allow the antenna assembly 200′ to be used in high wind operating conditions or applications that require low visual impact. Accordingly, as the multi-band radiator portions 100′ represent the limiting factor in terms of total height of the antenna assembly 200′, the low-profile multi-band radiator portions 100′ are particularly advantageous. In some implementations, the multi-band radiator portions 100′ can have a total height (e.g., from the bottom of the feed point 119′ to the top of the second low-band radiation portion 129′) of between 0.75 inch and 3 inches. For example, the multi-band radiator portions 100′ may have a total height of less than 3 inches, less than 2.5 inches, less than 2 inches, less than 1.5 inches, less than 1 inches, and/or the like.

In some other implementations, the second low-band radiation portion 129′ can be coupled to a third low-band radiation portion, a fourth low-band radiation portion, and/or other radiation portions. In some implementations, material forming the second low-band radiation portion 129′ can extend in a direction further away from the upright low-band radiation portion 125′ and comprise a slit between the material such that portion of material on each side of the slit may form a third low-band radiation portion and a fourth low-band radiation portion respectively, that may be coplanar with and extend beyond the second low-band radiation portion 129′. In some implementations the third and fourth low-band radiation portions can be the same length and width. In some implementations, the length and/or width of the third low-band radiation portion may be different from the length and/or width of the fourth low-band radiation portion. In some implementations, one or more of the third low-band radiation portion and the fourth low-band radiation portion may be angled or bent or attached such that it is not coplanar with the second low-band radiation portion 129′. Adding variations in radiation portions can provide advantageous coverage in different areas of bandwidth in some implementations.

In some cases, the radiating element 101′ is a modified printed inverted-F antenna (PIFA) modified to have three bent arm members that make the radiating element 101′ a three-dimensional antenna as opposed to a two-dimensional antenna generally practiced in the art for printed inverted-F antennas. Furthermore, the radiating element 101′ can be a dual-band monopole antenna, a multi-band 3D inverted F antenna, or a version of a 2D inverted F antenna similar to a PIFA that has a configuration that, when used in conjunction with high order electromagnetic modes generated or received by a transceiver and/or receiver (as is typically performed for PIFA antennas), permit the radiating element 101′ to have an operating frequency range of 500 MHz to 8 GHz.

The low-band portions (e.g., upright low-band radiation portion 125′, the second low-band radiation portion 129′, and any additional low-band radiation portions) can be configured for radiation in the low-band (e.g., approximately 600 MHz to 900 MHZ), including low-band odd multiples. The radiating element 101′ can also include additional portions configured for radiation above the low-band. For example, the radiating element 101′ can include one or more primary arms 127′ and/or one or more secondary arms 137′. The primary arms 127′ and the secondary arms 137′ may be configured for operation on different bands or the same bands. For example, the primary arms 127′ can be configured for radiation in the mid-band (e.g., approximately 1.7 GHZ to 2.7 GHz) and the secondary arms 137′ can be configured for radiation in the C-band (e.g., approximately 3.4 GHz to 4.2 GHZ). In the illustrated example, the radiating element 101′ includes two primary arms 127′ and two secondary arms 137′. However, more or fewer arms 127′, 137′ are possible. Further, in other implementations, the arms 127′, 137′ or additional/alternative arms can be included in the radiating element 101′ and configured for radiation in the high band Wi-Fi band (e.g., approximately 4.8 GHz to 7.25 GHZ).

The arms 127′ can be coupled to a lower portion of the upright low-band radiation portion 125′. In some implementations, the arms 127′ can be coupled to an upper portion of the upright low-band radiation portion 125′. In some other implementations, one or more additional arms 127′ can be coupled to an upper portion of a low-band radiation portion (e.g., upright low-band radiation portion 125′, the second low-band radiation portion 129′, etc.). In some implementations the arms 127′ can have the same length. In some implementations arms 127′ can have different lengths. In some implementations, one or more of the arms 127′ can be positioned at an angle relative to the upright low-band radiation portion 125′ and/or relative to a ground plane (e.g., the ground plane 212′). The arms 127′ can be positioned at the same angle or at different angles. The arms 127′ can be configured for radiation in the mid-band, including higher even order resonances. In some implementations, additional arm portions can be added or formed at selected locations to add coverage for additional high frequency bandwidth areas (e.g., the high band Wi-Fi band). For example, in some implementations, portions of the arms 127′ (and/or the arms 137′) may be slit, extended, angled, bent, modified, and/or otherwise connected to provide improved coverage areas.

As shown in FIG. 8E, in some implementations, each arm 127′ can include a first arm portion 133′ and a second arm portion 135′. The first arm portions 133′ can be coupled to or extend from the upright low-band radiation portion 125′, and the second arm portions 135′ can be coupled to or extend from the first arm portions 133′. The second arm portions 135′ can be at a different angle relative to the upright low-band radiation portion 125′ and the ground plane 212′ compared to the first arm portions 133′. The second arm portions 135′ can have a different width, thickness, length, and/or bend angle compared to the first arm portions 133′. These variations can improve return loss and radiation pattern performance in some cases. In the illustrated example, the first arm portions 133′ extend from a lower portion of the upright low-band radiation portion 125′ in a direction towards the second low-band radiation portion 129′. The first arm portions 133′ and the second low-band radiation portion 129′ can both extend away from the upright low-band radiation portion 125′. In some implementations, the arms 127′ can have a maximum height (relative to the ground plane 212′) that is substantially the same as the maximum height of the second low-band radiation portion 129′ (relative to the ground plane 212′).

The arms 137′ can extend from or be coupled to the upright low-band radiation portion 125′. For example, the arms 137′ can be coupled to an upper portion of the upright low-band radiation portion 125′. In some implementations, the arms 137′ can be positioned above the arms 127′, relative to the ground plane 212′. In some implementations, the arms 137′ can be coupled to a lower portion of the upright low-band radiation portion 125′. For example, the arms 137′ may be positioned below the arms 127′. In some other implementations, one or more additional arms 137′ can be coupled to a low-band radiation portion of the radiating element 101′ (e.g., the upright low-band radiation portion 125′, the second low-band radiation portion 129′, etc.). In some implementations the arms 137′ can have the same length. In some implementations arms 137′ can have different lengths. In some implementations, one or more of the arms 137′ can be positioned at an angle relative to the upright low-band radiation portion 125′ and/or relative to a ground plane (e.g., the ground plane 212′). The arms 137′ can be positioned at the same angle or at different angles. As described herein, the arms 137′ can be configured for radiation in the C-band (e.g., approximately 3.4 GHz to 4.2 GHZ), including high even order resonances. In some implementations, additional arm portions can be added or formed at selected locations to add coverage for additional high frequency bandwidth areas (e.g., the C-band or higher). For example, in some implementations portions of the arms may be slit, extended, angled, bent, modified, and/or otherwise connected to provide improved coverage areas. In some implementations, the arms 137′ can be coplanar to the upright low-band radiation portion 125′, as shown in FIG. 8E. In some implementations, the arms 137′ can improve return loss at the upper end of the mobile telecommunications spectrum relative to the radiating element 101′, which may not include the additional arms similar to the arms 137′.

As shown in FIG. 8B, a ground connection 103′ (also referred to herein as the “tuner 103′”) can be adapted and configured to couple the radiating element 101′ with the ground plane 212′. The tuner 103′ can include a face plate 171′ that is configured to be coupled to a ground plane (e.g., the ground plane 212′). The tuner 103′ can include an arm portion 173′, which can be an arm portion coupled to the face plate 171′. The width of arm portion 173′ can be adjusted to accommodate clearance for transmission lines, such as coaxial cables 240 of antenna assembly 200′, which can be used to excite the radiating element 101′. For example, as shown in FIG. 7A, the illustrated width of the arm portion 173′ allows the coaxial cables 240′ to extend past the arm portion 173′, under the body 175′, and to be positioned adjacent the arm portion 173′ when coupled to the radiating element 101′. Low-band operation of the multi-band radiator portion 100′ is enhanced and can be adjusted by the length and width of body portion 125′ and head portion 129′ as well as the location, placement, and configuration of an opening (not shown) in body portion 125′. The tuner 103′ can include a body 175′ that includes an engagement portion 177′. The engagement portion 177′ can be adapted and configured to be positioned against the body portion 125′ of the radiating element 101′. For example, the engagement portion 177′ can be positioned against the upright low-band radiation portion 125′ such that the body 175′ is substantially orthogonal to the upright low-band radiation portion 125′. The engagement portion 177′ can include one or more tabs 183′. The tabs one or more tabs 183′ can be twist tabs. The one or more tabs 183′ can be received within one or more slots 131′ of the upright low-band radiation portion 125′. As such, the extension of the tabs 183′ through the slots 131′ can be a point of coupling, creating a ground connection for the multi-band radiator portion 100′. Use of the tabs 183′ and the slot 131′ for the ground connection can improve grounding, reduce the part count, and/or reduce assembly time, compared to other coupling means such as a nut and threaded fastener. For example, to couple the ground connection 103′ to the radiating element 101′, the tabs 183′ can be inserted in the slots 131′ and twisted (e.g., with pliers) to create the connection. This type of connection can be completed more quickly than other connections (such as soldering, nut and fastener, etc.) and can provide a secured connection. In some cases, solder can optionally be used to improve the electrical connection between the ground connection 103′ and the radiating element 101′; however, the solder is generally not required for the mechanical or electrical connection to be established. The lateral position of the arm portion 173′ relative to body 175′ can also be selected to accommodate clearance for transmission lines. For example, while the arm portion 173′ is shown as positioned on one side of the body 175′, this position is not required and the arm portion 173′ could be centrally positioned on the body 175′ in other implementations. The position and width of the arm portion 173′ can also impact the performance of the multi-band radiator portion 100′ across the various bands.

The ground connection 103′ can be elevated relative to the feed location 119′ of the radiating element 101′ in the assembled antenna assembly 200′. For example, the face plate 171′ can be coupled to a portion of the ground plane 212′ that is higher than the feed point 119′ in the assembled antenna assembly 200′. Such a raised connection provides advantages to achieve the multi-band coverage. Dimensions can be selected to provide harmonic resonance at higher odd orders in some implementations. The grounding portion 103′ provides advantages for achieving multiple advantageous resonances. Also, the selection of the dimensions for radiating portion 100′ may also be adjusted to impact the radiation patterns of the fundamental mode as well as the higher order modes. For example, in some implementations, the height, width, and clearance provided for by the size of arm portion 173′ can be advantageously selected. Additionally, the length and width of body portion 175′ can also be advantageously selected. For example, the width and length of the arm portion 173′ and the body 175′ can be adjusted for impedance matching as well as to achieve a desired radiation pattern for the multi-band radiator portion 100′. The locations of the one or more slots 131′ and one or more tabs 183′, when coupled together for the grounding connection create a symbiotic connection to provide a resonance of desired impedance to match a desired frequency and bandwidth and radiation pattern for a low-band frequency configuration in some implementations. In the illustrated example, the slots 131′ are near the vertical center of the upright low-band radiation portion 125′. The vertical position of the slots 131′ on the upright low-band radiation portion 125′ is related to the height or length of the arm portion 173′. In other implementations, the slots 131′ can be located higher or lower on upright low-band radiation portion 125′ relative to the vertical axis. The location of the slots 131′ (e.g., where the ground connection 103′ attaches) relative to the height of the upright low-band radiation portion 125′ is selected for impedance matching and the desired behavior of the higher order modes (e.g., where the higher order modes occur). The relative dimensions are also selected so that the radiation patterns comes off of the radiating element 101′ in the desired shape and/or direction. The width between the slots 131′ can also be variable. In the illustrated example, each slot 131′ is located approximately centrally between the central vertical axis of the upright low-band radiation portion 125′ and an outside edge of the upright low-band radiation portion 125′. In other examples, the slots 131′ can be closer or further apart from each other. In some cases, decreasing the width between the slots 131′ can require the height of the slots 131′ to also be reduced relative to the upright low-band radiation portion 125′ for optimal performance of the multi-band radiator portion 100′. In some cases, it can be desirable for the slots 131′ to be located as high on the upright low-band radiation portion 125′ as possible for improved structural benefits. However, the height of the slots 131′ is selected generally selected for a balance of good structural support and performance of the multi-band radiator portion 100′ across all desired bands.

FIG. 8C shows coupling points 117a′ of the radiating element 101′. The twin coupling points 117a′ can be used to attach the multi-band radiator portion 100′ to a non-conductive structural stand coupled to the ground plane 212′. For example, the non-conductive structural stand can be secured to the ground plane 212′. More isolation can be created from the ground plane 212′ by expanding the space 113′ and/or the space 111′ between the twin coupling points 117a′ and a feed point location 119′. The feed point location 119′ is configured to receive an electrical connection to excite the radiating element 101′. For example, the center conductor of the terminated coaxial cable 240′ can be electrically and mechanically coupled to the feed point 119′ with the outer conductor being electrically and mechanically coupled to the ground plane 212′. The space 111′ can be selected primarily for impedance matching purposes and may vary depending on the particular implementation of the multi-band radiator portion 100′ and the antenna assembly 200′. For example, changing the dimensions or structure of the ground plane 212′ can result in a variation in the size of the space 111′. In some implementations, the feed point 119′ can be twice the height (e.g., space 111′ can be doubled) or greater and/or the feed point 119′ can be twice the width (e.g., the narrow width tab 109′ can be doubled) or greater. In other implementations, a feed point 119′ with different structural features can be used. For example, the radiating element 101′ may include a feed point that is a tab. The tab feed point may extend substantially perpendicular to the upright low-band radiation portion 125′. In one example, the radiating element 101′ can include a feed point that includes a spacer with a push rivet or established via a heat stake operation. In some implementations, the feed point of the radiating element 101′ can be configured to be snap fit into a slot or configured as a push pass connection.

In some other implementations, features and aspects of the multi-band radiator portions 100′ can be further described as follows. FIG. 8C illustrates the radiating element 101′ that can be coupled to the ground plane 212′ of the antenna assembly 200′ shown in at least FIG. 7A, and electrically excited at the feed point 119′. For example, as described above, the center conductor of the terminated coaxial cable 240′ can be coupled to the feed point 119′ with the outer conductor being coupled to the ground plane 212′. The feed point 119′ can extend from or be coupled to the upright low-band radiation portion 125′ with what can be a narrow width tab 109′. Additional isolation between the upright low-band radiation portion 125′ and the ground plane 212′ can be obtained by adjusting 111′ and consequently the coupling location reference 113′. For additional mechanical support, the upright low-band radiation portion 125′ can have a non-conductive coupling mechanism (not shown) to the ground plane 212′. The upright low-band radiation portion 125′ can have a coupling point (e.g., one or more slots 131′) for attaching the grounding portion 103′ with via the one or more tabs 183′. As noted above, also extending from/coupled to the upright low-band radiation portion 125′ can be one or more primary arms 127′ and/or one or more secondary arms 137′. The arms 127′, 137′ can assist with the dominate radiation in the mid-band and C-band for the multi-band radiator portion 100′. One or more portions similar to the arms 127′, 137′ may be used for assisting in the high band portion of the radiation are realizable in the implementation of this approach. Higher even order resonances may radiate from portions similar to the arms 127′, 137′ of the radiating element 101′ to assist in the multi-band properties of the device. Furthermore, there can be the additional head portion 129′ coupled to the upright low-band radiation portion 125′ that may be perpendicular in nature for its orientation. Though it is not necessary for it to be bent near 90-degrees as depicted in this illustration and can be shown to be perceptibly straight in other implementations. By bending the low-band radiation portion of the radiating element 101′ to realize two distinct portions (e.g., the upright low-band radiation portion 125′ and the second low-band radiation portion 129′), the total height of the radiating element 101′ is reduced and as such the total volume of the antenna assembly 200′ to most likely provide environmental protection is consequently reduced. The low-band operation of the radiating element 101′ is determined by several factors. Some of the factors are the length and width of the upright low-band radiation portion 125′ and of the second low-band radiation portion 129′, the location of opening one or more slots 131′, and/or the grounding portion 103′.

FIG. 8B illustrates the grounding portion of the device 103′. The face plate 171′ can extend from or be coupled to the arm 173′. The width of the arm 173′ can be adjusted to accommodate clearance for assembly purposes for a transmission line of the antenna assembly 200′ that may be used for excitation of the multi-band radiator portion 100′. The body 175′ can extend from or be coupled to arm 173′. The engagement portion 177′ can be coupled to or form a portion of the body 175′. The engagement portion 177′ can also have one or more coupling points (e.g., one or more tabs 183′) that are configured to couple to the opening one or more slots 131′ of the radiating element 101′ in the assembled multi-band radiator portion 100′. The height of the arm 173′, the width of the arm 173′, the clearance provided for in the arm 173′, the length of body 175′, and the symbiotic location of slots 131′ and/or tabs 183′ can provide for a reactance that counterbalances the reactance of the low-band impedance to provide a resonance of desired impedance match for the desired frequency and bandwidth for the low-band radiation. The location of the coupling points (e.g., one or more tabs 183′) and the length and width of the grounding portion 103′ are also chosen to provide higher odd order resonant harmonics at the desired locations to cover a portion of the frequency band of the multi-band performance of the antenna assembly 200. Further, the relative dimensions described above also influence the radiation pattern generated by the radio frequency excitation of the multi-band radiator portion 100′.

FIG. 8C illustrates a back side view of the radiating element 101′. Twin coupling points 117a′ in the radiating element 101′ may be coupled to a non-conductive object (not shown), which can be coupled to the ground plane 212′ of the antenna assembly 200′. This coupling may provide mechanical stability for the multi-band radiator portions 100′ while not disturbing or inhibiting the ground connection provided by the ground connection 103′.

FIGS. 8D-8F provide additional views of the radiating element 101′. As shown in FIGS. 8D and 8F, the second low-band radiation portion 129′ can include one or more clearances. For example, the second low-band radiation portion 129′ can include one or more first clearances 157a′ and/or one or more second clearances 157b′. The clearances 157a′, 157b′ can be holes or openings formed in the second low-band radiation portion 129′. The clearances 157a′, 157b′ may allow for ease of assembly of the completed multi-band radiator portions 100′. FIG. 8G-8H provide additional views of the ground connection 103′ of the multi-band radiator portions 100′.

### Antenna Assembly

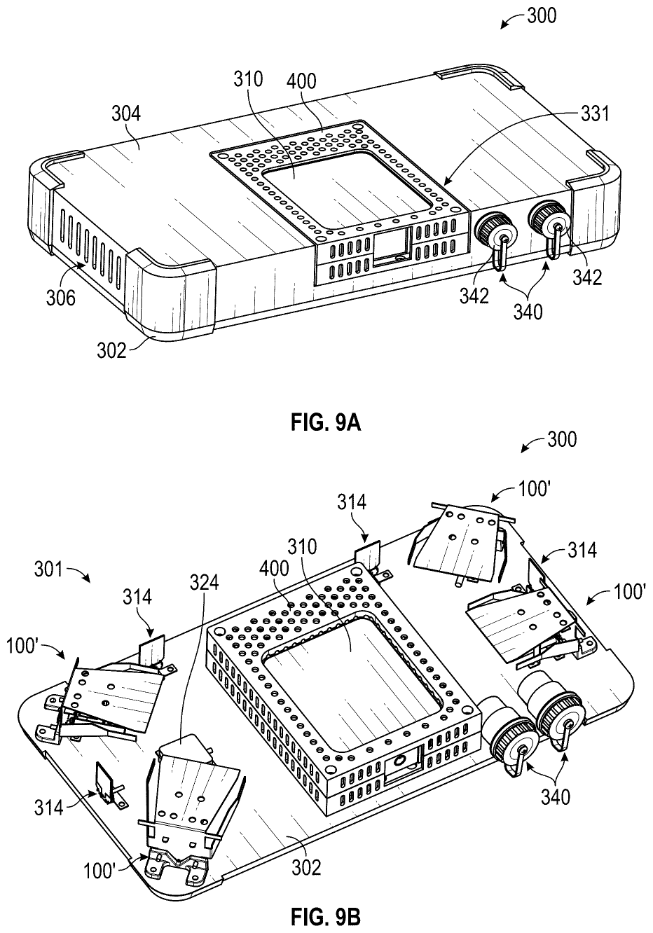

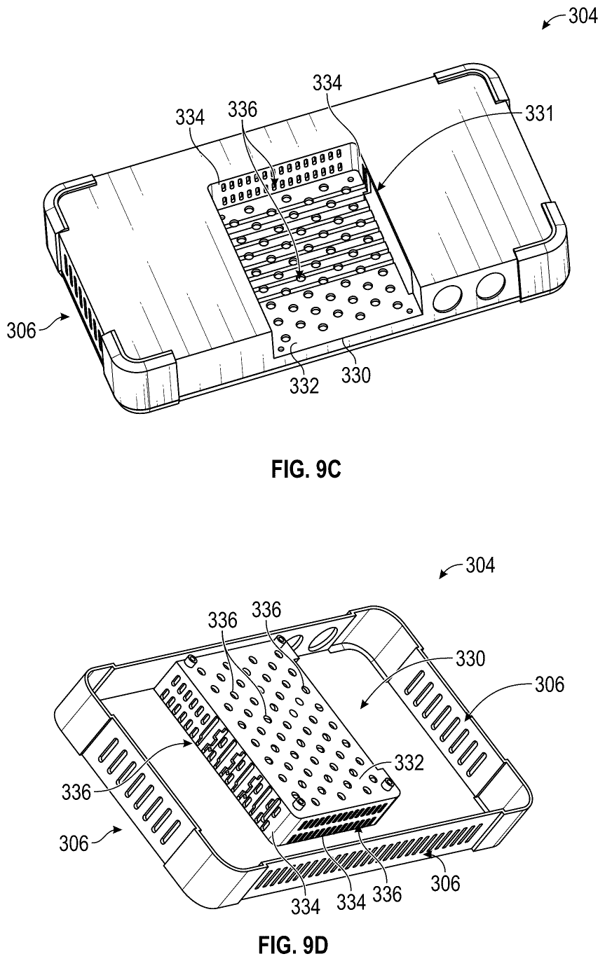

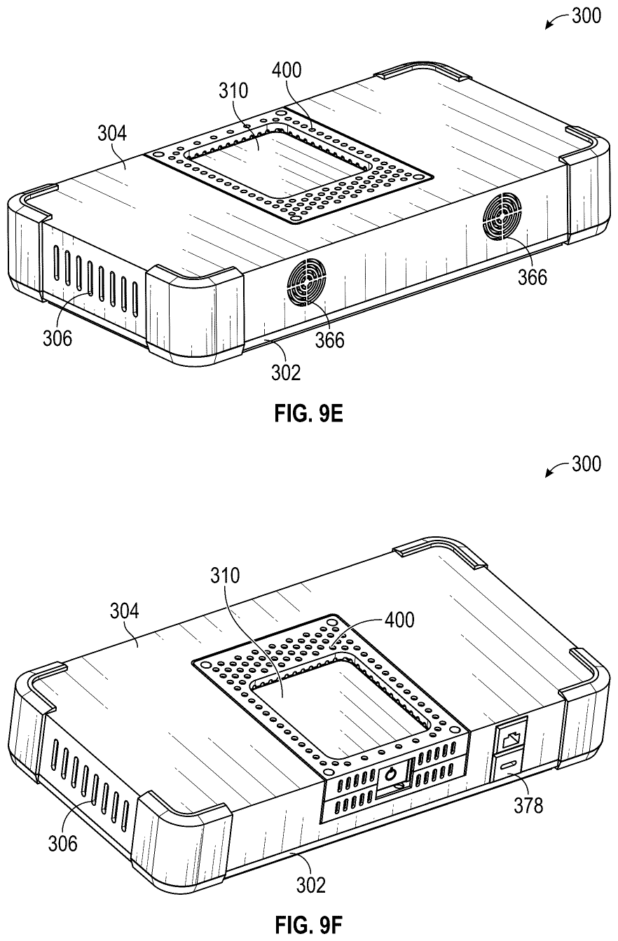

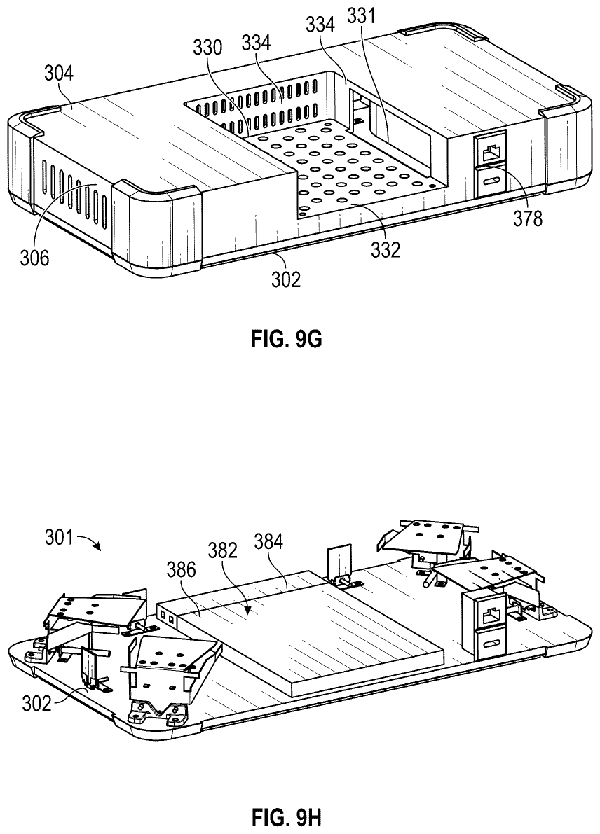

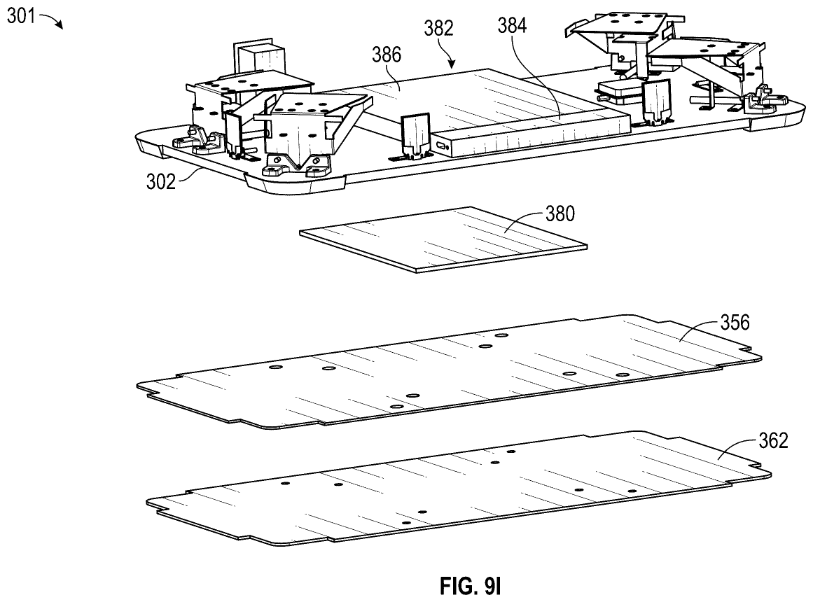

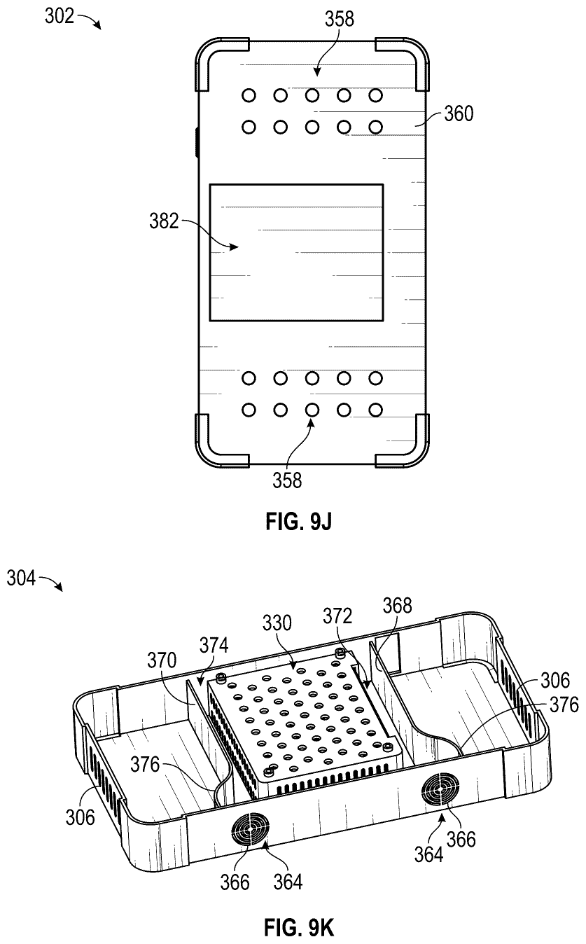

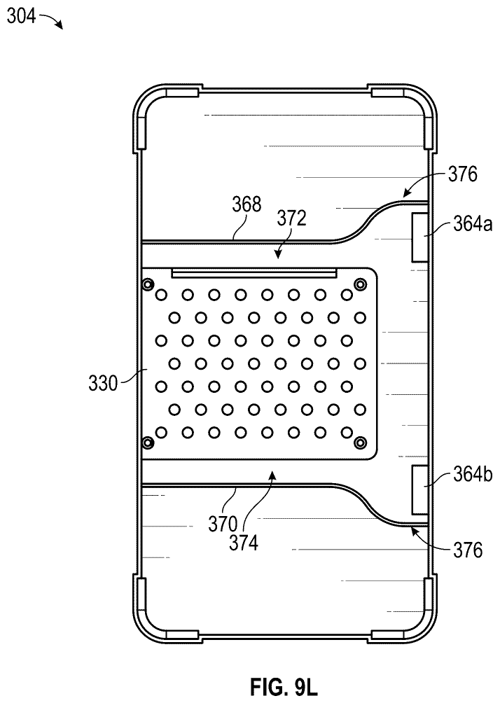

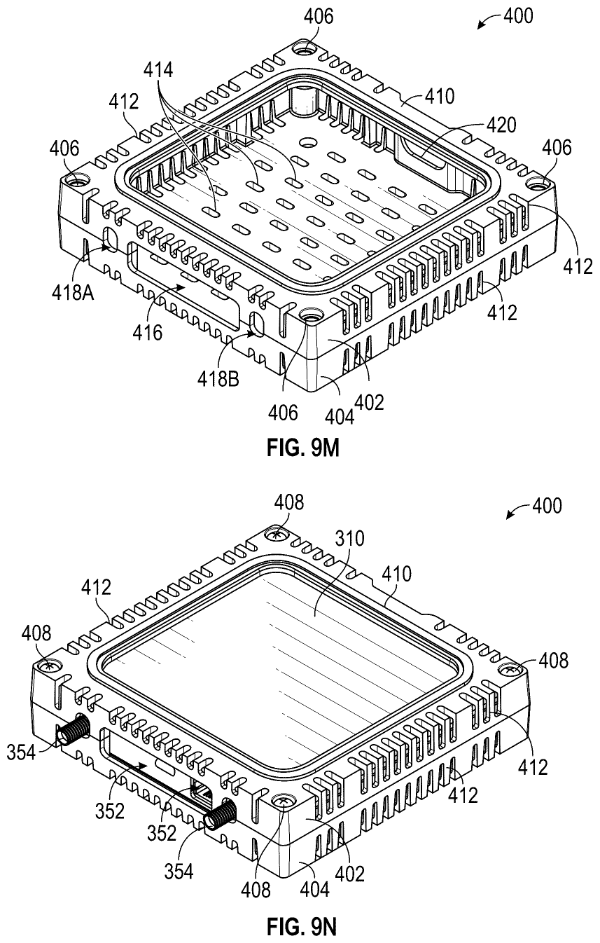

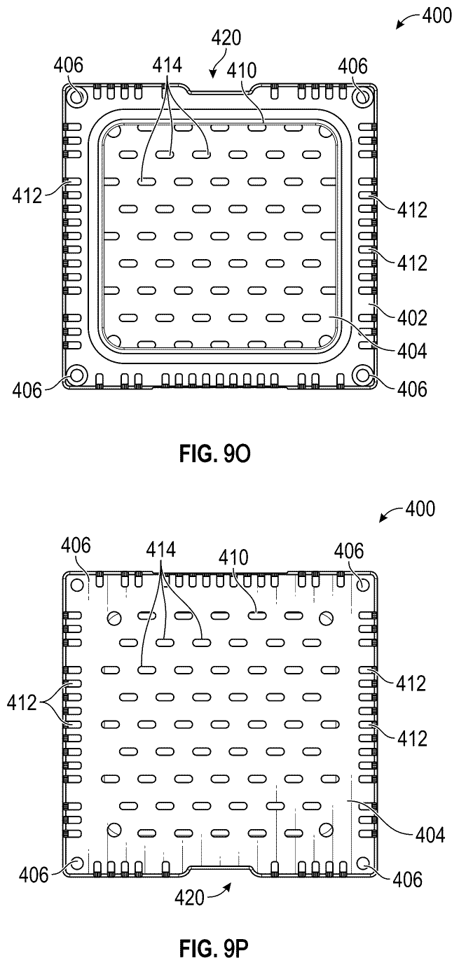

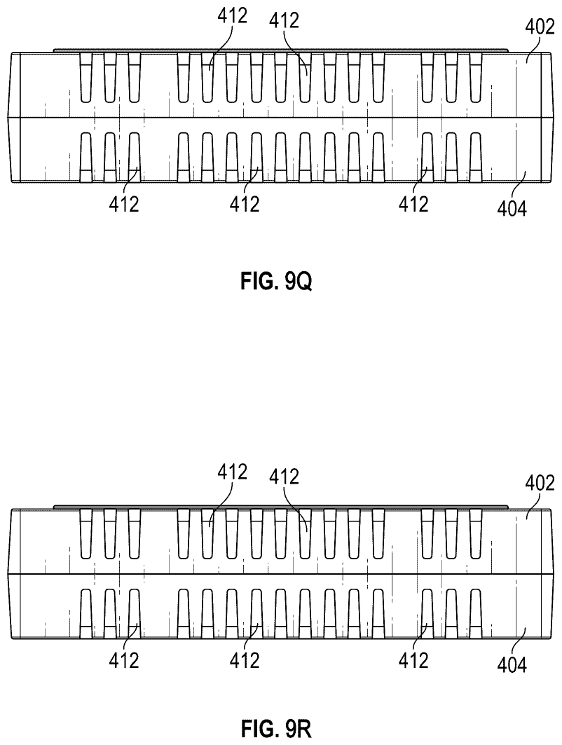

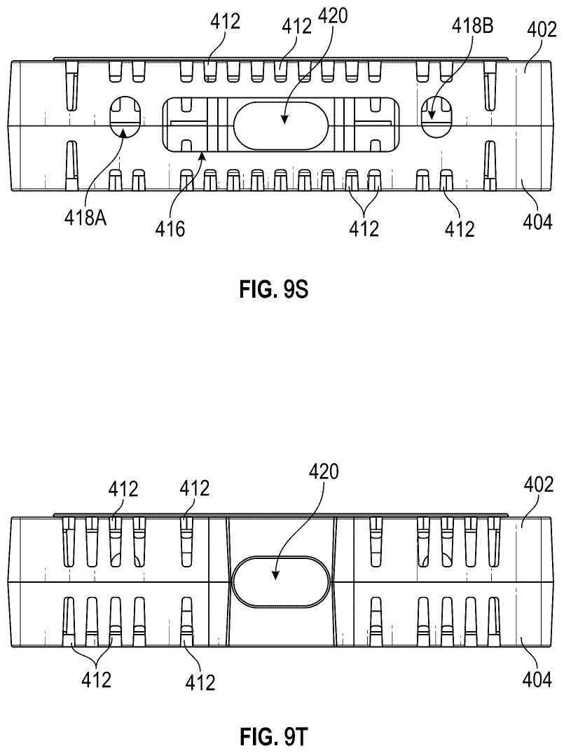

FIGS. 9A-9T illustrate various views of an antenna assembly 300 and components thereof. Some features of the antenna assembly 300 are similar or identical to features of the antenna assembly 200 in at least FIG. 1A-5K and/or the antenna assembly 200′ in FIGS. 6A-8H. Thus, reference numerals used to designate the various features or components of the antenna assembly 200 and the antenna assembly 200′ are identical to those used for identifying the corresponding features of the components of the antenna assembly 300 in FIGS. 9A-9T, except that the numerical identifiers for the antenna assembly 300 begin with a “3” instead of a “2”. Therefore, the structure and description for the various features of the antenna assembly 200 and antenna assembly 200′ and the operation thereof as described in at least FIGS. 1A-5K and FIGS. 6A-8H respectively are understood to also apply to the corresponding features of the antenna assembly 300 in FIG. 9A-9T, except as described differently below.

FIG. 9A shows a perspective view of an implementation of the antenna assembly 300. FIG. 9B shows a perspective view of the antenna assembly 300 with the cover removed. The antenna assembly 300 can include a base 302, a cover 304, and a multi-band antenna 301. As shown in FIG. 9B, the multi-band antenna 301 can include one or more multi-band radiator portions 100′ and/or one or more dual-band WiFi radiator portions 314. While FIGS. 9A and 9B show the antenna with multi-band radiator portions 100′, it is recognized that the antenna assembly 300 can include one or more the multi-band radiator portions 100 in addition to or alternatively to the multi-band radiator portions 100′. Additionally, various alternative antenna elements can also be incorporated into the multi-band multi-element antenna 301, in some implementations. For example, any of the multi-band radiator multi-band radiator portions 100, multi-band radiator portions 100′, multi-band radiator portion 100″, dual-band WiFi radiator portions 214, GPS antenna elements 224, multi-band radiator portion 500, multi-band antenna 600, multi-band antenna 700, multi-band antenna 800, multi-band antenna 900, multi-band antenna 1000, stacked patch antenna 1100, and/or multi-band radiator portion 1200 can form part of the multi-band multi-element antenna 301 of the antenna assembly 300. Additionally, in some implementations, any of the millimeter wave radios 250 described with reference to at least FIGS. 18A-18D can be incorporated into the antenna assembly 300.

The antenna assembly 300 can also include a modem 310 and a modem shell 400. The term “modem” can refer to a router, a wireless modem, a modem-router, hotspot, and/or the like. The modem 310 can be wireless and may include an internal power source, allowing the antenna assembly 300 to be portable. The modem shell 400 is described further with reference to FIGS. 9M-9T. In some implementations the antenna assembly 300 can include a GPS antenna 324.

The antenna assembly 300 differs from the antenna assembly 200 in that the multi-band antenna 201 and the modem 310 are housed within the same internal volume without a divider. Accordingly, the antenna assembly 300 may have a shorter height than the antenna assembly 200. The cover 304 can be removably coupled to the base 302 to define an internal volume of the antenna assembly 300. The cover 304 can include one or more vents 306. Vents 306 can be configured for heat flow (e.g., to allow heat produced by the components of the antenna assembly 300 to be exchanged with the environment). For example, the cover 304 can include one or more vents 306 in the side walls and/or the top wall (not shown). The cover 304 may also include one or more environmental connection ports 340. The environmental connection ports 340 may extend through a side wall of the cover 304, allowing the antenna assembly 300 to be connected to cables and/or transmission lines. The environmental connection ports 340 may each include a cover 342 that can prevent dust, debris, liquid, and/or the like from entering the internal volume of the antenna assembly 300. The base 302 may serve as the ground plane for the antenna assembly 300. As such, the base 302 may be made of an electrically conductive material. In some implementations, a separate ground plane for the multi-band antenna 301 may be coupled to or supported by the base 302.

In some implementations, the antenna assembly 300 can be configured to be supported by the base 302 in an arrangement with the base 302 positioned below the cover 204 (e.g., on a horizontal surface). In some implementations, the base 302 can be configured to be mounted to a vertical surface (e.g., a wall). Mounting the antenna assembly 300 to a wall (e.g., via the base 302 or an additional component) can provide certain advantages, particularly when the antenna is configured as a directional antenna, as described herein. In some cases, the antenna assembly 300 can be configured as a directional antenna, such as when one or more multi-band radiator portions 1200 of FIGS. 17A-17G and/or one or more stacked patch antennas 1100 of FIG. 16 are included in the antenna assembly 300. When the antenna assembly 300 is configured as a directional antenna, mounting the antenna assembly 300 on the wall can provide certain advantages. For example, a wall-mounted antenna assembly 300 can allow for an elevated position, which can provide a clearer line of sight to the device or networks the antenna assembly 300 is intending to communicate with (e.g., by reducing obstructions such as furniture, people, other objects, etc.) compared to if the antenna assembly 300 was positioned on a table. The wall-mounting of the antenna assembly 300 can also reduce potential interferences from other electronic devices positioned near the antenna assembly 300, with can improve signal quality and consistency in some cases. A wall-mounted antenna assembly 300 configured as a directional antenna can be aimed in a specific direction. For example, by wall-mounting, the antenna assembly 300 can be strategically pointed towards an area or device.

In some implementations, when the antenna assembly 300 is configured as a directional antenna (e.g., including one or more stacked patch antennas 1100 and/or multi-band radiator portions 1200) it can be advantageous to position the base 302 on a horizontal surface in some cases (e.g., to point vertically). For example, such an arrangement can be desirable when the antenna assembly 300 is configured to communicate with a satellite. In this example, the vertical direction of the antenna assembly 300 can provide improved line of sight to the satellite(s). For example, pointing the antenna assembly 300 vertically toward the satellite ensures the strongest possible signal is directed at the target. Misalignment could result in signal loss or weak reception. In some cases, satellite communication systems often require precise alignment in both azimuth (horizontal) and elevation (vertical) to maintain an optimal connection. A vertically oriented antenna assembly 300 configured as a directional antenna will can be aimed at a specific elevation angle that matches the satellite's position relative to the ground station. An additional advantage of pointing the antenna assembly 300 vertically can include minimizing interference from terrestrial signals and reflections from the ground or nearby objects, which can be especially important when communicating with high-altitude satellites.

Referring now to FIGS. 9C and 9D, a top perspective view and a bottom perspective view of the cover 304 are shown respectively. The cover 304 can include a modem support portion 330. The modem support portion 330 can be configured to support the modem 310 above the base 302. The modem support portion 330 can be accessed via an opening 331. The opening 331 may extend through a top wall and/or a side wall of the cover 304. The opening 331 can be configured to allow the modem shell 400 and/or the modem 310 to be removed and installed on the modem support portion 330 without requiring the cover 304 to be removed from the base 302. Accordingly, the modem 310 can be easily removed from the antenna assembly 300 without exposing the multi-band antenna 301. The modem support portion 330 can include a bottom portion 332 and one or more side walls 334. The bottom portion 332 can support the modem shell 400 and/or the modem 310. When the cover 304 is coupled to the base 302, the bottom portion 332 of the modem support portion 330 is suspended above the base 302. The one or more side walls 334 can be configured to prevent the modem shell 400 from moving relative to the modem support portion 330. For example, the modem support portion 330 may be configured to have a transition fit with the modem shell 400. In some cases, at least one of the one or more side walls 334 can include opening(s) for routing cables through the modem support portion 330 to the modem 310. The bottom portion 332 and/or the one or more side walls 334 can include one or more openings/vents 336. The vents 336 can be configured for heat flow (e.g., to allow heat produced by the modem 310 to be exchanged with the environment). When bottom portion 332 includes vents 336, the modem 310 can be exposed to airflow between the base 302 and the cover 304 for improved heat exchange. In some implementations, the modem support portion 330 may be configured to allow the modem shell 400 to be removably coupled to the modem support portion 330. For example, the modem shell 400 may have a snap fit connection (not shown) with the modem support portion 330. In other examples, the modem support portion 330 may include grooves (not show) for receiving slots (not shown) of the modem shell 400. Other mechanical connections between the modem shell 400 and the modem support portion 330 could also be utilized.

Referring back to FIG. 9B, the antenna assembly 300 may include one or more multi-band radiator portions 100′ and/or one or more dual-band WiFi radiator portions 314. In the illustrated example, the antenna assembly 300 includes four multi-band radiator portions 100′; however, more or fewer are possible, depending on the desired application. In some implementations, the antenna assembly 300 may not include any one or more dual-band WiFi radiator portions 314. As noted above, the modem 310 may have internal radiating portions such that the one or more dual-band WiFi radiator portions 314 may not be required. However, even when the modem 310 includes internal radiating portions, the antenna assembly 300 may still include one or more one or more dual-band WiFi radiator portions 314, particularly for high port count applications. Further, as described herein, the antenna assembly 300 may include any of the antenna of FIGS. 10A-18D in some implementations.

FIGS. 9E-9L illustrate another implementation of the antenna assembly 300. FIGS. 9E and 9F show top perspective views of the antenna assembly 300 with the modem shell 400. FIG. 9G shows a top perspective view of the antenna assembly 300 with the modem shell 400 and modem 310 removed. FIG. 9H shows a top perspective view of the antenna assembly 300 with the cover 304 removed. FIG. 9I shows a perspective exploded view of the base 302 and associated components. FIG. 9J shows a bottom view of the base with the bottom components of the base removed. FIGS. 9K and 9L show a bottom perspective view and a bottom view respectively of the cover 304 is isolation.

In some implementations, the antenna assembly 300 and/or any of the antenna assemblies described herein can be configured for use in a vehicle. In some configurations, it can be desirable for the antenna assembly 300 to be removably coupled to vehicle. For example, the antenna assembly 300 can be removably mounted to the vehicle for use within the vehicle and removable from the vehicle for use external to the vehicle. In one example, the antenna assembly 300 can be configured to be magnetically coupled to a vehicle. For example, the base 302 can be configured to magnetically couple to a mounting plate 356 via one or more magnets 358 housed in the base 302. In some cases, the base 302 may include a recess 360 extending upwardly into the base 302 for receiving the mounting plate 356. Such a configuration would allow the antenna assembly 300 to be seamlessly integrated into the vehicle when the mounting plate 356 is received within the base 302. The mounting plate 356 can be configured to be mounted to the vehicle (e.g., the dashboard) using any conventional means. In one example, as adhesive can be used (e.g., an adhesive gasket 362). In another example, fasteners can be used.

In some implementations, the antenna assembly 300 and/or any of the antenna assemblies described herein can include one or more fans, blowers, or other similar devices for forced air convection. The one or more fans 364 can be housed within the internal volume between the base 302 and the cover 304 in some implementations. In some cases, the one or more fans 364 can be configured to draw air into the internal volume from an environment external to the antenna assembly 300 such that air within the internal volume is forced out of the internal volume (e.g., via the one or more vents 306). In other cases, the one or more fans 364 can be configured to force air from the internal volume through the one or more vents 306 and/or additional vents 366 to the external environment such that air from the external environment is drawn into the internal volume due to the reduction in pressure.

In some implementations, the one or more fans 364 can be configured to provide cooling to both the multi-band radiator portions 100 and the modem 310. In some implementations, the one or more fans 364 can be configured to provide cooling primarily to the modem 310 or to the multi-band radiator portions 100′. In one example, the antenna assembly 300 can include one or more internal walls configured to provide partial or full isolation for airflow between the multi-band radiator portions 100′ and the modem 310. For the example, one or both of the base 302 and the cover 304 can include internal walls 368, 370 that extend between the modem support portion 330 and the multi-band radiator portions 100′. For example, a first internal wall 368 may extend from the base 302 towards the cover 304 (or vice-versa) along a first side of the modem support portion 330 within the internal volume and a second internal wall 370 may extend from the base 302 towards the cover 304 (or vice-versa) along a second side of the modem support portion 330 within the internal volume. In such a configuration, the first internal wall 368 can define a first flow channel 372 between a first side wall 334 of the modem support portion 330 and the second internal wall 370 can define a second flow channel 374 between a second side wall 334 (opposite the first side wall 334) of the modem support portion 330. As described herein, the one or more side walls 334 of the modem support portion 330 can include vents, channels, and/or other openings (e.g., opening 331) to allow fluid communication between modem support portion 330 and the internal volume of the antenna assembly 300. In such an implementation, a first fan 364a can be positioned within the first flow channel 372 and a second fan 364b can be positioned in the second flow channel 374. The first and second fans 364 can induce fluid (e.g., air) flow along the two channels 372, 374 to provide cooling to the modem 310. For example, the air flow can contact the modem 310 via the vents 336 in the one or more side walls 334 and via the slots 412 in the modem shell 400 as described further herein. The first fan 364a can be aligned with a first vent 366 in the cover 304 and the second fan 364b can be aligned with a second vent 366 in the cover 304 in some implementations. The first vent 366 can allow for fluid exchange between the first flow channel 372 and the external environment. The second vent 366 can allow for fluid exchange between the second flow channel 374 and the external environment.

In some implementations, the internal walls 368, 370 of the flow channels 372, 374 can be configured to direct air flow from the fans 364 inwardly towards the modem 310. For example, the internal walls 368, 370 can include curved or angled portions 376 that force some fluid from the fans 364 in a direction generally towards the modem support portion 330. Such a configuration can increase the amount of forced air convention provided to the modem 310.

In some implementations the cover 304 can include one or more cable routing ports 378 to allow the modem 310 to connect to an external system through the cover 304 without removing the modem shell 400 or the modem 310 from the antenna assembly 300. For example, the cover 304 can include an ethernet port or opening, a USB port or opening, a USBC port or opening, and/or the like.

In some implementations, the antenna assembly 300 can include a power source, such as a battery 380. The battery 380 can be configured to power the one or more fans 364 and/or to provide power to the modem 310. For example, the battery 380 can serve as a second power source for the modem 310. In some implementations, the battery 380 can extend the use of the modem 310 by approximately twice the life of the modem's 310 internal power source. In some implementations, the battery 380 can extend the use of the modem 310 by more than two times the life of the modem's 310 internal power source.

In some implementations, the battery 380 can be housed within the base 302. For example, the base 302 can include a recess 382 for receiving the battery 380 in the bottom side of the base 302. The recess 382 may be configured to be covered with a removable cover (not show). For example, the battery 380 can be configured to be removable from the base 302. Such a configuration can provide a benefit of allowing the battery 380 to be easily replaced as desired. For example, when the antenna assembly 300 is not connected to a power source, a user can achieve extended use of the antenna assembly 300 by replacing the spent battery 380 with a charged replacement battery 380. In some implementations, the battery 380 can be an uninterruptible power supply (UPS) for the modem 310 and/or the antenna assembly 300. For example, when the antenna assembly 300 is connected to a power source, the battery 380 may be recharging while power is supplied to the modem 310. When the antenna assembly 300 is disconnected from the power source, the battery 380 can provide power to the modem 310. Such a configuration can prevent the modem 310 and/or the antenna assembly 300 from experiencing power disruptions and/or can ensure continuous operation. The recess 380 may be positioned below the modem support portion 330. For example, the modem 310 can be positioned substantially over the battery 380 when both components are inserted in the antenna assembly 300. In other implementations, the battery 380 can be housed within the internal volume of the antenna assembly 300.

In some implementations, the battery 380 can be connected to a circuit system 384. The circuit system 384 can be configured to route power from the battery 380 to the fans 364 and/or the modem 310. In some cases, the circuit system 384 can be housed within the internal volume of the antenna assembly 300. In some implementations, the circuit system 384 can include a microcontroller or other programmable processors or controllable processing system.

In some implementations, the antenna assembly 300 can include a heating system (not shown). For example, the antenna assembly 300 may include a heating element, heating pad or similar device. The heating system can be configured to provide heat for the battery 380 and/or the antenna assembly 300 as required. For example, when the antenna assembly 300 is used in a cold environment, it may be desirable to provide heat to the battery 380. The battery 380 can provide power for the heating pad. In some cases, the heating pad can be positioned on a top or internal side 382 of the recess 382 of the base 302 that is configured to receive the battery 380. The internal side 382 can be within the internal volume of the antenna assembly 300. For example, the heating pad can be positioned between the internal side 386 of the recess 382 and the modem support portion 330. In some configurations, the base 302 may be made of a conductive material, such as aluminum, which can allow the battery 380 to receive heat from the heating pad through the base 302.

In some implementations, the circuit system 384 can be configured to control the operations of the fans 364 and the heating pad. In some cases, the circuit system 384 can control such operations without direct user control. The antenna assembly 300 may include one or more sensors (not shown) that provide the circuit system 384 with signals related to the internal or external environment of the antenna assembly 300. For example, the antenna assembly 300 may include one or more temperature sensors. The one or more temperature sensors may be positioned within the internal volume of the antenna assembly 300. In some implementations, the antenna assembly 300 can be configured to control operation of either the fans 364 or the heating pad, depending on signals received from the temperature sensors. For example, when the temperature sensors indicate that the detected temperature is below a first threshold value, the circuit system 384 may cause the heating pad to be activated. Similarly, when the temperature sensors indicate that the detected temperature is above a second threshold value, the circuit system 384 may cause the fans to be activated. Depending on the first and second threshold values, the antenna assembly 300 may be operated without either the fans 364 or the heating pad in operation.

FIGS. 9M and 9O-9T illustrate various view of the modem shell 400. FIG. 9N illustrates the modem shell 400 engaged with the modem 310. The modem shell 400 can be configured to support and protect the modem 310. The modem shell 400 can be configured to support a number of different modem types. The modem shell 400 can increase the height from which the modem 310 can be safely dropped from without damage occurring to the modem 310. For example, in some implementations, the modem shell 400 can be configured for a 3-meter drop test. The modem shell 400 can be configured for use with the antenna assembly 300. The modem shell 400 can also be used without the antenna assembly 300. For example, a user may use the modem shell 400 for added protection for the modem 310 without the antenna assembly 300.

The modem shell 400 can include a top cover 402 and a bottom cover 404. The top cover 402 can be configured to be removably coupled to the bottom cover 404. For example, in one implementation, one or more fastener holes 406 can extend through the top cover 402 and bottom cover 404. The fastener holes 406 can be configured to receive fasteners 408 (see e.g., FIG. 9N). In other implementations, other methods can be used to removably couple the top cover 402 to the bottom cover 404.

The top cover 402 can include a modem window 410. The modem window 410 can be a cutout extending through a top side of the top cover 402. The modem window 410 can allow a portion of the modem 310 to be exposed to airflow and visible through the modem shell 400. The covers 402, 404 can include a plurality of cutouts or slots 412. The slots 412 can be configured to promote airflow to the modem 310. For example, the slots 412 can be vents. The slots 412 can extend along the side walls of the covers 402, 404. In some implementations, the slots 412 in the top cover 402 can extend along the top side of the top cover 402 and the bottom side of the bottom cover 404. The bottom cover 404 can include a plurality of cutouts or holes 414. The holes 414 can be formed in a bottom side of the bottom cover 404. The holes 414 can be configured to promote airflow to the modem 310 in the modem shell 400.

The modem shell 400 can include one or more additional cutouts for access to the modem 310. The cutouts can be formed in the side walls of the covers 402, 404. For example, the modem shell 400 can include a modem port cutout 416. The modem port 416 can provide access through the modem shell 400 to various ports 352 of the modem 310 (e.g., USB port(s), USB-C port(s), ethernet port(s), etc.). In another example, the modem shell 400 can include one or more adaptor cutouts 418. For example, the modem shell 400 can include a first adaptor cutout 418A and a second adaptor cutout 418B. The adaptor cutouts 418 can be configured to allow cable adaptors 354 for the modem 310 to pass through the modem shell 400. Depending on the type, the modem 310 may not include cable adaptors 354. In yet another example, the modem shell 400 can include a power button cutout 420. The power button cutout 420 can be configured to provide access through the modem shell 400 to a power button of the modem.

In some implementations, the modem 310 may be positioned within the modem shell 400 with gaps or spaces between the modem 310 and the walls defined by the top cover 402 and the bottom cover 404. For example, a gap may extend between the side walls of the modem 310 and the side walls of the modem shell 400. Such a gap can provide increased air flow to the modem 310 through the modem shell 400. For example, the sidewall gap can provide for an air pocket around the modem 310. However, it is generally desirable that the modem 310 be configured to have limited movement relative to the modem shell 400. As such, the modem shell 400 can include one or more mechanisms for restricting movement of the modem 310 relative to the modem shell 400. In one example, the modem shell 400 may include one or more projections positioned within the sidewall gap between the modem 310 and the modem shell 400. For example, each corner of the modem shell 400 may include a projection. The projections can engage the modem 310 such that movement is restricted between the modem 310 and the modem shell 400 during normal use of the modem shell 400 while still allowing the modem 310 to be removed from the modem shell 400 when desired. In some cases, a second gap can be defined between the top of the modem 310 and the top cover 402 and/or a third gap can be defined between the bottom of the modem 310 and the bottom cover 404. The second gap and/or the third gap can be additional or alternative to the sidewall gap. The second and third gaps can perform a similar air pocket function as the sidewall gap. In some configurations, one or more additional projections may extend from the top cover 402 towards the top of the modem 310 and/or from the bottom cover 404 towards the bottom of the modem 310 to restrict movement between the modem 310 and the modem shell 400 while maintain the desired second and/or third gaps.

In some implementations, the modem 310 may include or may be configured to receive a SubMiniature version A (SMA) to Time-Sensitive Networking (TSN) adaptor. The modem shell 400 can include one or more adaptor cutouts 418 for the one or more SMA-TSN adaptors.

FIGS. 10A-10J illustrate various views of components of a multi-band radiator portion 500, in accordance with some aspects of this disclosure. Some features of the multi-band radiator portion 500 are similar or identical to features of the multi-band radiator portion 100′ in at least FIGS. 8A-8H. Thus, reference numerals used to designate the various features or components of the multi-band radiator portion 100′ are identical to those used for identifying the corresponding features of the components of the multi-band radiator portion 500 in FIGS. 10A-10J, except that the numerical identifiers for the multi-band radiator portion 500 begin with a “5” instead of a “1” and do not end with a “prime”. Therefore, the structure and description for the various features of the multi-band radiator portion 100′ and the operation thereof as described in at least FIGS. 8A-8H are understood to also apply to the corresponding features of the multi-band radiator portion 500 in FIGS. 10A-10J, except as shown and described differently. Additional disclosure regarding antenna systems and assemblies including the multi-band radiator portions 500 of FIGS. 10A-10H is further described in U.S. Provisional Application No. 63/637,247, filed Apr. 22, 2024, entitled “Antenna Systems,” the entire contents of which is hereby incorporated by reference herein in its entirety. The disclosure and Figures in U.S. Provisional Application No. 63/637,247 can be used in connection with the disclosure and Figures described and shown herein.

One or more multi-band radiator portions 500 can form part of any of the multi-band multi-element antennas described herein (e.g., the multi-band multi-element antenna 201 of the antenna assembly 200, the multi-band multi-element antenna 201′ of the antenna assembly 200′, the multi-band multi-element antenna 201A of the antenna assembly 200A, the multi-band multi-element antenna 301 of the antenna assembly 300, etc.). In FIGS. 10A-10H, particular reference is made to various components of the antenna assembly 300 and how those components interact with the multi-band radiator portion 500. However, it is recognized that one or more multi-band radiator portions 500 may be integrated into any of the antenna assemblies 200, 200′, 200A, and/or 300. In particular, one or more of the multi-band radiator portions 100′ and/or multi-band radiator portions 100 of the antenna assemblies 200, 200′, 200A, and/or 300 may be replaced with one or more of the multi-band radiator portions 500.

Each multi-band radiator portion 500 can include a multi-band radiating element 501 and a ground connection 503 (also referred to herein as a “grounding portion”). The ground connection 503 is configured to couple multi-band radiating element 501 a ground plane, such as the base 302 (when configured as a ground plane) of the antenna assembly 300. FIG. 10A shows a perspective view of the multi-band radiating element 501 and the ground connection 503 coupled together and secured to a mounting portion 502. As shown in FIG. 10A, fasteners 505 can be used to secure the multi-band radiating element 501 to the mounting portion 502. The fasteners 505 can also be used to secure the mounting portion 502 and the ground connection 503 to the base 302. FIGS. 10B-10F illustrate assorted views of the multi-band radiating element 501. FIGS. 10G-10J illustrate assorted views of the ground connection 503. It is recognized that the multi-band radiator portion 500 described herein is just one example of multi-band radiator portions that can be included in the antenna assemblies described herein. In other implementations, different multi-band radiator portions can be included. In the illustrated implementation, the radiating element 501 and the ground connection 503 are constructed of metal (e.g., a conductive sheet). In some cases, the conductive sheet can have a thickness between 0.01 inches and 0.03 inches. In other implementations, the radiating element 501 and/or ground connection 503 could be constructed out of several rigid PCB portions or a single flex circuit PCB (e.g., supported by the radome 304 or another RF-transparent supporting structure). For example, the formed three-dimensional multi-band radiator portions 500 described with reference to FIGS. 10A-10J can be supported by PCB structures, sheet metal, or other conductive surfaces that hold their three-dimensional shape, configured and adapted to be housed within the radome 304 along with other multi-band radiator portions (e.g., other multi-band radiator portions 500). The three-dimensional multi-band radiator portions can be paired with one or more formed ground plane(s), such as the base 302, that can permit a frequency range of 450 MHz to 8 GHZ, which can provide a wider range of frequencies than antenna systems currently known in the art, with improved cost effectiveness and simplicity of manufacture. The multi-band radiator portion 500 allow for the antenna to be compact, making it ideal for compact 3GPP or other telecommunication transmitters, in some implementations.

According to some implementations, when the multi-band radiator portion 500 are configured as PCB portions, a tab and slot configuration in the PCB material can be used to mechanically locate the individual PCB portions. When appropriate, in some implementations the tab and slot arrangements are then soldered. The soldering process can be used to provide a mechanical and/or electrical connection between the individual PCB portions or one or more sheet metal portions. In some implementations, there are electrically conducting features on one surface of the PCB support material. In other implementations, both sides of the PCB support material are used to for supporting the electrically conducting features. The same surface of any one particular surface of the PCB support material can have separate electrically conducting features that perform different functions for the multi-band antenna system or for an individual multi-band radiating element. In other implementations, one or more sheet metal portions can be configured with optional portions of electrically non-conductive material to provide a similar form and function to that of a PCB portion. The use of mechanical threaded fasteners, heat stakes, keyhole slots, pressure sensitive adhesive, soldering, interlocking, and other coupling techniques may be exploited to couple portions of the multi-element multi-band antenna 301. These coupling techniques are used to firmly hold structures and components in place and/or in contact with one another. In some implementations, the coupling techniques provide an important role in establishing and maintaining a direct electrical connection between two components. In other implementations, the coupling techniques are used to establish firm contact between two surfaces that are electrically conductive. In some implementations, the coupling techniques provide structural integrity between one or more components where one or more portions is electrically non-conductive. In some implementations, one or more of the radiating elements are electromagnetically excited by an individual coaxial transmission line (e.g., one coaxial transmission line for each of the radiating elements). In other implementations, the one or more of the radiating elements are electromagnetically excited by a microstrip, stripline, conductor backed coplanar waveguide, parallel plate, twin lead, wire above a groundplane, or other suitable microwave or telecommunication transmission line.

Referring first to FIGS. 10B-10F, various views of the multi-band radiating element 501 are shown. The multi-band radiating element 501 can define a three-dimensional radiating portion that includes several unique portions. The geometry of these unique portions are configured in a way that the radio frequency energy that is radiated by the multi-band radiator portion 500 has an intended direction that is nearly parallel to a groundplane that the multi-band radiator portion 500 is coupled to (e.g., the base 302). When one or more multi-band radiator portions 500 are incorporated into the multi-band multi-element antenna 301, a radiation intensity that is somewhat stable around its circumference is a typical requirement for the radiation profile for antennas servicing customer premises equipment. This is radiation that is in the same plane or only slightly above the plane of the base 302 and of somewhat equal intensity at a fixed radial distance away from multi-element multi-band antenna 301 of FIG. 7A in the plane of the first base 302. This type of radiation pattern is known as omni-directional for those familiar with wireless telecommunication technology.

With continued reference to FIGS. 10B-10F, the geometry of the multi-band radiator portion 500 can allow for close proximity spacing of other radiating elements of the multi-band multi-element antenna 301 on the base 302. To accommodate this close spacing, the height of the multi-band radiating element 501 can be greater than other three-dimensional inverted F antennas. For example, the multi-band radiating element 501 may have a greater height than the radiating element 101 of at least FIG. 3A and/or the radiating element 101′ of at least FIG. 4A. To obtain close proximity spacing between the radiating elements of the multi-band multi-element antenna 301 on the base 302, the geometry of the multi-band radiating element 501 has several unique features. As shown in FIG. 10C, the multi-band radiating element 501 of the multi-band radiator portion 500 can include a feed portion 519, a first low-band radiating portion 525 and/or a second low-band radiating portion 529. The multi-band radiating element 501 can also include one or more arms 527. The one or more arms 527 can be configured to radiate above the low-band. Accordingly, the arms 527 may be referred to as “high-band radiating portions”. For example, the one or more arms 527 can be configured for radiation in the mid-band and/or in the C-band. In the illustrated example, the multi-band radiating element 501 includes two arms 527. In other implementations, more or fewer arms 527 are possible. Further, in other implementations, the arms 527 or additional/alternative arms can be included in the radiating element 501 and configured for radiation in the high band Wi-Fi band. The illustrated example of the multi-band radiating element 501 does not include secondary arms. However, in some implementations, the multi-band radiating element 501 may include additional arms that are similar or identical to the secondary arms 137′ of the radiating element 101′ of at least FIG. 8A. The feed portion 519 can extend from the bottom of the first low band radiating portion 525. The first low band radiating portion 525 can include one or more mounting features 517a (e.g., holes) to facilitate mounting the multi-band radiating element 501 to the base 302. For example, as shown in FIG. 10A, the holes 517a can receive fasteners 505 to couple the multi-band radiating element 501 to the mounting portion 502. The mounting portion 502 can then be coupled to the base 302 (e.g., using additional fasteners). The first low band radiating portion 525 can extend substantially vertically from the base 302. Accordingly, in some implementations, the first low band radiating portion 525 can be an upright portion of the radiating element 501. The upright portion 525 can have a smaller width than other antennas. For example, the upright portion 525 may have a smaller width than the upright low band radiation portion 125 of the radiating element 101 of FIG. 3A and/or a smaller width than the upright low-band radiation portion 125′ of the radiating element 101′ of FIG. 4A. The upright portion 525 can have a larger height than width. In some implementations, the upright portion 525 can have a height to width ratio that is 2:1 or greater. The upright portion 525 can include a coupling point 531. The coupling point 531 can be used to couple the radiating element 501 to the ground portion 503 (e.g., in a similar or identical manner as the slots 131′ of the multi-band radiator portion 100′). The upright portion 525 can be used for all portions of the desired frequency band of operation to support the radio frequency requirements for the desired frequency band of operation.

The radiating element 501 can include one or more connecting portions 541 for connecting the upright portion 525 to the arms 527. For example, the radiating element 501 can include a first connecting portion 541 for connecting a left arm 527 to the upright portion 525 and a second connecting portion 541 for connecting a right arm 527 to the upright portion 525. With reference to FIG. 10E, the connecting portions 541 can extend a short distance from the upright portion 525 to reduce the overall width of the radiating element 501. In the illustrated example, the arms 527 extend away from the upright portion 525. For example, a greater than 90-degree angle is defined between each arm 527 and the upright portion 525. The arms 527 can extend in substantially the same direction that the upright portion 525 faces. In some implementations, the arms 527 can extend at an angle away from the upright portion 525. The arms 527 can initially extend substantially horizontally from the upright portion 525. The arms 527 can include one or more bend portions. For example, as shown in FIG. 10D, each arm 527 can include a first arm portion 533 that extends from the connecting portion 541 and a second arm portion 535 that extends from the first arm portion 533. The second arm portion 535 can extend approximately vertically from the first arm portion 533. When multiple arms 527 are included, as in the illustrated example, the arms 527 can be similar or identical except that the left arm 527 extends from the left side of the upright portion 525 and the right arm 525 extends from the right side of the upright portion 525. The arms 527 may have a shorter height than the upright portion 525. The second arm portion 535 of the arms 527 can be used to collectively support radiation in the 1.6 GHz to 8 GHz frequency band for the arms 527.

The radiating element 501 can optionally include the second low band radiator portion 529 to aid in accomplishing radiation in the low-band (e.g., approximately 600 MHz to 900 MHZ). The second low band radiating portion 529 can extend from the top of the upright portion 525. In some implementations, the second low band radiating portion 529 can be a head radiating element and can extend at a substantially perpendicular angle from the upright portion 525. The length of low band radiator portion 529 is significantly shorter than other radiating structures to accommodate the closer spacing of neighboring antenna elements. For example, the second low band radiating portion 529 may have a shorter length that the second low band radiation portion 129 of the radiating element 101 of FIG. 3A and/or a shorter length that the second low-band radiation portion 129′ of the radiating element 101′ of FIG. 4A. The additional height of upright portion 525 allows for a shorter than typical second low band radiating portion 529. The ratio and orientation of all portions of radiating element 501 allow for both dominate and higher order modes to support a somewhat omni-directional radiation characteristic for the multi-band radiator portion 500.

Referring now to FIGS. 10G-10J, various views of the ground connection 503 of the multi-band radiator portion 500 are shown. In the illustrated examples, the grounding portion 503 is made of sheet metal. In other implementations, one or more PCB portions with electrically conducting surfaces on one or more sides or layers may be used for the ground connection 503. In this implementation, coupling points 571 and 583 are present to electrically couple to the ground plane (e.g., the base 302) and radiating element 501, respectively. The width, thickness and height of portions 573 and 575 are selected so that the desired radiation pattern characteristics are maintained while providing an impedance match between the multi-band radiating element 501 and the characteristic impedance of the radio frequency transmission lines that connect the radio that is part of the 5G wireless communication link to the multi-element multi-band antenna 301 of FIG. 7A. The ground connection 503 can function in a similar manner as the ground connection 103′ of the multi-band radiator portion 100′ of FIG. 4B.

In some implementations, different antennas may be incorporated into any of the antenna assemblies described herein. For example, an off-the-shelf antenna in its full package (e.g., with a radome and secured to a base and/or ground plane) can replace the multi-band multi-element antenna (e.g., the multi-band multi-element antenna 301) of the antenna assemblies described herein, typically resulting in reduced performance. Such an off-the-shelf antenna could be positioned or secured to a ground plane (e.g., the base 302) and positioned beneath a radome of the respective antenna assembly (e.g., the radome 304). In the example of the antenna assembly 200, the off-the-shelf antenna may be secured to the ground plane 212 in the top internal volume in some cases.

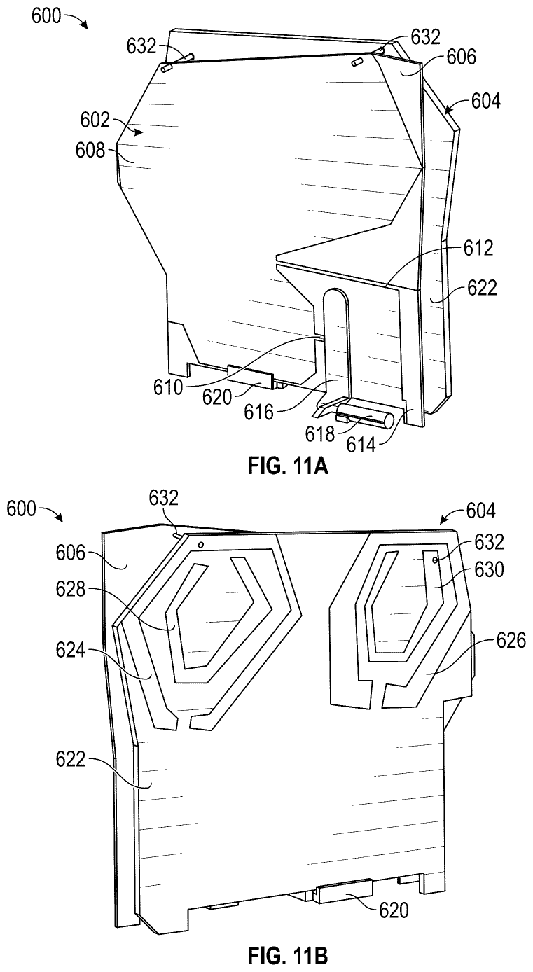

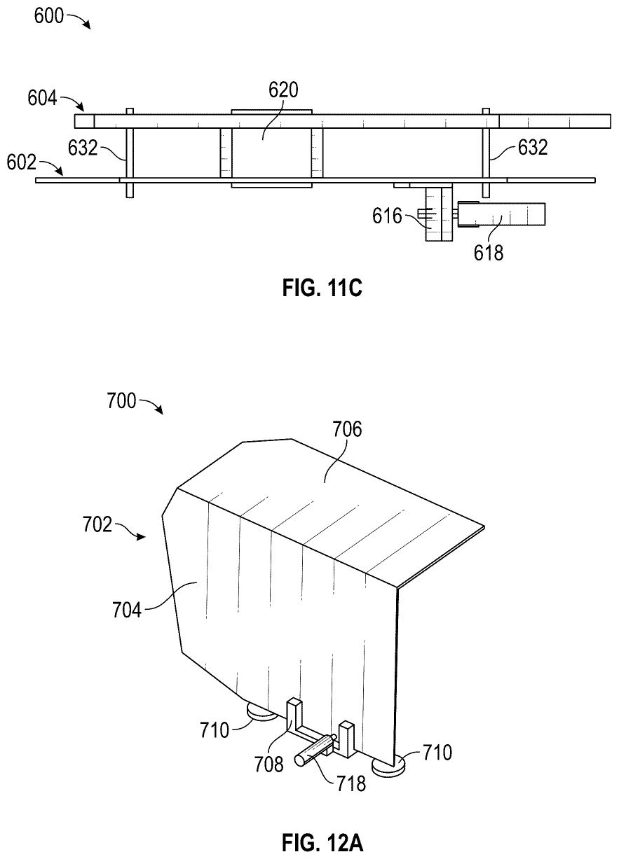

FIGS. 11A-15B illustrate various views of different multi-band antennas that can form part of any of the multi-band multi-element antennas described herein (e.g., the multi-band multi-element antenna 201 of the antenna assembly 200, the multi-band multi-element antenna 201′ of the antenna assembly 200′, the multi-band multi-element antenna 201A of the antenna assembly 200A, the multi-band multi-element antenna 301 of the antenna assembly 300, etc.). In FIGS. 11A-15B, particular reference is made to various components of the antenna assembly 300 and how those components interact with the various multi-band antennas. However, it is recognized that multi-band antennas of FIGS. 11A-15B may be integrated into any of the antenna assemblies 200, 200′, 200A, and/or 300. In particular, one or more of the multi-band radiator portions 100′ and/or multi-band radiator portions 100 of the antenna assemblies 200, 200′, 200A, and/or 300 may be replaced with one or more of multi-band antennas of FIGS. 11A-15B.

FIGS. 11A-11C illustrate various views of a multi-band antenna 600 that can be included in any of the antenna assemblies described herein, in accordance with some aspects of this disclosure. The multi-band antenna 600 can be mounted to the base 302. The multi-band antenna 600 can be a 3D or 2.5D inverted F antenna configured to be utilized with a ground reference, such as the base 302. The multi-band antenna 600 can include a first radiating portion 602 and a second radiating portion 604. In the illustrated example, the first radiating portion 602 is in the form of a first conductive portion 608 etched onto a first PCB portion 606. In other implementations, the first radiating portion 602 and/or the second radiating portion 604 can be sheet metal (e.g., with plastic supports). The multi-band antenna 600 can include a grounding portion configured to connect the first radiating portion 602 to the base 302. The grounding portion can be defined by a first grounding portion 612 that extends from the first conductive portion 608 in the horizontal direction and a second grounding portion 614 that extends from the first grounding portion 612 in the vertical direction along the first PCB portion 606 to the base 302. As such, the grounding portions 612, 614 can electrically connect the first conductive portion 608 to the base 302.

As shown in at least FIG. 11B, the second radiating portion 604 can be in the form of a plurality of conductive portions 624, 626, 628, and 630 etched onto a second PCB portion 622. The conductive portions 624 and 630 of the second radiating portion 604 can be electrically connected to the first conductive portion 608 of the first radiating portion 602. For example, shorting pins 632 can be used to establish the electrical connection from the first PCB portion 606 to the second PCB portion 622 (see e.g., FIG. 11C). The shorting pins 632 can be in the form of electrically conductive cylinders. The additional conductive portions 626 and 628 can be electromagnetically coupled to their neighboring conductive portions, for example, the conductive portion 630 and the conductive portions 624 respectively. The conductive portions 626, 628 can provide additional radiation that may not always be required.

Referring back to FIG. 11A, the multi-band antenna 600 can include a feed arm 616. The feed arm 616 can be in the form of an electrically conductive sheet metal portion, which forms the initial portion of the radiating portion of the multi-band antenna 600. The feed arm 616 can be electrically connected to the first conductive portion 608 of the first radiating portion 602 via feed line 610. The multi-band antenna 600 can be configured to connect to a coaxial cable 618. For example, the center conductor of the coaxial cable 618 can be electrically coupled to the multi-band antenna 600 via the feed arm 616. The outer conductor of the coaxial cable 618 can be electrically connected to a coax feed point of the base 302. In the illustrated example, the multi-band antenna 600 is supported by a non-conductive support portion 620, which can be mechanically coupled to the base 302.

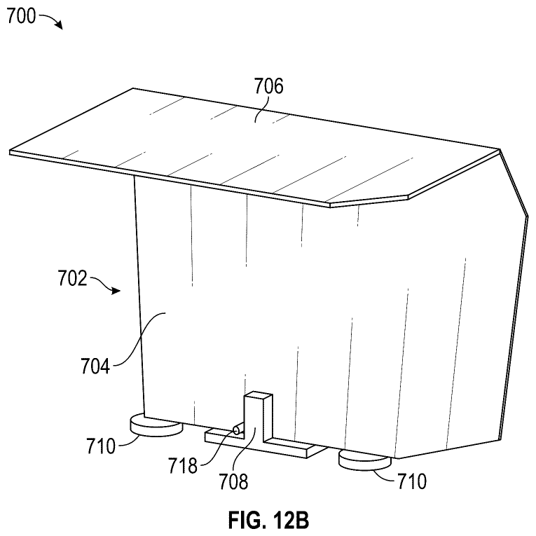

FIGS. 12A-12B illustrate various views of a multi-band antenna 700 that can be included in any of the antenna assemblies described herein, in accordance with some aspects of this disclosure. The multi-band antenna 700 can be a bent monopole antenna configured to be mounted to a ground plane (e.g., the base 302). The multi-band antenna 700 includes a radiating element 702. The radiating element 702 can be bent to define an upright portion 704 and a head portion 706. The bend in the radiating element 702 can allow the multi-band antenna 700 to fit under a fixed radome height. When the multi-band antenna 700 is incorporated into the multi-band multi-element antenna 301, the base 302 may be modified to accommodate the multi-band antenna 700. For example, the base 302 may include openings configured to receive mechanical supports 710. Alternatively, a separate ground plane with openings may be utilized in the antenna assembly 300 instead of the base 302. As such, the openings in the base 302/separate ground plane can have a similar shape to the mechanical supports 710 (e.g., circular). The mechanical supports 710 can be non-conductive. The mechanical supports 710 can be coupled to a lower edge of the upright portion 704 of the radiating element 702 to electrically insulate the radiating element 702 from the base 302. The multi-band antenna 700 can be configured to connect to a coaxial cable 718. For example, the center conductor of the coaxial cable 718 can be electrically coupled to the radiating element 702. The outer conductor of the coaxial cable 718 can be electrically connected to a coax feed point of the base 302. In the illustrated example, the multi-band antenna 700 is further supported by a non-conductive support portion 708, which can be mechanically coupled to the base 302.

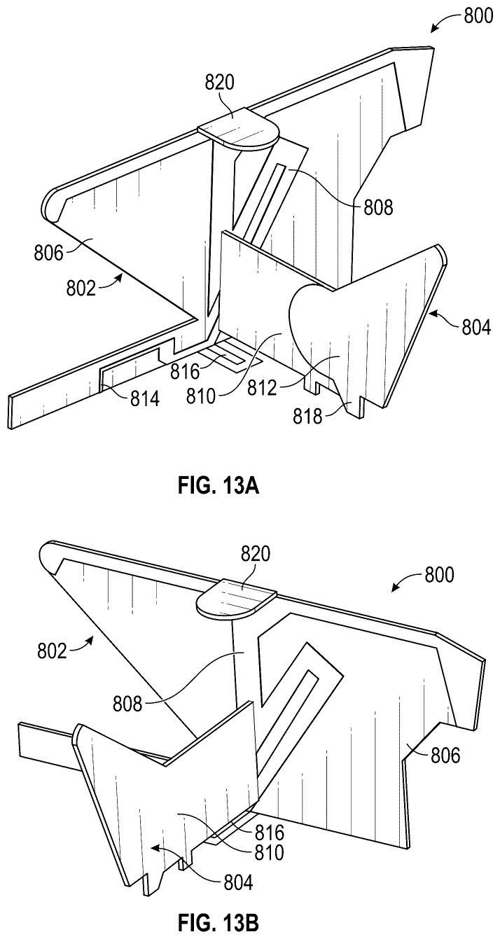

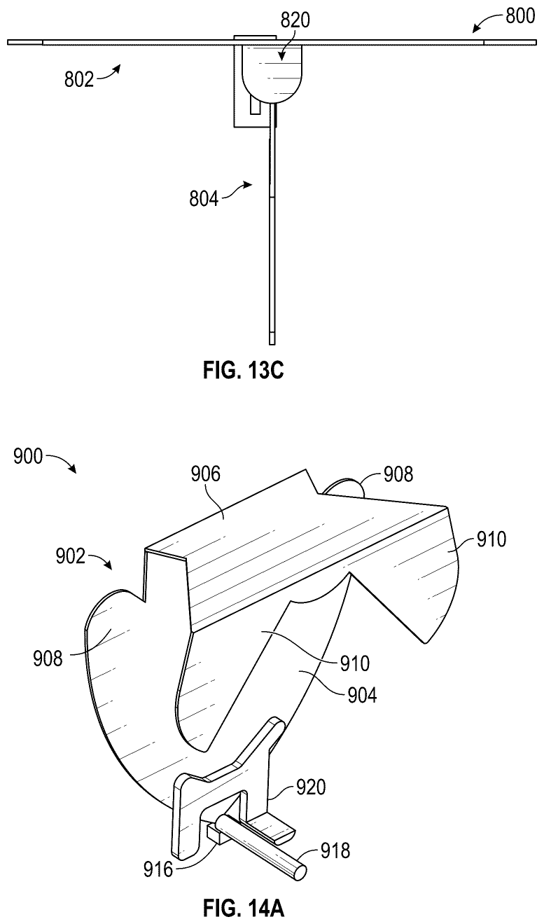

FIGS. 13A-13C illustrate various views of a multi-band antenna 800 that can be included in any of the antenna assemblies described herein, in accordance with some aspects of this disclosure. The multi-band antenna 800 can be mounted to the base 302. The multi-band antenna 800 can be a printed inverted F antenna (“PIFA”). The multi-band antenna 800 can include a first radiating portion 802 and a second radiating portion 804. In the illustrated example, the first radiating portion 802 is in the form of a first conductive portion 808 etched onto a first PCB portion 806. In other implementations, the first radiating portion 802 and/or the second radiating portion 804 can be sheet metal (e.g., with plastic supports). The first radiating portion 802 can be the directly fed portion of the PIFA. For example, a grounding portion 814 can extend from the first conductive portion 808 to electrically connect the first conductive portion 808 to the base 302. A microstrip line 816 can extend from the radio attaching the grounding portion 814 to the multi-band antenna 800. The first radiating portion 802 can include a top portion 820. The top portion 820 can extend orthogonally to the first PCB portion 806. A lower surface (not shown) of the top portion 820 can include a conductive portion that, along with the unequal length arms of the first conductive portion 808 along the first PCB portion 806, can allow for increased impedance bandwidth by having complementary higher order mode performance due to the unequal length arms of the first conductive portion 808.

The second radiating portion 804 can be electromagnetically coupled to the first radiating portion 802. In the illustrated example, the second radiating portion 804 is in the form of a second conductive portion 812 etched onto a second PCB portion 810. The second conductive portion 812 can be electrically coupled to the base 302 at the ground connection 818. The second conductive portion 812 of the second radiating portion 804 can be orthogonal to both the first conductive portion 808 and the top portion 820 of the first radiating portion 802. The second conductive portion 812 can assist with the high-band performance of the multi-band antenna 800.

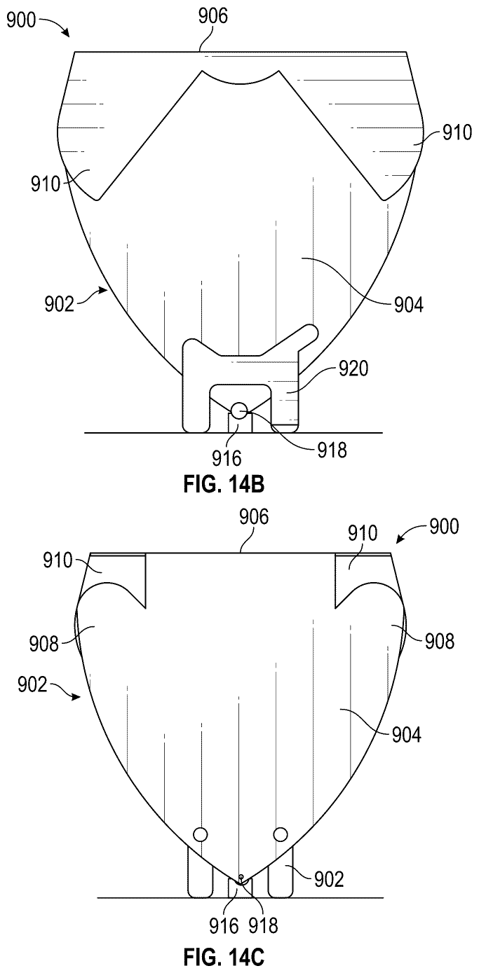

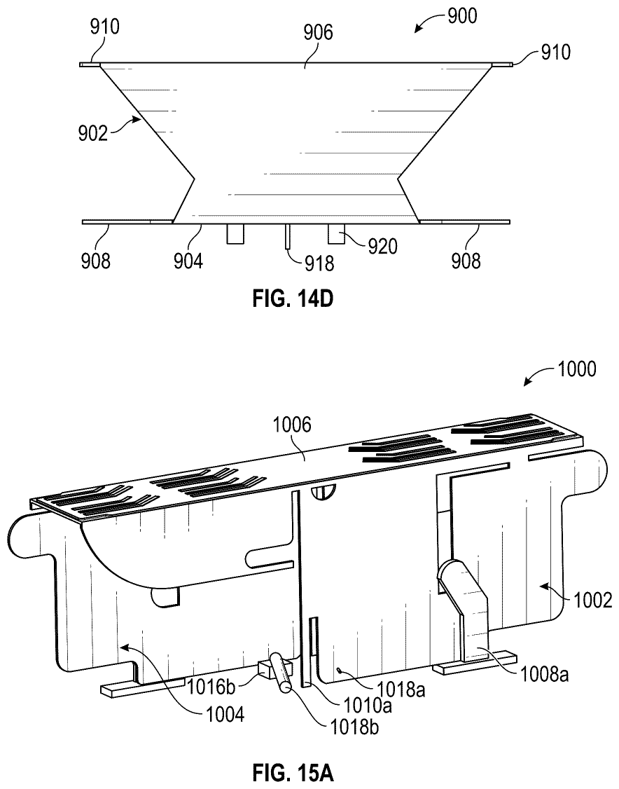

FIGS. 14A-14D illustrate various views of a multi-band antenna 900 that can be included in any of the antenna assemblies described herein, in accordance with some aspects of this disclosure. The multi-band antenna 900 can be a bent monopole antenna configured to be mounted to a ground plane (e.g., the base 302). The multi-band antenna 900 includes a radiating element 902. The radiating element 902 can be bent to define an upright portion 904 and a head portion 906. The bend in the radiating element 902 can allow the multi-band antenna 900 to fit under a fixed radome height. The bend can still allow the radiating element 902 to resonate down to 600 MHz. The radiating element 902 can include one or more first arms 908. The first arms 908 can extend from or form part of the upright portion 904. In some implementations, the first arms 908 can be co-planar to the upright portion 904. The radiating element 902 can include one or more second arms 910. The second arms 910 can extend from or form part of the head portion 906. As shown in FIG. 14D, in the illustrated example, the one or more second arms 910 can extend parallel to the upright portion 904 and may be at an angle and/or orthogonal to the head portion 906. The first arm 908 and the second arms 910 can assist with the input impedance at higher portions of the frequency band. The multi-band antenna 900 can be configured to connect to a coaxial cable 918. For example, the center conductor of the coaxial cable 918 can be electrically coupled to the radiating element 902 at its feed point. The outer conductor of the coaxial cable 918 can be electrically connected to a coax feed point of the base 302. In the illustrated example, the multi-band antenna 900 is supported by a non-conductive support portion 920, which can be mechanically coupled to the base 302. The support portion 920 can include heat stake posts that extend into corresponding openings in the upright portion 904.

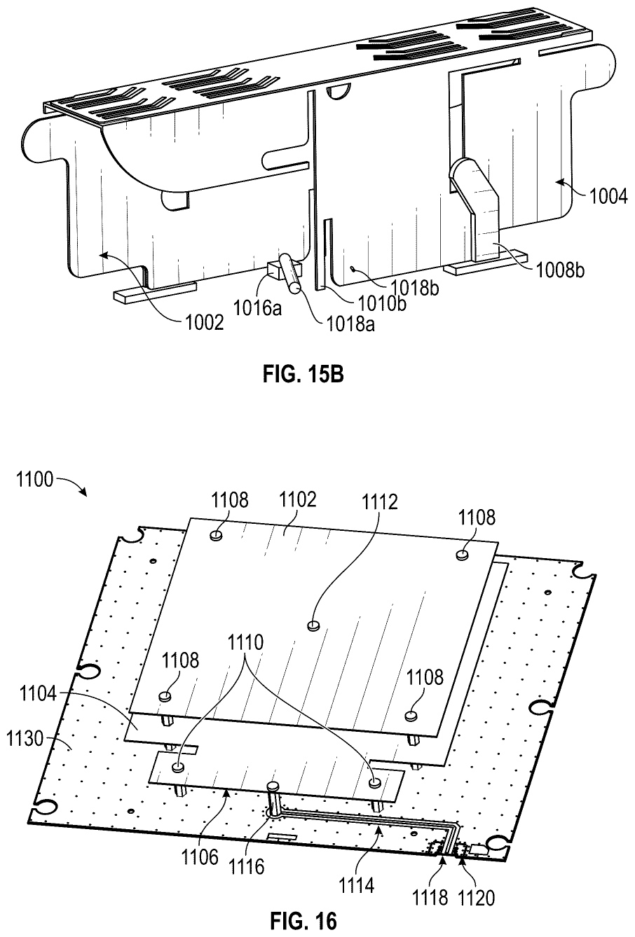

FIGS. 15A-15B illustrate various views of a multi-band antenna 1000 that can be included in any of the antenna assemblies described herein, in accordance with some aspects of this disclosure. The multi-band antenna 1000 can be mounted to the base 302. The multi-band antenna 1000 can comprise two 3D inverted F antennas. For example, the multi-band antenna 1000 can include a first inverted F antenna 1002 and a second inverted F antenna 1004. The first inverted F antenna 1002 and the second inverted F antenna 1004 can be similar or substantially identical to each other. The multi-band antenna 1000 can include a PCB support 1006 that can be coupled to the tops of and provide mechanical support for both inverted F antennas 1002, 1004. The first inverted F antenna 1002 can be further supported by a non-conductive support 1008a. Similarly, the second inverted F antenna 1004 can be further supported by a non-conductive support 1008b. The multi-band antenna 1000 can be configured to connect to coaxial cables 1018. For example, the center conductor of a first coaxial cable 1018a can be electrically coupled to the first inverted F antenna 1002 at its feed point and the center conductor of a second coaxial cable 1018b can be electrically coupled to the second inverted F antenna 1004 at its feed point. The outer conductors of the coaxial cables 1018a, 1018b can be electrically connected to coax feed points of the base 302. Each of the inverted F antennas 1002, 1004 can include a grounding point 1010a, 1010b respectively that can be electrically connected to the base 302.

FIGS. 17A-17G illustrate various views of components of a multi-band radiator portion 1200, in accordance with some aspects of this disclosure. Some features of the multi-band radiator portion 1200 are similar or identical to features of the multi-band radiator portion 100′ in at least FIGS. 4A-4H. Thus, reference numerals used to designate the various features or components of the multi-band radiator portion 100′ are identical to those used for identifying the corresponding features of the components of the multi-band radiator portion 1200 in FIGS. 17A-17G, except that the numerical identifiers for the multi-band radiator portion 1200 begin with a “12” instead of a “1” and do not end with a “prime”. Therefore, the structure and description for the various features of the multi-band radiator portion 100′ and the operation thereof as described in at least FIGS. 4A-4H are understood to also apply to the corresponding features of the multi-band radiator portion 1200 in FIGS. 17A-17G, except as shown and described differently. Additional disclosure regarding antenna systems and assemblies including the multi-band radiator portions 1200 of FIGS. 17A-17G is further described in U.S. Provisional Application No. 63/638,330, filed Apr. 24, 2024, entitled “Antenna Systems,” and U.S. Provisional Application No. 63/676,268, filed Jul. 26, 2024, entitled “Antenna Systems.” The entire contents of both are hereby incorporated by reference herein in their entireties. The disclosure and Figures in U.S. Provisional Application No. 63/638,330 and is U.S. Provisional Application No. 63/676,268 can be used in connection with the disclosure and Figures described and shown herein.

One or more multi-band radiator portions 1200 can form part of any of the multi-band multi-element antennas described herein (e.g., the multi-band multi-element antenna 201 of the antenna assembly 200, the multi-band multi-element antenna 201′ of the antenna assembly 200′, the multi-band multi-element antenna 201A of the antenna assembly 200A, the multi-band multi-element antenna 301 of the antenna assembly 300, etc.). In FIGS. 17A-17G, particular reference is made to various components of the antenna assembly 300 and how those components interact with the multi-band radiator portion 1200. However, it is recognized that one or more multi-band radiator portions 1200 may be integrated into any of the antenna assemblies 200, 200′, 200A, and/or 300. In particular, one or more of the multi-band radiator portions 100′ and/or multi-band radiator portions 100 of the antenna assemblies 200, 200′, 200A, and/or 300 may be replaced with one or more of the multi-band radiator portions 1200.

Each multi-band radiator portion 1200 can include a multi-band radiating element 1201 and a ground connection 1300 (also referred to herein as a “grounding portion”). The ground connection 1300 is configured to couple the multi-band radiating element 1301 to a ground plane, such as the base 302 of the antenna assembly 300 or an alternative ground plane utilized in the antenna assembly 300. The multi-band radiator portion 1200 differs from the illustrated example of the multi-band radiator portion 100′ in that the ground connection 1300 is formed on a PCB 1320, as described further below. FIG. 17A shows a perspective view of the multi-band radiating element 1201 and the ground connection 1300 coupled together and secured to a mounting portion 1202. As shown in FIG. 17A, fasteners 1205 can be used to secure the multi-band radiating element 1201 to the mounting portion 1202. The fasteners 1205 can also be used to secure the mounting portion 1202 to the associated ground plane, e.g., the base 302. FIGS. 17B-17E illustrate assorted views of the multi-band radiating element 1201. FIGS. 17F and 17G illustrate a first side view and a second side view the ground connection 1300. It is recognized that the multi-band radiator portion 1200 described herein is just one example of multi-band radiator portions that can be included in the antenna assemblies described herein. In other implementations, different multi-band radiator portions can be included. In the illustrated implementation, the radiating element 1201 is constructed of metal (e.g., a conductive sheet). In some cases, the conductive sheet can have a thickness between 0.01 inches and 0.03 inches. In other implementations, the radiating element 1201 could be constructed out of several rigid PCB portions or a single flex circuit PCB (e.g., supported by the radome 304 or another RF-transparent supporting structure). For example, the multi-band radiator portion 1200 may be constructed of PCB material, sheet metal, metalized plastic, or other such materials that can be configured and adapted to be used for communication between about 450 MHz to about 8 GHZ.

As noted above, the multi-band radiator portion 1200 can be configured for use with a ground plane, such as the base 302. In some implementations, a different ground plane of the antenna assembly 300 can be positioned or secured to the base 302 and can be constructed from one or more types of PCB material, sheet metal with non-conductive spacers of plastic, foam, ceramic, and metalized plastic. Transmission lines utilized with the multi-band radiator portion 1200 can be microstrip, stripline, conductor back co-planar waveguide, parallel plate waveguide, wire above a groundplane, coaxial cables or other such materials of construction that can be configured and adapted to be used for communication between about 450 MHz to about 8 GHz. According to some implementations, the non-conductive support portions and/or PCB portions of the groundplanes and/or radiating elements can be made of FR4, fiberglass reinforced epoxy, polyester reinforced epoxy, or other similar PCB support material that may have high performance radio frequency properties and that can support electrically conductive features of one or more radiating portions for one or more elements on its structure on one or both side of the support material.

According to some implementations, a tab and slot configuration in the PCB material can be used to mechanically locate the individual PCB portions, sheet metal portions, and/or other electromagnetic structures of the multi-band radiator portion 1200. When appropriate, in some implementations, the tab and slot arrangements are then soldered. The soldering process is used to provide a mechanical and electrical connection between the individual PCB portions. Any sheet metal portion(s) of the multi-band radiator portion 1200 may be supported with non-conductive material for the spacing and mechanical support between the sheet metal and the groundplane. In some implementations, the etched electrically conducting features can be on one surface of the PCB support material. In other implementations, both sides of the PCB support material are used for supporting the electrically conducting features. In other implementations, sheet metal or other construction material that is electrically conductive that is supported by non-conductive material to support the electrically conducting features is used in the multi-band radiator portion 1200.

In some implementations, mechanical threaded fasteners can be used with the multi-band radiator portion 1200 or to couple the multi-band radiator portion 1200 to another structure (e.g., the base 302). The fasteners can be used to firmly hold structures and components in place and in contact with one another. Some of the mechanical features of the antenna assemblies described herein can be formed with a heat staking process to couple different portions together. In some implementations, the mechanical fasteners provide an important role in establishing and maintaining a direct electrical connection between two components. In other implementations, the mechanical fasteners are used to establish firm contact between two surfaces that are electrically conductive. In some implementations, the mechanical fasteners provide structural fastening between one or more components that have wholly non-conductive components. The use of mechanical threaded fasteners, heat stakes, keyhole slots, pressure sensitive adhesive, soldering, interlocking, and other coupling techniques may be utilized to couple portions of the multi-element multi-band antennas described herein. These coupling techniques are used to firmly hold structures and components in place and in contact with one another.

When multiple multi-band radiator portions 1200 are included in the antenna assembly 300, the various multi-band radiator portions 1200 may be rotated in orientation to provide radiation in different polarizations with reference to the direction normal to the groundplane (e.g., the base 302). For example, the orientation of the multi-band radiator portions 1200 may correspond with a 45-degree polarization with respect to vertical (or other types of polarizations as applicable).

In some implementations, the multi-band radiator portion 1200 can be configured to be utilized with one or more ground planes that can be rigid PCBs with independent conductor back co-planar waveguide transmission lines that are electrically coupled to individual multi-band radiator portions 1200. In some implementations, the multi-band radiator portions 1200 can be mechanically coupled to the associated ground plane (e.g., the base 302 or alternative ground plane of the antenna assembly 300) through a plurality of electrically non-conductive connector portions (not shown). For example, as shown in FIG. 17D, the multi-band radiating element 1201 can include one or more openings 1259 in the second low-band radiation portion 1229 configured to receive the non-conductive connector portions. The connector portions can be secured to the multi-band radiating element 1201 with a heat staking process, in one example. The coupling of the connector portions may be accomplished with other manufacturing processes such as a snapping process, threaded fastener process, a key-hole process, an interference staking process, or other suitable mechanical coupling process. The coupling of multi-band radiating element 1201 to the base 302 (e.g., via the connector portions) provides a secure connection that enables a reliable mechanical connection to facilitate a stable electrical connection between the multi-band radiator portions 1200 and their associated transmission line excitations.

In the illustrated example, the multi-band radiator portion 1200 includes a multi-band radiating element 1201 comprised of a sheet metal portion as well as ground connection 1300 comprising a PCB with electrically conductive features on both surfaces. For example, FIGS. 17F and 17G illustrate both sides of the ground connection 1300. The ground connection 1300 may function as an impedance matching component and assist with the radiation characteristics of the fundamental resonance as well as higher order modes. The ground connection 1300 may be made of one or more rigid substrate materials (e.g., FR4) that act as the non-conductive support material and may include an electrically conductive portion on one or more sides or other suitable electrically conductive material for the electrically conductive features on the desired sides or surfaces. As such, the ground connection 1300 may be a one layer or a two layer or a multi-layer PCB of standard processing for the PCB industry. The ground connection 1300 may provide one portion of a multi-portion structure for the multi-band radiator portion 1200. In some implementations, a sheet metal portion may be used to realize the ground connection 1300 (e.g., similar to the ground connection 103, the ground connection 103′, and/or the like).

Referring back to FIGS. 17B-17E, the multi-band radiating element 1201 is comprised of several unique portions. The geometry of these unique portions is configured in a way that the radio frequency energy that is radiated by the multi-element multi-band antenna including the multi-band radiator portion 1200 (e.g., the multi-band multi-element antenna 301) has an intended direction that is normal/perpendicular to groundplane the multi-band radiating element 1201 is coupled to. Accordingly, it can be desirable to mount the antenna assembly 300 to a wall in some application as described above (e.g., for clearer line of sight in a certain direction) or to configure the antenna assembly 300 to be positioned on a horizontal surface (e.g., for satellite applications). Having this predominate radiation direction or orientation for the multi-band radiator portions 1200 may provide certain benefits and differs from traditional multi-band multi-element antennas. The typical radiation direction is in a directional that is the same as, co-planar, or only slightly above the plane of the ground plane. To obtain the radio frequency radiation direction that is normal to the ground plane or otherwise, known as a directional radiation pattern, the geometry of the radiator portion multi-band radiating element 1201 has been adjusted compared to the other multi-band radiating elements described herein (e.g., the radiating element 101, the radiating element 101′, and/or the like). In the illustrated implementation, the feed portion 1219 has been adjusted (e.g., compared to the feed points 119, 119′ of the radiating elements 101, 101′) to accommodate the transmission line feed from a conductor backed co-planar waveguide. The feed portion 1219 can be adjusted to accommodate the feed from a microstrip, coax, stripline, parallel plate, a waveguide of various cross sections, twin lead, wire above a groundplane, and/or other transmission line structures in the telecommunications and microwave industries. In FIG. 17B, upright portion 1225 can be used for all portions of the desired frequency band of operation to support the radio frequency radiation. In some examples, the upright portion 1225 has a greater width than height. For example, the upright portion 1225 can have a width to height ratio of 2:1 or greater and may be a compact radiating structure when compared to other implementations of three-dimensional inverted F antennas. Such a compact radiating structure can provide numerous advantages, including reducing the overall height of an antenna assembly incorporating the multi-band radiator portion 1200, as the height of the multi-band radiator portions can be a limiting factor in terms of total assembly height. Reduced height can be desirable for visual appearance, operations in high wind loads, etc. Additionally, the compact multi-band radiator portion 1200 can provide an advantage when the internal volume of the associated antenna assembly is reduced due to the associated internal modem. In one example, when an internal modem 210 used in the antenna assembly 200 has a large height, the top internal volume of the antenna assembly 200 may be reduced, which can make the multi-band radiator portion 1200 a desirable option. The upright portion 1225 may include one or more mounting features. The one or more mounting features can be configured to allow the upright portion 1225 to be coupled to the desired ground plane. The upright portion 1225 may include a slot 1231 that can be configured to receive the grounding portion 1300. Upright portion 1225 also supports mounting features 1217a for support portion 1202. As shown in FIGS. 17B and 17C, the multi-band radiating element 1201 can include two arms 1227. The arms can include main arm portions 1235 and connecting portions 1233. The connecting portions 1233 provide coupling between upright portion 1225 and main arm portions 1235 to assist in radiation in the 1 GHz to 8 GHz frequency band. As shown in at least FIG. 17C, main arm portions 1235 can have a significantly shorter length and can be positioned closer to the groundplane than the other antennas. For example, the arms 1227 can have a shorter length than arms 127 of the radiating element 101 and/or a shorter length than the arms 127′ of the radiating element 101′. Additionally, the second low-band radiation portion 1229 of the multi-band radiating element 1201 can be significantly longer in the length and closer to the groundplane than the other antennas. For example, compared to the second low band radiation portion 129 of the radiating element 101 and/or the second low-band radiation portion 129′ of the radiating element 101′. Grounding portion 1300 is thinner, rotated in orientation, and further away from the groundplane than the ground connection in other antennas (e.g., the ground connection 103 of FIG. 5B, the ground connection 103′ of FIG. 8B, etc.). These arrangements can contribute to accomplishing the change in predominate radiation direction. This change in the ratio of lengths between the high band and low band portions impacts the higher order mode radiation from the portions of the three-dimensional radiating element 1200 and allows for the dramatic change in the direction of predominate radio frequency radiation. In this manner, when one or more multi-band radiator portions 1200 are incorporated into the antenna assembly 300 (e.g., mounted to the base 302), the antenna assembly 300 may be configured to produce a radiation pattern perpendicular to the base 302. In some examples, such an implementation of the antenna assembly 300 may produce a radiation pattern that is either omni-directional or directional when the antenna assembly 300 is configured in accordance with a desired radiation performance criterion based on the geometry considerations of the multi-band radiating element 1201 and ground connection 1300. As shown in FIG. 17D, the second low-band radiation portion 1229 includes two openings 1259 for receiving the aforementioned connectors and clearance features 1257a.

Referring now to FIGS. 17F and 17G, side views of the ground connection 1300 are shown. In this implementation, the grounding portion 1300 is a PCB 1320 with electrically conducting surfaces 1340 on both sides. For example, the first side shown in FIG. 17F includes conducting surface 1340A and the second side shown in FIG. 17G includes conducting surface 1340B (collectively referred to as conducting surfaces 1340). In other implementations, only one side of the PCB 1320 might have an electrically conducting surface 1340 or the PCB 1320 could be a multi-layer PCB with three or more conducting surfaces 1340, or conducting surface 1340 could be a sheetmetal portion that may or may not be supported by a non-conducting portion. For example, depending on the particular ground plane, it may be desirable for the ground connection 1300 to be constructed wholly of sheet metal, similar to the ground connection 103 of FIG. 5B or the ground connection 103′ of FIG. 8B. In this implementation, several plated through holes 1380 are present to electrically connect the two conducting surfaces 1340A, 1340B of the ground portion 1300. The ground connection 1300 can also include coupling points 1301 and 1302 that can be used to establish electrical connection between ground portion 1300 and the associated ground plane (e.g., the base 302). In some implementations, the coupling points 1301, 1302 may extend through the associated groundplane (e.g., the base 302 or other groundplane of the antenna assembly 300) and an electrical connection may be established between one or both sides of the ground plane and the coupling points 1301, 1302. The ground connection 1300 can include a coupling point 1303 that establishes an electrical connection between ground portion 1300 and multi-band radiating element 1201 (e.g., coupling point 1303 can be received within slot 1231 of the multi-band radiating element 1201). In some examples, the coupling points 1301 and 1302 and/or the coupling point 1303 may be of a size and shape to pass buss wire through. In this manner, the buss wire may pass through one or more of the coupling points 1301, 1302, 1303 to provide electrical connection and/or structural support.

The width, length and height of conductive surfaces 1340 are selected to provide an impedance match and also assist with the radiation characteristics of the fundamental resonance as well as the higher order modes for the radiating element multi-band radiating element 1201 and the characteristic impedance of the radio frequency transmission lines that connect the radio that is part of the 5G wireless communication link to the multi-element multi-band antenna including the multi-band radiator portion 1200 (e.g., the multi-band multi-element antenna 301) as well as the individual radiation elements. In some implementations, the width of the conductive surfaces 1340 may include a first width and a second width. The first width may be positioned along a length portion of the conductive surfaces 1340. The second width may be positioned along the height portion of the conductive surfaces 1340. Each of the first width and the second width may be between about 0.0 centimeters (cm) and about 10.0 cm. The first width and the second width each may be equal to or smaller than about 10 cm. In some implementations, the first width and the second width may be between approximately 0.0 cm and approximately 10.0 cm, for example, between approximately 0.5 cm and approximately 9.5 cm, between approximately 1.0 cm and approximately 9.0 cm, between approximately 1.5 cm and approximately 8.5 cm, between approximately 2.0 cm and approximately 8.0 cm, between approximately 2.5 cm and approximately 7.5 cm, between approximately 3.0 cm and approximately 7.0 cm, between approximately 3.5 cm and approximately 6.5 cm, between approximately 4.0 cm and approximately 6.0 cm, between approximately 4.5 cm and approximately 5.5 cm, between approximately 5.0 cm and approximately 5.0 cm, or any value or range between any of these values or ranges or any value or range bounded by any combination of these values, although values or ranges outside these values or ranges can be used in some cases. In some examples, the first width may be a different value than the second width. For example, the first width may be wider than the second width.

A ratio of the first width to the second width (or of the second width to the first width) can be between approximately 1 and approximately 5, for example, between approximately 1.5 and approximately 4.5, between approximately 2 and approximately 4, between approximately 2.5 and approximately 3.5, between approximately 2 and approximately 2.5, or between approximately 3.5 and approximately 4, or any value or range between any of these values or ranges or any value or range bounded by any combination of these values, although values or ranges outside these values or ranges can be used in some cases.

In some implementations, the height and the length of the conductive surfaces 1340 may be between about 0.0 cm and about 10.0 cm. The height and the length may be equal to or smaller than about 10 cm. In some implementations, the height and the length of the conductive surfaces 1340 may be between approximately 0.0 cm and approximately 10.0 cm, for example, between approximately 0.5 cm and approximately 9.5 cm, between approximately 1.0 cm and approximately 9.0 cm, between approximately 1.5 cm and approximately 8.5 cm, between approximately 2.0 cm and approximately 8.0 cm, between approximately 2.5 cm and approximately 7.5 cm, between approximately 3.0 cm and approximately 7.0 cm, between approximately 3.5 cm and approximately 6.5 cm, between approximately 4.0 cm and approximately 6.0 cm, between approximately 4.5 cm and approximately 5.5 cm, between approximately 5.0 cm and approximately 5.0 cm, or any value or range between any of these values or ranges or any value or range bounded by any combination of these values, although values or ranges outside these values or ranges can be used in some cases. In some examples, the length and the height of the conductive surfaces 1340 may be different values. For example, the height may be greater than the length.

A ratio of the height to the length (or of the length to the height) of the conductive surfaces 1340 can be between approximately 1 and approximately 5, for example, between approximately 1.5 and approximately 4.5, between approximately 2 and approximately 4, between approximately 2.5 and approximately 3.5, between approximately 2 and approximately 2.5, or between approximately 3.5 and approximately 4, or any value or range between any of these values or ranges or any value or range bounded by any combination of these values, although values or ranges outside these values or ranges can be used in some cases.

In some instances, the plated through holes 1380 may be configured to equalize electrical potential across both sides of the ground connection 1300. For example, the grounding portion 1300 may include conductive material on both sides (e.g., conducting surface 1340A on the first side shown in FIG. 17F and conducting surface 1340B on the second side shown in FIG. 17G). In this manner, the conductive material forming the conducting surfaces 1340 may direct a current. When the current flows along the conductive material of the conducting surfaces 1340 of the ground connection 1300, there may be potential difference between both sides of the ground connection 1300. The plated through holes 1380 may allow for the current to pass through for any potential difference to equalize.

In some implementations, when multiple multi-band radiator portions 1200 are included in the antenna assembly 300, one or more of multi-band radiator portions 1200 can be arrayed together. In such a configuration, fewer RF ports may be required, and this allows for the possibility of a higher antenna gain for the remaining ports. For example, if the eight multi-band radiator portions 1200 were included in the antenna assembly 300 and are arrayed in pairs, the antenna assembly 300 can include four RF ports instead of eight for the multi-band radiator portions 1200. Such a configuration can also result in enhanced performance in a desired direction.

FIG. 16 illustrates a perspective view of a stacked patch antenna 1100 on a ground plane 1130 that can be included in any antenna assembly described herein, in accordance with some aspects of this disclosure. For example, stacked patch antenna 1100 can form part of any of the multi-band multi-element antennas described herein (e.g., the multi-band multi-element antenna 201 of the antenna assembly 200, the multi-band multi-element antenna 201′ of the antenna assembly 200′, the multi-band multi-element antenna 201A of the antenna assembly 200A, the multi-band multi-element antenna 301 of the antenna assembly 300, etc.). In other examples, the stacked patch antenna 1100 may be incorporated into an antenna assembly described herein but may operate separately from the corresponding multi-band multi-element antenna 301. In FIG. 16, particular reference is made to various components of the antenna assembly 300 and how those components interact with the stacked patch antenna 1100. However, it is recognized that one or more stacked patch antenna 1100 may be integrated into any of the antenna assemblies 200, 200′, 200A, and/or 300. Additional disclosure regarding antenna systems and assemblies including the stacked patch antenna 1100 of FIGS. 17A-17G is further described in U.S. Provisional Application No. 63/638,330, filed Apr. 24, 2024, entitled “Antenna Systems,” and U.S. Provisional Application No. 63/676,268, filed Jul. 26, 2024, entitled “Antenna Systems.” The entire contents of both are hereby incorporated by reference herein in their entireties. The disclosure and Figures in U.S. Provisional Application No. 63/638,330 and is U.S. Provisional Application No. 63/676,268 can be used in connection with the disclosure and Figures described and shown herein.

With continued reference to FIG. 16, the stacked patch antenna 1100 can be formed on and/or supported by the ground plane 1130. Including the stacked patch antenna 1100 in an antenna assembly, such as the antenna assembly 300 can provide certain advantages. For example, the stacked patch antenna 1100 may enhance the performance of the antenna assembly 300 in terms of beamwidth, gain, spatial filtering, and/or efficiency. The stacked patch antenna 1100 can be configured as a highly directional antenna. Which can provide the advantages related to either vertical or horizontal orientation of the antenna assembly 300 described herein, depending on the desired application.

The stacked patch antenna 1100 can include a first or top patch element 1102 and a second or bottom patch element 1104. The patch elements 1102, 1104 may also be referred to herein as “patch antenna radiators”, “patch antenna elements”, and/or “patch radiating elements”. Including a stacked patch antenna 1100 in the antenna assembly 300 can provide more impedance bandwidth than a single layer patch antenna of comparable thickness.

The top patch element 1102 and the bottom patch element 1104 can each be considered an electrically conductive structure. In some implementations, the top patch element 1102 and the bottom patch element 1104 can comprise sheet metal, PCBs with an electrically conductive coating, and/or the like. The top patch element 1102 can be positioned above the ground plane 1130 with the bottom patch element 1104 positioned therebetween in the orientation of the stacked patch antenna 1100 relative to the ground plane 1130 shown in FIG. 16. A first gap or physical space can be maintained between the top patch element 1102 and the bottom patch element 1104 and a second gap can be maintained between the bottom patch element 1104 and the ground plane 1130. The stacked patch antenna 1100 can include one or more support posts 1108 that extend between the ground plane 1130 and the bottom patch element 1104 and/or between the bottom patch element 1104 and the top patch element 1102. The support posts 1108 can be configured to support the top patch element 1102 and the bottom patch element 1104 and maintain the first and second gaps. The support posts 1108 can extend through the bottom patch element 1104 in some configurations. The support posts 1108 can be non-conductive. For example, the support posts 1108 are configured such that there is not a conductive path between the ground plane 1130 and either to the top patch element 1102 or the bottom patch element 1104 or between the top patch element 1102 and the bottom patch element 1104.

In some implementations, the stacked patch antenna 1100 can include a conductive post 1112. The conductive post 1112 can provide mechanical support for the top patch element 1102 and/or the bottom patch element 1104. The conductive post 1112 can also be electrically connected to the ground plane 1130 and the patch elements 1102, 1104. The gain and bandwidth performance of the stacked patch antenna 1100 will not change in a significant fashion if post 1112 is constructed of non-conductive material.

In the illustrated configuration, the bottom patch element 1104 includes a matching circuit 1106. The matching circuit 1106 can allow for a transmission line 1114 (e.g., a 50-ohm microstrip transmission line) to be matched to the input impedance of the stacked patch antenna 1100. The matching circuit 1106 can be T-shaped. The matching circuit 1106 can extend from the bottom patch element 1104. While a majority of the bottom patch element 1104 may be positioned directly below the top patch element 1102, the matching circuit 1106 may extend outwardly from the bottom patch element 1104 such that the matching circuit 1106 is not positioned directly below the top patch element 1102. The matching circuit 1106 can be mechanically supported by one or more support posts 1110. The one or more support posts 1110 can be configured in a similar manner as the support posts 1108 (e.g., to provide non-conductive mechanical support).

The matching circuit 1106 can be electrically connected to the transmission line 1114 via a feed post 1116. The feed post 1116 provides the electrical connection between the transmission line 1114 and the bottom patch element 1104. In some configurations, the feed post 1116 serves an additional function of providing mechanical support for the matching circuit 1106 in addition to or alternatively to the one or more support posts 1110. The transmission line 1114 can include a junction or attachment point 1118. The attachment point 1118 is where a coaxial cable could attach to the ground plane 1130 to connect the stacked patch antenna 1100 to a radio. The ground plane 1130 can include heat relief sections 1120 in the ground plane 1130 (e.g., in the PCB structure when formed as such) at the attachment point 1118. The transmission line 1114 can extend along the non-conductive side of the ground plane 1130 between the attachment point 1118 and the feed post 1116. In some configurations, the transmission line 1114 could include an impedance transformer or reactive matching components along the transmission line 1114.

In some implementations, any of antenna assemblies described herein can include one or more millimeter wave radios. For example, the one or more millimeter wave radios can form part of the associated multi-element multi-band antenna. FIGS. 18A-18D illustrate four example millimeter wave radios 250A, 250B, 250C, 250D respectively (collectively millimeter wave radios 250), any of which can be included in any antenna assembly described herein (e.g., the antenna assembly 300). While particular reference is made to the antenna assembly 300 and its components, it is recognized that the millimeter wave radios 250 of FIGS. 18A-18D can form part of any of the other antennas assemblies described herein. While four example millimeter wave radios 250 are provided, in other implementations, different or modified millimeter wave radios 250 can be included in the antenna assemblies described herein. The millimeter wave radios 250 can be included in addition to or alternatively to the other antennas included in the antenna assembly 300. The millimeter wave radios 250 can operated in the millimeter wave frequency spectrum (approximately between 30 GHz and 300 GHz), with wavelengths ranging from 1 to 10 millimeters approximately. The millimeter wave radios 250 can be used for high-frequency communication. Including one or more millimeter wave radios 250 can improve or support high data transfer rates of the antenna assembly 300 over short distances. For example, the millimeter wave radios 250 can be configured to transmit large amounts of data, which can be ideal for 5G network applications and high-speed wireless communication for the antenna assembly 300. In some implementations, the millimeter wave radios 250 can be mounted to the base 302. When one or more of the stacked patch antennas 1100 and/or the multi-band radiator portion 1200 are included in the antenna assembly 300, it may be desirable to include one or more millimeter wave radios 250 as well.

FIG. 18A illustrates a first example of a millimeter wave radio 250A that can be included in the antenna assembly 300. The millimeter wave radio 250A can be a slotted waveguide array millimeter wave radio. The millimeter wave radio 250A can include a millimeter wave radio 252A and one or more waveguides 254A. In the illustrated example, three waveguides 254A are included. The waveguides 254A can be hollow metallic structures that direct electromagnetic waves. Each waveguide 254A can include slots 256A cut into its surface to allow for controlled radiation. For case of illustration, not all slots 256A in FIG. 18A are labeled. The waveguides 254A can serve as a conduit for the millimeter-wave signals, efficiently transmitting them along its length with minimal loss. The slots 256A can act as the radiating elements for the millimeter wave radio 250A, emitting the millimeter wave signals. The position and size of the slots 256A can be selected to achieve a highly directional beam. In some implementations, the waveguides 254A can be configured to create an array of slots 256A. Such an array can be used to form a high-gain, highly directional antenna, which can be ideal for focusing energy in a specific direction or scanned along a portion of the horizon, which may be desirable in some applications, as described herein.

FIG. 18B illustrates a second example of a millimeter wave radio 250B that can be included in the antenna assembly 300. The millimeter wave radio 250B can be a dipole array millimeter wave radio. The millimeter wave radio 250B can include a millimeter wave radio 252B, a microwave grade PCB portion 254B, and a plurality of dipole antennas 256B. The dipole antennas 256B can be arranged in an array on the PCB portion 254B. The PCB portion 254B can include a ground plane (not shown) on its back side (e.g., the side closest to the millimeter wave radio 252B). For ease of illustration, not all of the dipole antennas 256B in FIG. 18B are labeled. The dipole antennas 256B can be substantially smaller compared to other antennas of the antenna assembly 300 because of the short wavelength of the millimeter wave radio 250B. Arranging the dipole antennas 256B in an array can enhance the gain, directivity, and/or beamforming capabilities of the millimeter wave radio 250B. The phase and amplitude of signals fed to each dipole antenna 256B can be selected to focus the energy in a specific direction. For example, highly directional and scannable radiation patterns can be generated by the millimeter wave radio 250B, which can be desirable in some applications, as described herein.

FIG. 18C illustrates a third example of a millimeter wave radio 250C that can be included in the antenna assembly 300. The millimeter wave radio 250C can be a microstrip patch array millimeter wave radio. The millimeter wave radio 250C can include a millimeter wave radio 252C, a microwave grade PCB portion 254C, and a plurality of microstrip patch antennas 256C. The microstrip patch antennas 256C can be flat rectangular antennas comprising a conductive material (e.g., a metal). The microstrip patch antennas 256C can be arranged in an array on the PCB portion 254C. The PCB portion 254C can include a ground plane (not shown) on its back side (e.g., the side closest to the millimeter wave radio 252C). For ease of illustration, not all of the microstrip patch antennas 256C in FIG. 18C are labeled. The microstrip patch antennas 256C can be substantially smaller compared to other antennas of the antenna assembly 300 because of the short wavelength of the millimeter wave radio 250C. Arranging the microstrip patch antennas 256C in an array can enhance the gain, directivity, and/or beamforming capabilities of the millimeter wave radio 250C. The feed network of the microstrip patch antenna array can be controlled to allow for precise beamforming and higher directional accuracy, which can be desirable in some applications, as described herein. Alternatively, elements can be individually fed as opposed to serially fed to form a highly scannable array in both azimuth and elevation.

FIG. 18D illustrates a fourth example of a millimeter wave radio 250D that can be included in the antenna assembly 300. The millimeter wave radio 250D can be a coplanar waveguide feed cylindrical dielectric resonator array millimeter wave radio. The millimeter wave radio 250D can include a millimeter wave radio 252D, a microwave grade PCB portion 254D, a plurality of dielectric resonator antennas 256D, and a ground plane 258D. The dielectric resonator antennas 256D can be constructed of a non-metallic material (e.g., dielectrics) and can be the radiating elements of the millimeter wave radio 250D. The dielectric resonator antennas 256D can be cylindrically shaped, which can help confine and radiate electromagnetic energy effectively at millimeter-wave frequencies. The dielectric resonator antennas 256D can be arranged in an array on the PCB portion 254D. For case of illustration, not all of the dielectric resonator antennas 256D in FIG. 18D are labeled. The dielectric resonator antennas 256D can be substantially smaller compared to other antennas of the antenna assembly 300 because of the short wavelength of the millimeter wave radio 250D. Arranging the dielectric resonator antennas 256D in an array can enhance the gain, directivity, and/or beamforming capabilities of the millimeter wave radio 250D, which can be desirable in some applications, as described herein.

The particular implementations disclosed above are illustrative only, as the application may be modified and practiced in different but equivalent manners apparent to those skilled in the art having the benefit of the teachings herein. It is therefore evident that the particular implementations disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

### EXAMPLE CLAUSES

Various examples of systems relating to an antenna system are found in the following clauses:

Clause 1. An antenna assembly comprising: a base portion; a cover, the cover configured to be removably coupled to the base portion; a modem coupled to the base portion; a ground plane; one or more multi-band radiator portions coupled to the ground plane; and one or more dual-band WiFi radiator portions coupled to the ground plane.

Clause 2. The antenna assembly of Clause 1, wherein the ground plane is suspended above the modem, wherein the ground plane acts as a dividing wall between a top internal volume between the ground plane and the cover, and a bottom internal volume between the ground plane and the base portion.

Clause 3. The antenna assembly of Clause 1 or Clause 2, wherein the cover include one or more vents, wherein the one or more vents are configured to promote heat exchange between internal components of the antenna assembly and a surrounding environment.

Clause 4. The antenna assembly of any of Clauses 1-3, wherein the ground plane is configured to act as a heat sink for the modem.

Clause 5. The antenna assembly of any of Clauses 1-4, wherein each multi-band radiator portion of the one or more multi-band radiator portions comprises: a feeding portion; a grounding portion; an upright low band radiation portion; a second low band radiation portion; and a high band radiation portion.

Clause 6. The antenna assembly of Clause 5, wherein the second low band radiation portion is not-coplanar with the upright low band radiation portion.

Clause 7. The antenna assembly of Clause 5, wherein the second low band radiation portion is coplanar with the upright low band radiation portion.

Clause 8. The antenna assembly of any of Clauses 5-7, wherein the high band radiation portion comprises two primary arms coupled to a base of the upright low band radiation portion.

Clause 9. The antenna assembly of Clause 8, wherein each primary arm comprises a first arm portion and a second arm portion, wherein the first arm portion is coupled to the upright low band radiation portion and the second arm portion extends from the first arm portion.

Clause 10. The antenna assembly of Clause 9, wherein the first arm portion has a varying width along a length of the first arm portion.

Clause 11. The antenna assembly of Clause 9 or Clause 10, wherein the second arm portion has a consistent width along a length of the second arm portion.

Clause 12. The antenna assembly of any of Clauses 5-7, wherein the high band radiation portion comprises a single primary arm coupled to a base of the upright low band radiation portion.

Clause 13. The antenna assembly of any of Clauses 5-7, wherein the high band radiation portion comprises a plurality of primary arms coupled to a base of the upright low band radiation portion.

Clause 14. The antenna assembly of any of Clauses 5-7, wherein the high band radiation portion comprises a plurality of primary arms of different lengths coupled to a base of the upright low band radiation portion.

Clause 15. The antenna assembly of any of Clauses 5-14, wherein each multi-band radiator portion of the one or more multi-band radiator portions further comprises: a third low band radiation portion coupled to the second low band radiation portion; and a fourth low band radiation portion coupled to the second low band radiation portion and not contacting the third low band radiation portion.

Clause 16. The antenna assembly of Clause 15, wherein the third low band radiation portion has a first dimension, wherein the fourth low band radiation portion has a second dimension, and wherein the first dimension and the second dimension are substantially the same.

Clause 17. The antenna assembly of Clause 15, wherein the third low band radiation portion has a first dimension, wherein the fourth low band radiation portion has a second dimension, and wherein the first dimension and the second dimension are different.

Clause 18. The antenna assembly of any of Clauses 5-17, wherein the high band radiation portion further comprises one or more secondary arms coupled to the upright low band radiation portion.

Clause 19. The antenna assembly of Clause 18, wherein the one or more secondary arms are coplanar to the upright low band radiation portion.

Clause 20. The antenna assembly of Clause 18, wherein the one or more secondary arms are not coplanar to the upright low band radiation portion.

Clause 21. The antenna assembly of any of Clauses 18-20, wherein the one or more secondary arms comprise two secondary arms.

Clause 22. The antenna assembly of any of Clauses 1-21, wherein the one or more multi-band radiator portions comprises two multi-band radiator portions.

Clause 23. The antenna assembly of any of Clauses 1-22, wherein the one or more dual-band WiFi radiator portions comprises two dual-band WiFi radiator portions.

Clause 24. The antenna assembly of any of Clauses 1-23, further comprising a GPS radiator portion coupled to the ground plane.

Clause 25. An antenna system comprising: a conductive sheet having a body portion with a front face, a head portion, a first left arm, and a first right arm; wherein the head portion angularly extends from the body portion; wherein the first left arm angularly extends from the body portion and the first right arm angularly extends from the body portion; wherein the front face is configured as a first resonating component, the head portion is configured as a second resonating component, the first left arm is configured as a third resonating component, and the first right arm is configured a fourth resonating component; and wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHZ and 6.0 GHz during use.

Clause 26. The antenna system of Clause 25, further comprising a second left arm that extends from the body portion and a second right arm that extends from the body portion.

Clause 27. The antenna system of Clause 26, wherein the second left arm and the second right arm are coplanar to the front face.

Clause 28. The antenna system of any of Clauses 25-27, wherein the body portion further comprises one or more slots configured to receive projections of an antenna connection.

Clause 29. The antenna system of any of Clause 25-28, wherein the conductive sheet has a thickness at or within 0.01 to 0.03 inches.

Clause 30. The antenna system of any of Clauses 25-29, wherein the head portion is configured to angularly extend from the body portion at an angle at or within 89-91 degrees.

Clause 31. The antenna system of any of Clauses 25-30, wherein the first left arm angularly extends from a left side of the body portion at an angle at or within 79-81 degrees.

Clause 32. The antenna system of any of Clauses 25-31, wherein the first right arm angularly extends from a left side of the body portion at an angle at or within 79-81 degrees.

Clause 33. The antenna system of any of Clauses 25-32, wherein at least one of the respective first and second resonating components is configured to resonate within a low frequency band of between 600 MHz and 700 MHz during use.

Clause 34. The antenna system of any of Clauses 25-33, wherein at least one of the respective third and fourth resonating components is configured to resonate within a high frequency band of between 2.7 GHz and 6.0 GHz during use.

Clause 35. The antenna system of any of Clauses 25-34, further comprising a ground aperture located along a symmetry line of the body portion and configured to be electrically coupled to a ground reference.

Clause 36. The antenna system of any of Clauses 25-35, further comprising a first set of apertures on the head portion and located proximate to an upper edge of the body portion.

Clause 37. The antenna system of any of Clauses 25-36, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 38. The antenna system of Clause 37, wherein the first right arm portion has a varying width along a length of the first right arm portion and the first left arm portion has a varying width along a length of the first left arm portion.

Clause 39. The antenna system of Clause 37 or Clause 38, wherein the second left arm portion has a consistent width along a length of the second left arm portion and the second right arm portion has a consistent width along a length of the second right arm portion.

Clause 40. An antenna assembly comprising: a base portion; a cover, the cover configured to be removably coupled to the base portion; a modem positioned on or above the base portion; a ground plane; and a multi-band antenna.

Clause 41. The antenna assembly of Clause 40, wherein the ground plane is coupled to the cover between a top side of the cover and the base portion, wherein the ground plane acts as a dividing wall between a top internal volume between the ground plane and the cover, and a bottom internal volume between the ground plane and the base portion.

Clause 42. The antenna assembly of Clause 40 or Clause 41, wherein the cover include one or more vents, wherein the one or more vents are configured to promote heat exchange between internal components of the antenna assembly and a surrounding environment.

Clause 43. The antenna assembly of Clause 41 or Clause 42, wherein the modem is positioned within the bottom internal volume and the multi-band antenna is positioned within the top internal volume.

Clause 44. The antenna assembly of any of Clauses 40-43, wherein the ground plane is configured to act as a heat sink for the modem.

Clause 45. The antenna assembly of any of Clauses 40-44, wherein the multi-band antenna includes one or more multi-band radiating elements.

Clause 46. The antenna assembly of Clause 45, wherein each multi-band radiating element of the one or more multi-band radiating elements comprises: a feeding portion; a grounding portion; an upright low band radiation portion; a second low band radiation portion; and a high band radiation portion.

Clause 47. The antenna assembly of Clause 46, wherein the second low band radiation portion is not-coplanar with the upright low band radiation portion.

Clause 48. The antenna assembly of Clause 46, wherein the second low band radiation portion is coplanar with the upright low band radiation portion.

Clause 49. The antenna assembly of any of Clauses 46-48, wherein the high band radiation portion comprises two primary arms coupled to a base of the upright low band radiation portion.

Clause 50. The antenna assembly of Clause 49, wherein each primary arm comprises a first arm portion and a second arm portion, wherein the first arm portion is coupled to the upright low band radiation portion and the second arm portion extends from the first arm portion.

Clause 51. The antenna assembly of Clause 50, wherein the first arm portion has a varying width along a length of the first arm portion.

Clause 52. The antenna assembly of Clause 50 or Clause 51, wherein the second arm portion has a consistent width along a length of the second arm portion.

Clause 53. The antenna assembly of any of Clauses 46-48, wherein the high band radiation portion comprises a single primary arm coupled to a base of the upright low band radiation portion.

Clause 54. The antenna assembly of any of Clauses 46-48, wherein the high band radiation portion comprises a plurality of primary arms coupled to a base of the upright low band radiation portion.

Clause 55. The antenna assembly of any of Clauses 46-48, wherein the high band radiation portion comprises a plurality of primary arms of different lengths coupled to a base of the upright low band radiation portion.

Clause 56. The antenna assembly of any of Clauses 46-55, wherein each multi-band radiating element further comprises: a third low band radiation portion coupled to the second low band radiation portion; and a fourth low band radiation portion coupled to the second low band radiation portion and not contacting the third low band radiation portion.

Clause 57. The antenna assembly of Clause 56, wherein the third low band radiation portion has a first dimension, wherein the fourth low band radiation portion has a second dimension, and wherein the first dimension and the second dimension are substantially the same.

Clause 58. The antenna assembly of Clause 56, wherein the third low band radiation portion has a first dimension, wherein the fourth low band radiation portion has a second dimension, and wherein the first dimension and the second dimension are different.

Clause 59. The antenna assembly of any of Clauses 46-58, wherein the high band radiation portion further comprises one or more secondary arms coupled to the upright low band radiation portion.

Clause 60. The antenna assembly of Clause 59, wherein the one or more secondary arms are coplanar to the upright low band radiation portion.

Clause 61. The antenna assembly of Clause 59, wherein the one or more secondary arms are not coplanar to the upright low band radiation portion.

Clause 62. The antenna assembly of any of Clauses 59-61, wherein the one or more secondary arms comprise two secondary arms.

Clause 63. The antenna assembly of any of Clauses 45-62, wherein the one or more multi-band radiating elements comprises two multi-band radiating elements.

Clause 64. The antenna assembly of any of Clauses 45-62, wherein the one or more multi-band radiating elements comprises four multi-band radiating elements.

Clause 65. The antenna assembly of any of Clauses 40-63, wherein the multi-band antenna further comprises one or more dual-band WiFi radiating elements.

Clause 66. The antenna assembly of any of Clauses 40-65, further comprising a GPS antenna coupled to the ground plane.

Clause 67. The antenna assembly of any of Clauses 41-66, wherein the ground plane is configured to be removably coupled to the cover in a first configuration and a second configuration, wherein in the first configuration, the ground plane is positioned closer to the base portion than in the second configuration.

Clause 68. The antenna assembly of Clause 67, wherein a ratio between the top internal volume and the bottom internal volume changes when the ground plane is moved from the first configuration to the second configuration.

Clause 69. An antenna assembly comprising: a base portion; a cover configured to be removably coupled to the base portion to define an internal volume, the cover comprising a support portion extending from a top side of the cover towards the base portion; a modem configured to be supported by the support portion; and a multi-band antenna housed within the internal volume.

Clause 70. The antenna assembly of Clause 69, wherein the base portion comprises a ground plane.

Clause 71. The antenna assembly of Clause 69, further comprising a ground plane supported by the base portion.

Clause 72. The antenna assembly of any of Clauses 69-71, further comprising a modem shell configured to house the modem, wherein the support portion supports the modem shell.

Clause 73. The antenna assembly of Clause 72, wherein the modem shell is configured to be removably coupled to the support portion.

Clause 74. The antenna assembly of Clause 72 or Clause 73, wherein the modem shell comprises: a top cover; and a bottom cover, the top cover configured to be removably coupled to the bottom cover with the modem therebetween; wherein the top cover and the bottom cover comprise a plurality of slots, the plurality of slots configured to allow portions of the modem to be exposed to an external environment.

Clause 75. The antenna assembly of Clause 74, wherein the modem shell further comprises one or more cutouts, the one or more cutouts configured to provide access to ports of the modem.

Clause 76. The antenna assembly of any of Clause 69-75, wherein the cover include one or more vents, wherein the one or more vents are configured to promote heat exchange between internal components of the antenna assembly and a surrounding environment.

Clause 77. The antenna assembly of any of Clause 69-76, wherein the support portion comprises a bottom portion configured to support the modem and one or more side walls, wherein at least one of the bottom portion and the one or more side walls includes a plurality of vents configured to promote heat exchange between the modem and the internal volume.

Clause 78. The antenna assembly of any of Clause 69-77, wherein the multi-band antenna includes one or more multi-band radiating elements.

Clause 79. The antenna assembly of Clause 78, wherein each multi-band radiating element of the one or more multi-band radiating elements comprises: a feeding portion; a grounding portion; an upright low band radiation portion; a second low band radiation portion; and a high band radiation portion.

Clause 80. The antenna assembly of Clause 78, wherein each multi-band radiating element of the one or more multi-band radiating elements comprises: a conductive sheet having a body portion with a front face, a head portion, a first left arm, and a first right arm; wherein the head portion angularly extends from the body portion; wherein the first left arm angularly extends from the body portion and the first right arm angularly extends from the body portion; and wherein the front face is configured as a first resonating component, the head portion is configured as a second resonating component, the first left arm is configured as a third resonating component, and the first right arm is configured a fourth resonating component.

Clause 81. The antenna assembly of Clause 80, wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHZ and 6.0 GHz during use.

Clause 82. The antenna assembly of Clause 80 or Clause 81, further comprising a second left arm that extends from the body portion and a second right arm that extends from the body portion.

Clause 83. The antenna assembly of Clause 82, wherein the second left arm and the second right arm are coplanar to the front face.

Clause 84. The antenna assembly of any of Clauses 80-83, wherein the body portion further comprises one or more slots configured to receive projections of an antenna connection.

Clause 85. The antenna assembly of any of Clauses 80-84, wherein the conductive sheet has a thickness at or within 0.01 to 0.03 inches.

Clause 86. The antenna assembly of any of Clauses 80-85, wherein the head portion is configured to angularly extend from the body portion at an angle at or within 89-91 degrees.

Clause 87. The antenna assembly of any of Clauses 80-86, wherein the first left arm angularly extends from a left side of the body portion at an angle at or within 79-81 degrees.

Clause 88. The antenna assembly of any of Clauses 80-87, wherein the first right arm angularly extends from a left side of the body portion at an angle at or within 79-81 degrees.

Clause 89. The antenna assembly of any of Clauses 80-88, wherein at least one of the respective first and second resonating components is configured to resonate within a low frequency band of between 600 MHz and 700 MHz during use.

Clause 90. The antenna assembly of any of Clauses 80-89, wherein at least one of the respective third and fourth resonating components is configured to resonate within a high frequency band of between 2.7 GHZ and 6.0 GHz during use.

Clause 91. The antenna assembly of any of Clauses 80-90, further comprising a ground aperture located along a symmetry line of the body portion and configured to be electrically coupled to a ground reference.

Clause 92. The antenna assembly of any of Clauses 80-91, further comprising a first set of apertures on the head portion and located proximate to an upper edge of the body portion.

Clause 93. The antenna assembly of any of Clauses 80-92, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 94. The antenna assembly of Clause 93, wherein the first right arm portion has a varying width along a length of the first right arm portion and the first left arm portion has a varying width along a length of the first left arm portion.

Clause 95. The antenna assembly of Clause 93 or Clause 94, wherein the second left arm portion has a consistent width along a length of the second left arm portion and the second right arm portion has a consistent width along a length of the second right arm portion.

Clause 96. The antenna assembly of any of Clauses 69-95, wherein one or more multi-band radiating elements comprises between one and four multi-band radiating elements.

Clause 97. The antenna assembly of any of Clauses 69-96, wherein the multi-band antenna further comprises at least one dual-band WiFi radiator portion.

Clause 98. An antenna assembly comprising: a base portion; a cover, the cover configured to be removably coupled to the base portion; a modem positioned on or above the base portion; a ground plane; and a multi-band antenna.

Clause 99. The antenna assembly of clause 98, wherein the ground plane is coupled to the cover between a top side of the cover and the base portion, wherein the ground plane acts as a dividing wall between a top internal volume between the ground plane and the cover, and a bottom internal volume between the ground plane and the base portion.

Clause 100. The antenna assembly of clause 98 or clause 99, wherein the cover include one or more vents, wherein the one or more vents are configured to promote heat exchange between internal components of the antenna assembly and a surrounding environment.

Clause 101. The antenna assembly of clause 99 or clause 100, wherein the modem is positioned within the bottom internal volume and the multi-band antenna is positioned within the top internal volume.

Clause 102. The antenna assembly of any of clauses 98-101, wherein the ground plane is configured to act as a heat sink for the modem.

Clause 103. The antenna assembly of any of clauses 98-102, wherein the multi-band antenna includes one or more multi-band radiating elements.

Clause 104. The antenna assembly of clause 103, wherein each multi-band radiating element of the one or more multi-band radiating elements comprises: a feeding portion; a grounding portion; an upright low band radiation portion; a second low band radiation portion; and a high band radiation portion.

Clause 105. The antenna assembly of clause 104, wherein the second low band radiation portion is not-coplanar with the upright low band radiation portion.

Clause 106. The antenna assembly of clause 104, wherein the second low band radiation portion is coplanar with the upright low band radiation portion.

Clause 107. The antenna assembly of any of clauses 104-106, wherein the high band radiation portion comprises two primary arms coupled to a base of the upright low band radiation portion.

Clause 108. The antenna assembly of clause 107, wherein each primary arm comprises a first arm portion and a second arm portion, wherein the first arm portion is coupled to the upright low band radiation portion and the second arm portion extends from the first arm portion.

Clause 109. The antenna assembly of clause 108, wherein the first arm portion has a varying width along a length of the first arm portion.

Clause 110. The antenna assembly of clause 108 or clause 109, wherein the second arm portion has a consistent width along a length of the second arm portion.

Clause 111. The antenna assembly of any of clauses 104-106, wherein the high band radiation portion comprises a single primary arm coupled to a base of the upright low band radiation portion.

Clause 112. The antenna assembly of any of clauses 104-106, wherein the high band radiation portion comprises a plurality of primary arms coupled to a base of the upright low band radiation portion.

Clause 113. The antenna assembly of any of clauses 104-106, wherein the high band radiation portion comprises a plurality of primary arms of different lengths coupled to a base of the upright low band radiation portion.

Clause 114. The antenna assembly of any of clauses 104-113, wherein each multi-band radiating element further comprises: a third low band radiation portion coupled to the second low band radiation portion; and a fourth low band radiation portion coupled to the second low band radiation portion and not contacting the third low band radiation portion.

Clause 115. The antenna assembly of clause 114, wherein the third low band radiation portion has a first dimension, wherein the fourth low band radiation portion has a second dimension, and wherein the first dimension and the second dimension are substantially the same.

Clause 116. The antenna assembly of clause 114, wherein the third low band radiation portion has a first dimension, wherein the fourth low band radiation portion has a second dimension, and wherein the first dimension and the second dimension are different.

Clause 117. The antenna assembly of any of clauses 104-116, wherein the high band radiation portion further comprises one or more secondary arms coupled to the upright low band radiation portion.

Clause 118. The antenna assembly of clause 117, wherein the one or more secondary arms are coplanar to the upright low band radiation portion.

Clause 119. The antenna assembly of clause 117, wherein the one or more secondary arms are not coplanar to the upright low band radiation portion.

Clause 120. The antenna assembly of any of clauses 117-119, wherein the one or more secondary arms comprise two secondary arms.

Clause 121. The antenna assembly of any of clauses 103-120, wherein the one or more multi-band radiating elements comprises two multi-band radiating elements.

Clause 122. The antenna assembly of any of clauses 103-120, wherein the one or more multi-band radiating elements comprises four multi-band radiating elements.

Clause 123. The antenna assembly of any of clauses 98-121, wherein the multi-band antenna further comprises one or more dual-band WiFi radiating elements.

Clause 124. The antenna assembly of any of clauses 98-123, further comprising a GPS antenna coupled to the ground plane.

Clause 125. The antenna assembly of any of clauses 99-124, wherein the ground plane is configured to be removably coupled to the cover in a first configuration and a second configuration, wherein in the first configuration, the ground plane is positioned closer to the base portion than in the second configuration.

Clause 126. The antenna assembly of clause 125, wherein a ratio between the top internal volume and the bottom internal volume changes when the ground plane is moved from the first configuration to the second configuration.

Clause 127. An antenna system comprising: a conductive sheet having a body portion with a front face, a head portion, a first left arm, and a first right arm; wherein the head portion angularly extends from the body portion; wherein the first left arm angularly extends from the body portion and the first right arm angularly extends from the body portion; wherein the front face is configured as a first resonating component, the head portion is configured as a second resonating component, the first left arm is configured as a third resonating component, and the first right arm is configured a fourth resonating component; and wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHZ and 6.0 GHz during use.

Clause 128. The antenna system of clause 127, further comprising a second left arm that extends from the body portion and a second right arm that extends from the body portion.

Clause 129. The antenna system of clause 128, wherein the second left arm and the second right arm are coplanar to the front face.

Clause 130. The antenna system of any of clauses 127-129, wherein the body portion further comprises one or more slots configured to receive projections of an antenna connection.

Clause 131. The antenna system of any of clause 127-130, wherein the conductive sheet has a thickness at or within 0.01 to 0.03 inches.

Clause 132. The antenna system of any of clauses 127-131, wherein the head portion is configured to angularly extend from the body portion at an angle at or within 89-91 degrees.

Clause 133. The antenna system of any of clauses 127-132, wherein the first left arm angularly extends from a left side of the body portion at an angle at or within 79-81 degrees.

Clause 134. The antenna system of any of clauses 127-133, wherein the first right arm angularly extends from a left side of the body portion at an angle at or within 79-81 degrees.

Clause 135. The antenna system of any of clauses 127-134, wherein at least one of the respective first and second resonating components is configured to resonate within a low frequency band of between 600 MHz and 700 MHz during use.

Clause 136. The antenna system of any of clauses 127-135, wherein at least one of the respective third and fourth resonating components is configured to resonate within a high frequency band of between 2.7 GHZ and 6.0 GHz during use.

Clause 137. The antenna system of any of clauses 127-136, further comprising a ground aperture located along a symmetry line of the body portion and configured to be electrically coupled to a ground reference.

Clause 138. The antenna system of any of clauses 127-137, further comprising a first set of apertures on the head portion and located proximate to an upper edge of the body portion.

Clause 139. The antenna system of any of clauses 127-138, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 140. The antenna system of clause 139, wherein the first right arm portion has a varying width along a length of the first right arm portion and the first left arm portion has a varying width along a length of the first left arm portion.

Clause 141. The antenna system of clause 139 or clause 140, wherein the second left arm portion has a consistent width along a length of the second left arm portion and the second right arm portion has a consistent width along a length of the second right arm portion.

Clause 142. An antenna assembly, comprising: a base portion; a cover configured to be removably coupled to the base portion to define an internal volume, the cover comprising a support portion extending from a top side of the cover towards the base portion; a modem configured to be supported by the support portion; and a multi-band antenna housed within the internal volume.

Clause 143. The antenna assembly of clause 142, wherein the base portion comprises a ground plane.

Clause 144. The antenna assembly of clause 142, further comprising a ground plane supported by the base portion.

Clause 145. The antenna assembly of any of clauses 142-144, further comprising a modem shell configured to house the modem, wherein the support portion supports the modem shell.

Clause 146. The antenna assembly of clause 145, wherein the modem shell is configured to be removably coupled to the support portion.

Clause 147. The antenna assembly of clause 145 or clause 146, wherein the modem shell comprises: a top cover; and a bottom cover, the top cover configured to be removably coupled to the bottom cover with the modem therebetween; wherein the top cover and the bottom cover comprise a plurality of slots, the plurality of slots configured to allow portions of the modem to be exposed to an external environment.

Clause 148. The antenna assembly of clause 147, wherein the modem shell further comprises one or more cutouts, the one or more cutouts configured to provide access to ports of the modem.

Clause 149. The antenna assembly of any of clause 142-148, wherein the cover include one or more vents, wherein the one or more vents are configured to promote heat exchange between internal components of the antenna assembly and a surrounding environment.

Clause 150. The antenna assembly of any of clause 142-149, wherein the support portion comprises a bottom portion configured to support the modem and one or more side walls, wherein at least one of the bottom portion and the one or more side walls includes a plurality of vents configured to promote heat exchange between the modem and the internal volume.

Clause 151. The antenna assembly of any of clause 142-150, wherein the multi-band antenna includes one or more multi-band radiating elements.

Clause 152. The antenna assembly of clause 151, wherein each multi-band radiating element of the one or more multi-band radiating elements comprises: a feeding portion; a grounding portion; an upright low band radiation portion; a second low band radiation portion; and a high band radiation portion.

Clause 153. The antenna assembly of clause 151, wherein each multi-band radiating element of the one or more multi-band radiating elements comprises: a conductive sheet having a body portion with a front face, a head portion, a first left arm, and a first right arm; wherein the head portion angularly extends from the body portion; wherein the first left arm angularly extends from the body portion and the first right arm angularly extends from the body portion; and wherein the front face is configured as a first resonating component, the head portion is configured as a second resonating component, the first left arm is configured as a third resonating component, and the first right arm is configured a fourth resonating component.

Clause 154. The antenna assembly of clause 153, wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHZ and 6.0 GHz during use.

Clause 155. The antenna assembly of clause 153 or clause 154, further comprising a second left arm that extends from the body portion and a second right arm that extends from the body portion.

Clause 156. The antenna assembly of clause 155, wherein the second left arm and the second right arm are coplanar to the front face.

Clause 157. The antenna assembly of any of clauses 153-156, wherein the body portion further comprises one or more slots configured to receive projections of an antenna connection.

Clause 158. The antenna assembly of any of clauses 153-157, wherein the conductive sheet has a thickness at or within 0.01 to 0.03 inches.

Clause 159. The antenna assembly of any of clauses 153-158, wherein the head portion is configured to angularly extend from the body portion at an angle at or within 89-91 degrees.

Clause 160. The antenna assembly of any of clauses 153-159, wherein the first left arm angularly extends from a left side of the body portion at an angle at or within 79-81 degrees.

Clause 161. The antenna assembly of any of clauses 153-160, wherein the first right arm angularly extends from a left side of the body portion at an angle at or within 79-81 degrees.

Clause 162. The antenna assembly of any of clauses 153-161, wherein at least one of the respective first and second resonating components is configured to resonate within a low frequency band of between 600 MHz and 700 MHz during use.

Clause 163. The antenna assembly of any of clauses 153-162, wherein at least one of the respective third and fourth resonating components is configured to resonate within a high frequency band of between 2.7 GHZ and 6.0 GHz during use.

Clause 164. The antenna assembly of any of clauses 153-163, further comprising a ground aperture located along a symmetry line of the body portion and configured to be electrically coupled to a ground reference.

Clause 165. The antenna assembly of any of clauses 153-164, further comprising a first set of apertures on the head portion and located proximate to an upper edge of the body portion.

Clause 166. The antenna assembly of any of clauses 153-165, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 167. The antenna assembly of clause 166, wherein the first right arm portion has a varying width along a length of the first right arm portion and the first left arm portion has a varying width along a length of the first left arm portion.

Clause 168. The antenna assembly of clause 166 or clause 167, wherein the second left arm portion has a consistent width along a length of the second left arm portion and the second right arm portion has a consistent width along a length of the second right arm portion.

Clause 169. The antenna assembly of any of clauses 142-168, wherein one or more multi-band radiating elements comprises between one and four multi-band radiating elements.

Clause 170. The antenna assembly of any of clauses 142-169, wherein the multi-band antenna further comprises at least one dual-band WiFi radiator portion.

Clause 171. An antenna assembly, comprising: a modem shell; and a modem.

Clause 172. An antenna assembly of any of the clauses herein, wherein the antenna assembly comprises a cover.

Clause 173. An antenna assembly of any of the clauses herein, wherein the antenna assembly comprises a base and associated components.

Clause 174. An antenna assembly of any of the clauses herein, wherein the antenna assembly comprises one or more bottom components.

Clause 175. An antenna assembly of any of the clauses herein, wherein the antenna assembly is configured for use in a vehicle.

Clause 176. An antenna assembly of any of the clauses herein, wherein the antenna assembly is removably coupled to a vehicle.

Clause 177. An antenna assembly of any of the clauses herein, wherein the antenna assembly is removably mounted to a vehicle for use within the vehicle and removable from the vehicle for use external to the vehicle.

Clause 178. An antenna assembly of any of the clauses herein, wherein the antenna assembly is magnetically coupled to a vehicle.

Clause 179. An antenna assembly of any of the clauses herein, wherein the antenna assembly comprises a base that can be configured to magnetically couple to a mounting plate via one or more magnets.

Clause 180. An antenna assembly of any of the clauses herein, wherein the antenna assembly comprises a base that can include a recess extending upwardly into the base for receiving the mounting plate.

Clause 181. An antenna assembly of any of the clauses herein, wherein the antenna assembly is configured to allow the antenna assembly to be seamlessly integrated into the vehicle when the mounting plate is received within the base.

Clause 182. An antenna assembly of any of the clauses herein, wherein the antenna assembly has a mounting plate configured to be mounted to the vehicle (e.g., the dashboard) using any conventional method.

Clause 183. An antenna assembly of any of the clauses herein, wherein the antenna assembly comprises adhesive (e.g., an adhesive gasket).

Clause 184. An antenna assembly of any of the clauses herein, wherein the antenna assembly comprises fasteners.

Clause 185. An antenna assembly of any of the clauses herein, wherein the antenna assembly comprises one or more fans, blowers, or other similar devices for forced air convection.

Clause 186. An antenna assembly of any of the clauses herein, wherein the antenna assembly includes one or more internal walls configured to provide partial or full isolation between the multi-band radiator portions and the modem.

Clause 187. An antenna assembly of any of the clauses herein, wherein the antenna assembly comprises one or both of the base and the cover can include internal walls that extend between the modem support portion and the multi-band radiator portions.

Clause 188. An antenna assembly of any of the clauses herein, wherein the antenna assembly has a first internal wall that may extend from the base towards the cover (or vice-versa) along a first side of the modem support portion within the internal volume and a second internal wall may extend from the base towards the cover (or vice-versa) along a second side of the modem support portion within the internal volume.

Clause 189. An antenna assembly of any of the clauses herein, wherein the antenna assembly is configured such that the first internal wall can define a first flow channel between a first side wall of the modem support portion and the second internal wall can define a second flow channel between a second side wall (opposite the first side wall) of the modem support portion.

Clause 190. An antenna assembly of any of the clauses herein, wherein the antenna assembly comprises the one or more side walls of the modem support portion can include vents, channels, and/or other openings to allow fluid communication between modem support portion and the internal volume of the antenna assembly.

Clause 191. An antenna assembly of any of the clauses herein, wherein the antenna assembly has a first fan that can be positioned within the first flow channel and a second fan can be positioned in the second flow channel, wherein the first and second fans can induce fluid (e.g., air) flow along the two channels to provide cooling to the modem and/or other components and systems.

Clause 192. An antenna assembly of any of the clauses herein, wherein the antenna assembly is configured such that the air flow can contact the modem via the vents in the one or more side walls and via the slots in the modem shell.

Clause 193. An antenna assembly of any of the clauses herein, wherein the antenna assembly has internal walls of the flow channels that can be configured to direct air flow from the fans inwardly towards the modem.

Clause 194. An antenna assembly of any of the clauses herein, wherein the antenna assembly has internal walls that can include curved or angled portions that forces some fluid from the fan towards the modem support portion, wherein such a configuration can increase the amount of forced convention provided to the modem.

Clause 195. An antenna assembly of any of the clauses herein, wherein the antenna assembly has a cover that can include one or more cable routing ports to allow the modem to connect to an external system through the cover without removing the modem shell or the modem from the antenna assembly.

Clause 196. An antenna assembly of any of the clauses herein, wherein the antenna assembly comprises a cover that can include an ethernet port or opening, a USB port or opening, a USBC port or opening, and/or the like.

Clause 197. An antenna assembly of any of the clauses herein, wherein the antenna assembly can include a power source, such as a battery.

Clause 198. An antenna assembly of any of the clauses herein, wherein the antenna assembly has a battery that can be configured to power the one or more fans and/or to provide power to the modem.

Clause 199. An antenna assembly of any of the clauses herein, wherein the antenna assembly has a battery that can serve as a second power source for the modem.

Clause 200. An antenna assembly of any of the clauses herein, wherein the antenna assembly has a battery that can be housed within the base; wherein the base can include a recess for receiving the battery in the bottom side of the base and the recess is configured to be covered with a removable cover.

Clause 201. An antenna assembly of any of the clauses herein, wherein the antenna assembly has a battery that can be an uninterruptible power supply (UPS) for the modem and/or the antenna assembly.

Clause 202. An antenna assembly of any of the clauses herein, wherein the antenna assembly is connected to a power source, the battery may be recharging while power is supplied to the modem and when the antenna assembly is disconnected from the power source, the battery can provide power to the modem.

Clause 203. An antenna assembly of any of the clauses herein, wherein the antenna assembly has a battery that can be connected to a circuit system.

Clause 204. An antenna assembly of any of the clauses herein, wherein the antenna assembly can include a heating system.

Clause 205. An antenna assembly of any of the clauses herein, wherein the antenna assembly has a circuit system that can be configured to control the operations of the fans and the heating pad; wherein the circuit system can control such operations without direct user control, wherein the antenna assembly can include one or more sensors that provide the circuit system with signals related to the internal or external environment of the antenna assembly.

Clause 206. An antenna assembly of any of the clauses herein, wherein the antenna assembly has a modem that may be positioned within the modem shell with gaps or spaces between the modem and the walls defined by the top cover and the bottom cover; wherein a gap may extend between the sides walls of the modem and the side walls of the modem shell; wherein such a gap can provide increased air flow to the modem through the modem shell.

Clause 207. An antenna assembly of any of the clauses herein, wherein the antenna assembly has a modem that can include or may be configured to receive a SubMiniature version A (SMA) to Time-Sensitive Networking (TSN) adaptor; wherein the modem shell can include one or more adaptor cutouts for the one or more SMA-TSN adaptors.

Clause 208. A multi-band antenna comprising a radiating element, the radiating element comprising: an upright portion configured for low-band radiation; a head portion extending from a top edge of the upright portion, the head portion configured for low-band radiation; one or more first arms extending from the upright portion, the one or more first arms configured for mid-band radiation; and one or more second arms extending from the upright portion, the one or more second arms configured for C-band radiation.

Clause 209. The multi-band antenna of clause 208, wherein the multi-band antenna is formed from a conductive sheet comprising the upright portion, the head portion, the one or more first arms, and the one or more second arms.

Clause 210. The multi-band antenna of clause 208, wherein the multi-band antenna is formed of one or more PCB portions, the one or more PCB portions comprising the upright portion, the head portion, the one or more first arms, and the one or more second arms.

Clause 211. The multi-band antenna of any of clauses 208 to 210, wherein the head portion extends angularly from the upright portion.

Clause 212. The multi-band antenna of clause 211, wherein the head portion extends from the upright portion at an angle at or within 89-91 degrees.

Clause 213. The multi-band antenna of any of clauses 208 to 212, wherein the one or more first arms extend angularly from the upright portion.

Clause 214. The multi-band antenna of any of clauses 208 to 213, wherein the one or more first arms comprise a first left arm that extends from a left side of the upright portion and a first right arm that extends from a right side of the upright portion.

Clause 215. The multi-band antenna of clause 214, wherein the first left arm comprises a first left arm portion extending from the left side of the upright portion and a second left arm portion extending from the first left arm portion, and the first right arm comprises a first right arm portion extending from the right side of the upright portion and a second right arm portion extending from the first right arm portion.

Clause 216. The multi-band antenna of clause 215, wherein the first right arm portion has a varying width along a length of the first right arm portion and the first left arm portion has a varying width along a length of the first left arm portion.

Clause 217. The multi-band antenna of clause 215 or clause 216, wherein the second left arm portion has a consistent width along a length of the second left arm portion and the second right arm portion has a consistent width along a length of the second right arm portion.

Clause 218. The multi-band antenna of any of clauses 215 to 217, wherein the second left arm portion and the second right arm portion are substantially orthogonal to the upright portion.

Clause 219. The multi-band antenna of any of clauses 208 to 218, wherein the one or more second arms comprise a second left arm that extends from a left side of the upright portion and a second right arm that extends from a right side of the upright portion.

Clause 220. The multi-band antenna of clause 219, wherein the second left arm and the second right arm are coplanar with the upright portion.

Clause 221. The multi-band antenna of any of clauses 208 to 220, wherein the one or more second arms are positioned on the upright portion between the head portion and the one or more first arms.

Clause 222. The multi-band antenna of any of clauses 208 to 221, wherein the upright portion comprises one or more slots configured to receive projection of a ground connection.

Clause 223. The multi-band antenna of any of clauses 208 to 222, further comprising a feed point extending from a bottom edge of the upright portion.

Clause 224. The multi-band antenna of any of clauses 208 to 223, wherein the head portion further comprises a first set of apertures located proximate to the top edge of the upright portion.

Clause 225. The multi-band antenna of any of clauses 208 to 224, further comprising one or more additional low-band portions extending from the head portion or the upright portion and configured for low-band radiation.

Clause 226. The multi-band antenna of any of clauses 208 to 225, wherein at least one of the upright portion and the head portion is configured to have multiple resonances that are odd multiples of a lowest low-band resonance.

Clause 227. The multi-band antenna of any of clauses 208 to 226, wherein at least one of the one or more first arms and the one or more second arms is configured to have multiple resonances that are even multiples of a lowest low-band resonance.

Clause 228. The multi-band antenna of any of clauses 208 to 227, further comprising a ground connection, the ground connection comprising: a face plate configured to be coupled to a ground reference; a body portion configured to be coupled to the upright portion; and an arm portion extending between the face plate and the body portion.

Clause 229. The multi-band antenna of clause 228, wherein the body portion further comprises one or more tabs, the one or more tabs configured to be received within slots of the upright portion to electrically connect the ground connection to the radiating element.

Clause 230. The multi-band antenna of clause 229, wherein the one or more tabs are configured to be twisted once received within the slots of the upright portion to mechanically connect the ground connection to the radiating element.

Clause 231. The multi-band antenna of any of clauses 228 to 230, wherein the arm portion has a smaller width than the body portion.

Clause 232. The multi-band antenna of any of clauses 228 to 231, wherein the arm portion extends from one side of a back side of the body portion such that a coaxial cable can extend past the arm portion and under the body portion when the coaxial cable is coupled to the radiating element.

Clause 233. A multi-band antenna comprising: an upright portion configured as a first resonating component; a head portion extending angularly from the upright portion, the head portion configured as a second resonating component; a first left arm extending from a left edge of the upright portion, the first left arm configured as a third resonating component; a first right arm extending from a right edge of the upright portion, the first right arm configured as a fourth resonating component; a second left arm extending from the left edge of the upright portion, the second left arm configured as a fifth resonating component; and a second right arm extending from the right edge of the upright portion, the second right arm configured as a sixth resonating component.

Clause 234. The multi-band antenna of clause 233, wherein the first resonating component and the second resonating component are configured to resonate within a low-frequency band of between 600 MHz and 900 MHz during use.

Clause 235. The multi-band antenna of clause 233 or clause 234, wherein the third resonating component and the fourth resonating component are configured to resonate within a mid-frequency band of between 1.7 GHZ and 2.7 GHZ during use.

Clause 236. The multi-band antenna of any of clauses 233 to 235, wherein the fifth resonating component and the sixth resonating component are configured to resonate within a CBRS-frequency band of between 3.4 GHz and 4.2 GHz during use.

Clause 237. The multi-band antenna of any of clauses 233 to 236, wherein the multi-band antenna is formed from a conductive sheet comprising the upright portion, the head portion, the first left arm, the first right arm, the second left arm, and the second right arm.

Clause 238. The multi-band antenna of any of clauses 233 to 237, wherein the multi-band antenna is formed of one or more PCB portions, the one or more PCB portions comprising the upright portion, the head portion, the first left arm, the first right arm, the second left arm, and the second right arm.

Clause 239. The multi-band antenna of any of clauses 233 to 238, wherein the head portion extends from the upright portion at an angle at or within 89-91 degrees.

Clause 240. The multi-band antenna of any of clauses 233 to 239, wherein the first left arm and the first right arm extend angularly from the upright portion.

Clause 241. The multi-band antenna of any of clauses 233 to 240, wherein the first left arm comprises a first left arm portion extending from the left edge of the upright portion and a second left arm portion extending from the first left arm portion, and the first right arm comprises a first right arm portion extending from the right edge of the upright portion and a second right arm portion extending from the first right arm portion.

Clause 242. The multi-band antenna of clause 241, wherein the first right arm portion has a varying width along a length of the first right arm portion and the first left arm portion has a varying width along a length of the first left arm portion.

Clause 243. The multi-band antenna of clause 241 or clause 242, wherein the second left arm portion has a consistent width along a length of the second left arm portion and the second right arm portion has a consistent width along a length of the second right arm portion.

Clause 244. The multi-band antenna of any of clauses 241 to 243, wherein the second left arm portion and the second right arm portion are substantially orthogonal to the upright portion.

Clause 245. The multi-band antenna of any of clauses 233 to 244, wherein the second left arm and the second right arm are coplanar with the upright portion.

Clause 246. The multi-band antenna of any of clauses 233 to 245, wherein the second left arm and the second right arm are positioned on the upright portion between the head portion and the first left arm and the first right arm.

Clause 247. The multi-band antenna of any of clauses 233 to 246, wherein the upright portion comprises one or more slots configured to receive projection of a ground connection.

Clause 248. The multi-band antenna of any of clauses 233 to 247, further comprising a feed point extending from a bottom edge of the upright portion.

Clause 249. The multi-band antenna of any of clauses 233 to 248, wherein the head portion further comprises a first set of apertures located proximate to a top edge of the upright portion.

Clause 250. The multi-band antenna of any of clauses 233 to 249, further comprising one or more additional low-band portions extending from the head portion or the upright portion and configured for low-band radiation.

Clause 251. The multi-band antenna of any of clauses 233 to 250, wherein at least one of the upright portion and the head portion is configured to have multiple resonances that are odd multiples of a lowest low-band resonance.

Clause 252. The multi-band antenna of any of clauses 233 to 251, wherein at least one of the first left arm, the first right arm, the second left arm, and the second right arm is configured to have multiple resonances that are even multiples of a lowest low-band resonance.

Clause 253. The multi-band antenna of any of clauses 233 to 252, further comprising a ground connection, the ground connection comprising: a face plate configured to be coupled to a ground reference; a body portion configured to be coupled to the upright portion; and an arm portion extending between the face plate and the body portion.

Clause 254. The multi-band antenna of clause 253, wherein the body portion further comprises one or more tabs, the one or more tabs configured to be received within slots of the upright portion to electrically connect the ground connection to the upright portion.

Clause 255. The multi-band antenna of clause 254, wherein the one or more tabs are configured to be twisted once received within the slots of the upright portion to mechanically connect the ground connection to the upright portion.

Clause 256. The multi-band antenna of any of clauses 253 to 255, wherein the arm portion has a smaller width than the body portion.

Clause 257. The multi-band antenna of any of clauses 253 to 256, wherein the arm portion extends from one side of a back side of the body portion such that a coaxial cable can extend past the arm portion and under the body portion when the coaxial cable is coupled to the upright portion.

Clause 258. The antenna assembly of clause 98, wherein the multi-band antenna comprises the multi-band antenna defined by any of clauses 208 to 232 or clauses 233 to 257.

Clause 259. The antenna assembly of clause 142, wherein the multi-band antenna comprises the multi-band antenna defined by any of clauses 208 to 232 or clauses 233 to 257.

Clause 260. The antenna assembly, according to any one or more of the clauses herein, further comprising one or more multi-band antenna defined by any of 208 to 232 or clauses 233 to 257.

Clause 261. The antenna assembly according to any one or more of the clauses herein, further comprising one or more millimeter wave radios configured for operation at frequencies between 30 GHz and 300 GHz.

Clause 262. The antenna assembly of clause 261, wherein the one or more millimeter wave radios comprise slotted waveguide array millimeter wave radios, dipole array millimeter wave radios, microstrip patch array millimeter wave radios, or coplanar waveguide feed cylindrical dielectric resonator array millimeter wave radios.

Clause 263. An antenna assembly, comprising: a multi-element multi-band antenna coupled to a ground plane; and a plurality of impedance matching components coupled to one or more portions of the multi-element multi-band antenna and the ground plane.

Clause 264. The antenna assembly, according to any one or more of the clauses herein, wherein the multi-element multi-band antenna includes one or more radiating elements, each radiating element comprising an upright portion, a low band radiator portion, and one or more high band portions.

Clause 265. The antenna assembly, according to any one or more of the clauses herein, wherein a first high band portion of one or more high band portions is coupled to a connecting portion extending from the upright portion.

Clause 266. The antenna assembly, according to any one or more of the clauses herein, wherein the connecting portion extends at a first angle from the upright portion, and wherein the first high band portion extends from the connecting portion in a substantially parallel direction relative to the ground plane.

Clause 267. The antenna assembly, according to any one or more of the clauses herein, wherein each impedance matching component of the one or more impedance matching components is coupled to the upright portion and the ground plane, wherein the impedance matching component is positioned substantially perpendicular to the ground plane.

Clause 268. The antenna assembly, according to any one or more of the clauses herein, wherein the antenna assembly may be configured to produce a radiation pattern perpendicular to the ground plane.

Clause 269. The antenna assembly, according to any one or more of the clauses herein, wherein a radiation pattern of the antenna assembly is either omni-directional or directional when the antenna assembly is configured in accordance with a desired radiation performance criterion.

Clause 270. The antenna assembly, according to any one or more of the clauses herein, wherein the multi-element multi-band antenna comprises at least one inverted F antenna.

Clause 271. The antenna assembly, according to any one or more of the clauses herein, wherein the antenna assembly is configured and adapted to have an operating frequency range of between about 450 MHz to about 8 GHz when used in conjunction with high order electromagnetic modes generated or received by a transceiver and/or a receiver.

Clause 272. The antenna assembly, according to any one or more of the clauses herein, wherein the one or more high band portions can be configured and adapted to be used for communication between about 1 GHz to about 8 GHz.

Clause 273. The antenna assembly, according to any one or more of the clauses herein, wherein the multi-element multi-band antenna can be configured and adapted to be used for communication between about 450 MHz to about 8 GHz.

Clause 274. The antenna assembly, according to any one or more of the clauses herein, wherein the one or more high band portions comprises two high band portions.

Clause 275. The antenna assembly, according to any one or more of the clauses herein, wherein at least some of the multi-element multi-band antenna are constructed of one or more types of PCB material.

Clause 276. The antenna assembly, according to any one or more of the clauses herein, wherein the multi-element multi-band antenna is constructed substantially from sheet metal.

Clause 277. The antenna assembly, according to any one or more of the clauses herein, wherein the low band radiator portion extends substantially perpendicular from the upright portion.

Clause 278. The antenna assembly, according to any one or more of the clauses herein, wherein the upright portion has a greater width than height.

Clause 279. The antenna assembly, according to any one or more of the clauses herein, wherein the upright portion has a width to height ratio of 2:1 or greater.

Clause 280. The antenna assembly, according to any one or more of the clauses herein, wherein the upright portion includes one or more mounting features, the one or more mounting features configured to allow the upright portion to be coupled to the ground plane.

Clause 281. The antenna assembly, according to any one or more of the clauses herein, wherein the upright portion includes a slot, the slot configured to receive the impedance matching component.

Clause 282. The antenna assembly, according to any one or more of the clauses herein, wherein a first radiating element of the one or more radiating elements is rotated at least 15-degrees from a second radiating element of the one or more radiating elements.

Clause 283. An antenna comprising: a ground plane; and one or more multi-band radiating elements electrically connected to the ground plane.

Clause 284. The antenna of clause 283, wherein the one or more multi-band radiating elements comprise a first radiating element, a second radiating element, a third radiating element, and a fourth radiating element.

Clause 285. The antenna of clause 284, wherein each of the first radiating element, the second radiating element, the third radiating element, and the fourth radiating element comprise a three-dimensional radiator portion and a grounding portion.

Clause 286. The antenna of clause 284 or clause 285, wherein the first radiating element is arrayed with the second radiating element to form a first element pair, and the third radiating element is arrayed with the fourth radiating element to form a second element pair.

Clause 287. The antenna of clause 284, wherein the first radiating element and the second radiating element are arrayed other.

Clause 288. The antenna assembly, according to any one or more of the clauses herein, further comprising a stacked patch antenna.

Clause 289. The antenna assembly of clause 288, wherein the stacked patch antenna comprises: a bottom patch element positioned above a ground plane with a first gap therebetween; and a top patch element positioned above the bottom patch element with a second gap therebetween.

Clause 290. The antenna assembly of clause 289, further comprising one or more support posts positioned between the ground plane and the bottom patch element, the one or more support posts supporting the bottom patch element above the ground plane.

Clause 291. The antenna assembly of clause 290, wherein the one or more support posts extend through the bottom patch element to support the top patch element above the bottom patch element.

Clause 292. The antenna assembly of clause 289 or clause 290, wherein the one or more support posts comprise a non-conductive material.

Clause 293. The antenna assembly of any of clauses 289 to 292, wherein the bottom patch element further comprises a bottom plate and a matching circuit, the matching circuit extending from the bottom plate in a plane defined by the bottom plate.

Clause 294. The antenna assembly of clause 293, wherein the matching circuit is T-shaped.

Clause 295. The antenna assembly of clause 293 or clause 294, wherein the ground plane comprises a microstrip transmission line extending from an attachment point to a feed post, the feed post comprising a conductive material, the feed post electrically connecting the matching circuit to the microstrip transmission line.

Clause 296. The antenna assembly of clause 295, wherein the attachment point is configured to allow a coaxial cable to connect the stacked patch antenna to a radio.

Clause 297. The antenna assembly of any of clauses 289 to 296, further comprising a conductive post, the conductive post extending between the ground plane and the top patch element through the bottom patch element, the conductive post electrically connecting the ground plane to the top patch element and the bottom patch element.

Clause 298. An antenna assembly, comprising: a base portion; a cover configured to be removably coupled to the base portion to define an internal volume, the cover comprising a support portion extending from a top side of the cover towards the base portion; a modem configured to be supported by the support portion; and a multi-band antenna housed within the internal volume.

Clause 299. The antenna assembly of clause 298, wherein the base portion comprises a ground plane.

Clause 300. The antenna assembly of clause 298, further comprising a ground plane supported by the base portion.

Clause 301. The antenna assembly of any of clauses 298-300, further comprising a modem shell configured to house the modem, wherein the support portion supports the modem shell.

Clause 302. The antenna assembly of clause 301, wherein the modem shell is configured to be removably coupled to the support portion.

Clause 303. The antenna assembly of clause 301 or clause 302, wherein the modem shell comprises: a top cover; and a bottom cover, the top cover configured to be removably coupled to the bottom cover with the modem therebetween; wherein the top cover and the bottom cover comprise a plurality of slots, the plurality of slots configured to allow portions of the modem to be exposed to an external environment.

Clause 304. The antenna assembly of clause 303, wherein the modem shell further comprises one or more cutouts, the one or more cutouts configured to provide access to ports of the modem.

Clause 305. The antenna assembly of any of clause 298-304, wherein the cover include one or more vents, wherein the one or more vents are configured to promote heat exchange between internal components of the antenna assembly and a surrounding environment.

Clause 306. The antenna assembly of any of clause 298-305, wherein the support portion comprises a bottom portion configured to support the modem and one or more side walls, wherein at least one of the bottom portion and the one or more side walls includes a plurality of vents configured to promote heat exchange between the modem and the internal volume.

Clause 307. The antenna assembly of any of clause 298-306, wherein the multi-band antenna includes one or more multi-band radiating elements.

Clause 308. The antenna assembly of clause 307, wherein each multi-band radiating element of the one or more multi-band radiating elements comprises: a feeding portion; a grounding portion; an upright low band radiation portion; a second low band radiation portion; and a high band radiation portion.

Clause 309. The antenna assembly of clause 307, wherein each multi-band radiating element of the one or more multi-band radiating elements comprises: a conductive sheet having a body portion with a front face, a head portion, a first left arm, and a first right arm; wherein the head portion angularly extends from the body portion; wherein the first left arm angularly extends from the body portion and the first right arm angularly extends from the body portion; and wherein the front face is configured as a first resonating component, the head portion is configured as a second resonating component, the first left arm is configured as a third resonating component, and the first right arm is configured a fourth resonating component.

Clause 310. The antenna assembly of clause 309, wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHz and 6.0 GHz during use.

Clause 311. The antenna assembly of clause 309 or clause 310, further comprising a second left arm that extends from the body portion and a second right arm that extends from the body portion.

Clause 312. The antenna assembly of clause 311, wherein the second left arm and the second right arm are coplanar to the front face.

Clause 313. The antenna assembly of any of clauses 309-312, wherein the body portion further comprises one or more slots configured to receive projections of an antenna connection.

Clause 314. The antenna assembly of any of clauses 309-313, wherein the conductive sheet has a thickness at or within 0.01 to 0.03 inches.

Clause 315. The antenna assembly of any of clauses 309-314, wherein the head portion is configured to angularly extend from the body portion at an angle at or within 89-91 degrees.

Clause 316. The antenna assembly of any of clauses 309-315, wherein the first left arm angularly extends from a left side of the body portion at an angle at or within 79-81 degrees.

Clause 317. The antenna assembly of any of clauses 309-316, wherein the first right arm angularly extends from a left side of the body portion at an angle at or within 79-81 degrees.

Clause 318. The antenna assembly of any of clauses 309-317, wherein at least one of the respective first and second resonating components is configured to resonate within a low frequency band of between 600 MHz and 700 MHz during use.

Clause 319. The antenna assembly of any of clauses 309-318, wherein at least one of the respective third and fourth resonating components is configured to resonate within a high frequency band of between 2.7 GHZ and 6.0 GHz during use.

Clause 320. The antenna assembly of any of clauses 309-319, further comprising a ground aperture located along a symmetry line of the body portion and configured to be electrically coupled to a ground reference.

Clause 321. The antenna assembly of any of clauses 309-320, further comprising a first set of apertures on the head portion and located proximate to an upper edge of the body portion.

Clause 322. The antenna assembly of any of clauses 309-321, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 323. The antenna assembly of clause 322, wherein the first right arm portion has a varying width along a length of the first right arm portion and the first left arm portion has a varying width along a length of the first left arm portion.

Clause 324. The antenna assembly of clause 322 or clause 323, wherein the second left arm portion has a consistent width along a length of the second left arm portion and the second right arm portion has a consistent width along a length of the second right arm portion.

Clause 325. The antenna assembly of any of clauses 298-324, wherein one or more multi-band radiating elements comprises between one and four multi-band radiating elements.

Clause 326. The antenna assembly of any of clauses 298-325, wherein the multi-band antenna further comprises at least one dual-band WiFi radiator portion.

Clause 327. The antenna assembly of any of clauses 298-326, wherein the base portion is configured to removably couple the antenna assembly to a vehicle.

Clause 328. The antenna assembly of any of clauses 298-327, wherein the base portion is configured to receive a removable plate in a bottom surface thereof.

Clause 329. The antenna assembly of clause 328, wherein the removable plate is magnetically coupled to the bottom surface of the base portion.

Clause 330. The antenna assembly of any of clauses 298-329, wherein the antenna assembly comprises one or more fans, blowers, or other similar devices for forced air convection.

Clause 331. The antenna assembly of any of clauses 298-330, wherein the antenna assembly further comprises one or more internal walls, the one or more internal walls configured to provide partial or full isolation between the multi-band radiator portions and the modem.

Clause 332. The antenna assembly of any of clauses 298-331, further comprising a first internal wall positioned between the base portion and the cover along a first side of the modem support portion within the internal volume and a second internal wall positioned between the base portion and the cover along a second side of the modem support portion within the internal volume.

Clause 333. The antenna assembly of clause 332, wherein the first internal wall defines a first flow channel between a first side wall of the modem support portion and the second internal wall defines a second flow channel between a second side wall of the modem support portion, the second side wall opposite the first side wall.

Clause 334. The antenna assembly of clause 333, wherein the first side wall and/or the second side wall include vents, channels, and/or other openings to allow fluid communication between modem support portion and the internal volume of the antenna assembly.

Clause 335. The antenna assembly clause 332 or clause 333, further comprising a first fan positioned within the first flow channel and a second fan positioned within the second flow channel, wherein the first and second fans can induce fluid (e.g., air) flow along the two channels to provide cooling to the modem and/or other components and systems.

Clause 336. The antenna assembly of clause 335, wherein the antenna assembly is configured such that the air flow can contact the modem via the vents in the one or more side walls and via the slots in the modem shell.

Clause 337. The antenna assembly of clause 335, wherein the first flow channel and the second flow channel are configured to direct air flow from the fans inwardly towards the modem.

Clause 338. The antenna assembly of clause 337, wherein the first internal wall and/or the second internal wall include curved or angled portions that forces some fluid from the first and second fans towards the modem support portion.

Clause 339. The antenna assembly of any of clauses 298 to 338, wherein the cover includes one or more cable routing ports to allow the modem to connect to an external system through the cover without removing the modem shell or the modem from the antenna assembly.

Clause 340. The antenna assembly any of clauses 298 to 339, wherein the antenna assembly further comprises a power source.

Clause 341. The antenna assembly of clause 340, wherein the power source comprises a battery, the battery configured to power the one or more fans and/or to provide power to the modem.

Clause 342. An antenna assembly of clause 341, wherein the battery is configured as a second power source for the modem.

Clause 343. The antenna assembly of any of clauses 298 to 342, wherein the antenna assembly further comprises a battery, the battery housed within the base, wherein the base includes a recess for receiving the battery in a bottom side of the base and the recess is configured to be covered with a removable cover.

Clause 344. The antenna assembly of any of clauses 341 to 343, wherein the battery is configured as an uninterruptible power supply (UPS) for the modem and/or other components of the antenna assembly.

Clause 345. The antenna assembly of any of the clauses 341 to 344, further comprising a circuit system, the circuit system powered by the battery.

Clause 346. The antenna assembly of any of clauses 298 to 345, further comprising a heating system.

Clause 347. The antenna assembly of any of clauses 298 to 346, further comprising a circuit system, the circuit system configured to control the operations of the fans and the heating system.

Clause 348. The antenna assembly of clause 347, wherein the circuit system is configured to control the operation of the fans and the heating system without direct user control.

Clause 349. The antenna assembly of clause 348, further comprising one or more sensors that provide the circuit system with signals related to the internal or external environment of the antenna assembly.

Clause 350. The antenna assembly of any of clauses 298 to 349, wherein the antenna assembly has a modem that may be positioned within the modem shell with gaps or spaces between the modem and the walls defined by the top cover and the bottom cover; wherein a gap may extend between the sides walls of the modem and the side walls of the modem shell; wherein such a gap can provide increased air flow to the modem through the modem shell.

### ADDITIONAL CONSIDERATIONS AND TERMINOLOGY

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise, the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1.-53. (canceled)

54. An antenna assembly, comprising:
a base portion;
a cover configured to be removably coupled to the base portion to define an internal volume, the cover comprising a support portion extending from a top side of the cover towards the base portion, wherein the support portion is configured and adapted to support a modem; and
a multi-band antenna housed within the internal volume.

55. The antenna assembly of claim 54, wherein the base portion is configured to removably couple the antenna assembly to a vehicle.

56. The antenna assembly of claim 54, wherein the base portion is configured to receive a removable plate in a bottom surface thereof, wherein the removable plate is magnetically coupled to the bottom surface of the base portion.

57. The antenna assembly of claim 54, wherein the antenna assembly comprises one or more fans, blowers, or other similar devices for forced air convection.

58. The antenna assembly of claim 54, wherein the antenna assembly further comprises one or more internal walls, the one or more internal walls configured to provide partial or full isolation between the multi-band radiator portions and a modem.

59. The antenna assembly of claim 54, further comprising a first internal wall positioned between the base portion and the cover along a first side of the modem support portion within the internal volume and a second internal wall positioned between the base portion and the cover along a second side of the modem support portion within the internal volume; wherein the first internal wall defines a first flow channel between a first side wall of the modem support portion and the second internal wall defines a second flow channel between a second side wall of the modem support portion, the second side wall opposite the first side wall; wherein the first side wall and/or the second side wall include vents, channels, and/or other openings to allow fluid communication between the modem support portion and the internal volume of the antenna assembly; and further comprising a first fan positioned within the first flow channel and a second fan positioned within the second flow channel, wherein the first and second fans can induce fluid (e.g., air) flow along the two channels to provide cooling to a modem and/or other components and systems.

60. The antenna assembly of claim 59, wherein the antenna assembly is configured such that the air flow can contact a modem via the vents in the one or more side walls and via the slots in the modem shell; wherein the first flow channel and the second flow channel are configured to direct air flow from the fans inwardly towards a modem; and wherein the first internal wall and/or the second internal wall include curved or angled portions that forces some fluid from the first and second fans towards the modem support portion.

61. The antenna assembly of claim 54, wherein the cover includes one or more cable routing ports to allow a modem to connect to an external system through the cover without removing the modem shell or a modem from the antenna assembly.

62. The antenna assembly of claim 54, wherein the antenna assembly further comprises a power source; wherein the power source comprises a battery, the battery configured to power the one or more fans and/or to provide power to a modem; and wherein the battery is configured as a second power source for a modem.

63. The antenna assembly of claim 54, wherein the antenna assembly further comprises a battery, the battery housed within the base, wherein the base includes a recess for receiving the battery in a bottom side of the base and the recess is configured to be covered with a removable cover; wherein the battery is configured as an uninterruptible power supply (UPS) for a modem and/or other components of the antenna assembly; and further comprising a circuit system, the circuit system powered by the battery.

64. The antenna assembly of claim 54, further comprising a heating system.

65. The antenna assembly of claim 54, further comprising a circuit system, the circuit system configured to control the operations of the fans and the heating system; wherein the circuit system is configured to control the operation of the fans and the heating system without direct user control; and further comprising one or more sensors that provide the circuit system with signals related to the internal or external environment of the antenna assembly.

66. The antenna assembly of claim 54, wherein the antenna assembly has a modem that may be positioned within the modem shell with gaps or spaces between the modem and the walls defined by the top cover and the bottom cover; wherein a gap may extend between the sides walls of the modem and the side walls of the modem shell; wherein such a gap can provide increased air flow to the modem through the modem shell.

67. An antenna assembly, comprising:
a base portion;
a cover, the cover configured to be removably coupled to the base portion;
a modem positioned on or above the base portion;
a ground plane; and
a multi-band antenna.

68. The antenna assembly of claim 67, wherein the ground plane is coupled to the cover between a top side of the cover and the base portion, wherein the ground plane acts as a dividing wall between a top internal volume between the ground plane and the cover, and a bottom internal volume between the ground plane and the base portion.

69. The antenna assembly of claim 68, wherein the modem is positioned within the bottom internal volume and the multi-band antenna is positioned within the top internal volume.

70. The antenna assembly of claim 68, wherein the ground plane is configured to be removably coupled to the cover in a first configuration and a second configuration, wherein in the first configuration, the ground plane is positioned closer to the base portion than in the second configuration.

71. The antenna assembly of claim 70, wherein a ratio between the top internal volume and the bottom internal volume changes when the ground plane is moved from the first configuration to the second configuration.

72. The antenna assembly of claim 67, wherein the cover include one or more vents, wherein the one or more vents are configured to promote heat exchange between internal components of the antenna assembly and a surrounding environment.

73. The antenna assembly of claim 67, wherein the ground plane is configured to act as a heat sink for the modem.
